(19) United States
(12) Patent Application Publication
(10) Pub. No.: US 2004/0030741 A1
(43) Pub. Date: Feb. 12, 2004

(54) Method and apparatus for search, visual navigation, analysis and retrieval of information from networks with remote notification and content delivery

(76) Inventors: Richard Ernest Wolton, Placerville, CA (US); William Scott Moulton, Kentfield, CA (US)

Correspondence Address: WILLIAM MOULTON, SUITE 2, 838 SIR FRANCIS DRAKE BLVD., KENTFIELD, CA, 94904, US

(21) Appl. No.: 10/112,408

(22) Filed: Apr. 1, 2002

Related U.S. Application Data
(60) Provisional application No. 60/280,756, filed on Apr. 2, 2001.

(51) Int. Cl. G06F 15/16; G06F 17/00; G06F 17/30; G06F 7/00

(52) U.S. Cl. 709/202; 707/104.1; 707/10

(57) ABSTRACT

A modular intelligent personal agent system is presented for search, navigation, control, retrieval, analysis, and results reporting on networks and databases. A client-side or server-side software application retrieves and interprets hypertext documents executing a search algorithm, which search results are displayed in alternate three-dimensional and two-dimensional graphical visualization formats. Hypertext documents and associated content media are displayed as symbol or thumbnail web documents as nodes with connector lines representing links between the documents. Nodes and connector lines are color-coded symbol form for the user according to truth of search terms, numeric data tested in hypertext documents, according to domain type, link density, and metric counts. Different symbols represent search and Boolean evaluation status, document type, and thumbnails represent whole or incremental portions of the document page or type documents found. The three-dimensional displayed nodes are visually navigated based on recency, chronology of discovery and metric information values. The result of searches performed by the system can retrieve user selected documents from a network and automatically format results of the search and content retrieval using a plurality of ranking methods. The system provides alerts and content delivery to users using email, instant messaging and audio. Multiple agents can operate to accomplish complex tasks a singular agent cannot. Agents are deployed

The following description includes some copyrighted material. While Applicants do not object to the copying of this specification for patent related purposes, Applicants reserve all copyrights to themselves and/or the assignee of the present invention.

### FIELD OF THE INVENTION

The present invention pertains to the field of networked computer systems known as the world wide web, the internet, intranets, and databases. More particularly, the present invention relates to real-time network search navigation, selective hypertext document content retrieval, graphically representing the distributed network for analysis, and providing remote communications notification and results delivery to users.

### BACKGROUND OF THE INVENTION

The World Wide Web (“the Web”) is a network distributed collection of hypertext documents (“Web pages”), which are connected via the internet. The internet is a networked collection of computer systems. An intranet is a wide area network of computer systems. An extranet or virtual private network are access restricted collections of networked computers and hypertext documents that are connected via the Web and or the internet. The Web is a immense resource of information and media content relating to many subjects, including business, entertainment, education, science, and religion for example.

Improvements in Web related technology such as Web browsers like Internet Explorer or Netscape Navigator, for example; or search engines, such as Google, Alta Vista, Excite, and NorthernLight, for example, have made the Web accessible to a large segment of the population.

Despite these improvements, the ability of users to readily, timely and effectively identify, select, access, and retrieve information remains more limited and difficult than necessary.

On the Web, hypertext HTML (HyperText Mark-up Language) documents can be connected to one another via links. Links function as means for one hypertext document to connect to another hypertext document, and using a cursor selector, a user can click on a link to select a word, a phrase, or an image (a “hypertext anchor”) to command the computer to retrieve the associated document located on the same server as the originating page, or otherwise located on a remote server.

The majority of users on the Web become familiar and even dependent on a limited number of web sites, to which they return again and again to retrieve information and media content for viewing or usage.

Users of large complex sites, called portals, or directories, often find it difficult and or time consuming to navigate and identify documents and items of interest, and spend much time ferreting through the many pages and options available. In addition, the paths and layouts of web pages and portals different from one another so there very often is no uniform method users can use to navigate portals and pages on the web, except as provided for within the navigation options which have been built into the particular web sites.

Users also commonly utilize large scale search engines available at certain web pages and portals such as America On Line, Yahoo, Microsoft Network, which conventional search engines may include for Google, Excite, NorthernLight, or Alta Vista, example, to find and identify web pages and documents they are not yet aware of which are of interest.

Users who revisit web sites again and again may not find items and documents of interest in every visit, and certain improvements have been made to notify users of when changes have been introduced to a given web page or particular web page element they are interested in.

Many web sites now offer update notification services and some software tool providers now offer special purpose update notification services. In some cases, web sites offer users the ability to pre-select the type of information and media content they are interested in.

In some cases, web sites automatically will send notification to users when there are changes, or will send to users via email fill or excerpted documents or emails of links to documents so the users can later peruse them when navigating the Web using their browser tool.

Conventional search engines scan large portions of the Web to build up large scale databases of information from and about web pages on the Web, the internet, FTP (File Transfer Protocol), newsgroups, and the like. These databases are then indexed and available to be searched by users so they can identify information of interest to use their web browser to go visit.

The web is growing at an extremely rapid rate, and search engines are less and less able to scan and index the entire web and the built up databases are increasingly out of date, and do not represent the most current real time status of what is available on the Web.

Once a user has entered some search terms into a query line on a large conventional search engine served on a web page, the indexed database is checked against the search terms entered and web pages which match the search terms are returned and served to the user, and ranked according to a variety of different methods.

Web sites and web site operators subject to search engine ranking schemes attempt to characterize their pages through covert word repetition and direct submission to search engines, amongst other things, to obtain a higher position in the search engine rankings in order to reach more search engine users. Web sites may contain words that are not directly associated with the web page content but are known popular words that people search for, such as the word “sex” for example.

In these preceding examples, of repetition and popular word inclusion, these characterizations can be misleading in order to generate traffic to their web site. Search engine companies are always developing new methods to defeat the so called search engine “spammers” in order to have search results more correctly reflect their results ranking philosophy.

Some conventional search engines will partly rank results according the number of times search terms appear on the web pages indexed. Google has improved this on situation somewhat by additionally ranking web pages according to the number of other web pages found to link to the given web page. Search engines have improved on this situation by using human editors and indexers to identify, classify, and rank web sites and pages, such as Magellan.com, or Savvysearch.com for example.

Search engine portal sites have sometimes improved their ranking control by providing extensive subject directories for users to select from, narrowing user search space to the sites indexed to fit into particular predetermined directory subjects and topics. Some search engines offer paid ranking, or featured ranking, where the web site can purchase placement higher in a ranking than ordinarily would occur.

Search engines may not index more than a limited number of pages per domain, or may not index pages that contain a so called “robot exclusion tag” which is a voluntary convention for informing search engine web scanning software, called crawlers and spiders, to not crawl and index further into the site.

In general, however, when users visit a search engine portal to find web sites and pages of interest, they are largely unaware of the degree of coverage the search index has for the web, unaware of the recency of information indexed, an unaware of how the search engine index ranks results against the search words or terms they enter. The only fairly obvious element users control is the option to enter search terms in some Boolean format, such as default AND between all terms entered, for example, in order to narrow the resulting hits to a smaller number of listings.

The Web in whole, represents merely the hypertext surface of a larger deep repository of information and media content which is stored in databases and served through the surface web query interfaces, and this deeper repository is most often not indexed by the large conventional search engines. It is estimated this repository is more than two orders of magnitude larger than the more than 2 billion web pages currently existing.

This overall set of environmental circumstances of how the Web functions has generated numerous problems, including:

(1) the lack of timely Web information from search engines,

(2) the lack of sufficient coverage of search engines indexed databases of what is available on the Web,

(3) the lack of ranking information according to user needs of relevance,

(4) the extensive amount of time required for users to identify if the search engine results are useful by having to visit the web page corresponding to every search engine database search results,

(5) the lack of sufficient sampling of what is available at a given web site via the search engine databases,

(6) the lack of an intuitive or practical way to visualize the relationships between different web pages and web sites,

(7) the lack of an intuitive or practical way to visualize the density of useful information located in clusters of related web pages and web sites,

(8) the lack of ubiquitous availability of information search results to any HTML enabled or email enabled device,

(9) the lack of adaptive approaches to personalize the formatting, reporting and delivery of the results of any search or update notification,

(10) and the lack of navigation methods to allow users to effectively sort out and prune or quickly preview web pages or web sites or underlying databases of information.

To address these continuing difficulties and limitations, there have been a number of different approaches to assist users in having a more timely, thorough, relevant and intuitive experience of finding and using information available on the Web, the internet, FTP, intranets, extranets, virtual private networks and databases.

These include the development of better browsers, specialized or general purpose meta-search tools and services, easier to navigate database and web directories, and single site search engines available for users on a web site.

Further, these include so called ‘push’ technologies to serve to users preferential content, intelligent agents to help users interact with web sites, software called ‘bots’.

Agents and bots are used to gather information automatically or provide alerts, and on-the-fly linking, update, and content retrieval services which provide optional links to any word or phrase based on remotely matching the words to other sites and serving these options to users via email or web sites, such as for example, FlySwat.com or Spyonit.com.

Some parties have developed approaches to visualizing the Web, as site nodes and hypertext links, and as web metric analytic and monitoring tools for professionals, such as SilentRunner.com, or CyberGeography.org, or Inxight.com, or Map.net as topical subject search, navigation and indexing tools.

Many of these approaches begin to treat the problems mentioned identified above, however most of these are disparate and individual solutions that the user must collect, and thereby becomes faced with having to navigate amongst many tools available for navigating In some cases these solutions aggravate the problems faced, resulting in diminishing returns for the user in terms of time spent and productivity in using the Web.

Software agents and so called ‘bot’ tools and applications available have considerable problems associated with their use by non-programmer consumers, and have considerable problems associated with their construction and application to accomplish complex tasks. Sophisticated software agent application building tools require programmers to be involved in order to create consumer usable application solutions.

What is needed, therefore, is a general purpose, easy to use, non-programmer user customizable solution for building, adapting, managing and delivering solutions to these many identified related problems of personalized information management. One solution that is useful is to provide a client-side means to layer a general purpose Web navigation capability for the user between the common browser and the plurality of site resources and services available on the Web.

A client-side solution as a browser extension capability, or as a standalone capability, can provide a means for users to privately, locally and preferentially access and search, navigate, collect, analyze, and present web information resources. Further what is needed is a solution that cans be readily adapted to the user's personal preferentially advantaged search, navigation, retrieval, analysis and presentation criteria.

While it is conceptually useful and operationally practical to have a client-side software application solution, similar capabilities can be served from a central server or peer-to-peer network, where the same essential tasks are executed and then provided to a client device interface. It is valuable to provide a means where a user is afforded the maximum opportunity to use an information retrieval tool to their arbitrary benefit and afford their fullest rights of fair-use copyright law.

In some instances it is most appropriate to use a client-side application solution approach. A commercial entity providing the same capability from a server could be interpreted to be infringing on the copyright of the web site or documents retrieved from remote sites and served to the user, and as such, could be a form of content re-purposing which may be considered copyright infringement.

A client-side solution approach is not designed as means to in any way skirt copyright law, but rather as means to afford independent individual users fullest rights under the scope of fair-use of information over the internet as defined under copyright law. Additionally users be afforded certain added privacy and independence as to the purposes to which they apply any selective information search and retrieval solution.

Further, a solution is needed which bridges the growing gap between the amount of information available on the internet and the recency of large search engine databases. A solution is needed which bridges the gap between the current limited navigation capabilities of web and internet browsers and users needs to save time and increase productivity of on-line activities. As such, a solution is needed that can ably automate components of the internet browsing process.

Further, a solution is needed that bridges the gap between the required skill set to operate and effectively apply sophisticated customization tools and the common sense skill set which consumer already possess. What is needed is an integrated solution which can be effectively used by the majority of non-programmer consumers to produce complex custom application functionality which up to the present require significant expenditure and programming expertise to produce.

### SUMMARY OF THE INVENTION

The present invention includes a tool for creating intelligent information management applications, in the form of specialized information search and retrieval agents. The present invention permits the creation of a plurality of different types of special purpose software agents.

The system provides means to construct personalized collections of integrated computer implemented methods for engaging in a complex sequence of activities. This sequence can include live network search, navigation, graphical representing, retrieval and collection, analysis and interpretation, formatting, notification, presentation and delivering of textual information and media content data sets. These data sets are distributed on a plurality of computers on a network.

Software agents can be solely operated as entirely a client side application, or as a server side application, or as a hybrid between server and client application software. If operated as a client side only desktop software for example, the system provides users with advantages of enhanced privacy, application independence, and enhanced personal fair-use access to copyright material which would otherwise be more cumbersome or even illegal to obtain.

In the present invention, a hypertext web page document or conventional search engine or site local search engine ranked results listing may be initially obtained using a popular search engine. Alternatively, a web site portal URL is initially obtained using a browser client or initially found in email client software program. Alternatively, an HTML document is obtained from any source. The user either has previously or currently specifies and selects in the preferences of the integrated agent system. These preferences determine what particular Web or database or intranet element of text, documents or content media, or types thereof, are of interest to the user.

These preferences additionally determine how the user wishes to visualize and represent the search and retrieval engagement process and results. Further, these preferences determine when and how often or at what rate or by what dynamic indicator the content is to be of interest. Further, these preferences determine how the results of the search and retrieval process are to be formatted, how the user is to be notified of the results, and how and where the collected results are to be delivered.

In the search aspect of the invention, the agent engages a process of automatically visiting one or more hypertext web page documents or sites on the Web and pursuing any links associated with those web page documents sites to other document sites. This pursuit is according to the Boolean search terms and link terms and metric terms the user wishes to search for and match and thereby identify for retrieval.

In the navigation aspect of the invention, the agent selectively prunes the search space to limit the number of documents visited, and thereby make the search process more efficient, relevant and limited in volume.

In the graphical representation aspect of the invention, the agent search activity is preferentially represented in a two or three-dimensional animated visual map form according to a preferential method of mapping, such as for example the so-called tree, cube, zonal, and sphere display types of the present invention.

In this form the individual web sites documents are represented as symbols or thumbnails and the hypertext link connections between them are represented as connector lines. Various symbol shape objects represent search identification status or web document type or popularity, and color coding represent Boolean search term match results as True, False, and Unknown, and visual thumbnail objects representing different kinds of reductions of web document visual elements or whole page.

Additionally, in the graphical representation aspect of the invention this two or three-dimensional object visual map network of sites, pages, documents and links between them can be navigated and tracked via several methods. This includes pointing at recent discoveries, tracking through chronology of discovery, multi-axis spatial rotation of the network, multiple Cartesian spatial references, point-of-view zoom control.

This further includes free flight simulation of the user point-of-view throughout the three-dimensional network representation, portions of which can be cursor highlight selected and click-able for launching the standard browser, such as Internet Explorer for example, to retrieve particular web page and or content media documents.

Additionally in the graphical representation aspect of the invention this two or three-dimensional object visual map network of sites, pages, documents and links between them can be automatically be executing and simultaneously displayed as a screensaver while the user is not working on the computer or web device interface.

In the retrieval aspect of the invention, the agent collects and saves to a local database predetermined types of documents. Documents can images, or music files or video, or text files or software application executables, or postscript documents, or any other specified file types of documents which are either present within or linked to the web page or network database under consideration for selective collection.

The collected elements are retrieved without the user needing to be present and are stored locally for the user to later browse and peruse using the system of the present invention and a standard web browser, such as Internet Explorer.

In the results formatting aspect of the invention, the agent ranks collected information, documents, images, files, and other results according to the:

(1) natural order in which the search discovery occurred, or alternatively results can be ranked according

(2) to search term matches of True, False, and Unknown, or

(3) according to discovered numbers of matches in the web pages based on word or

(4) numeric count metrics, or

(5) according to recency of changes detected in web pages previously visited, for example.

In the presentation aspect of the invention, the agent produces on-the-fly an HTML document which is derived from the collected and locally stored results, and which may be then saved as desired as an independent HTML document that refers to the collected elements in the local database.

In the results notification and or delivery aspect of the invention, the agent is specified as to when and how often it is scheduled to execute, and where the results are to be notified and or to be delivered via email to the user. Additionally, the qualified as true or false or threshold results notification may be used to launch another agent activity or any arbitrary application program, for example.

In the multi-agent or compound-agent or agent-suite operating aspect of the invention, agents can be linked to other agents to produce complex task production capabilities.

Further, in the peer-to-peer operating aspect of the invention, agents can be deployed to accomplish tasks using a plurality of personal computers with or without the need of using a centralized server.

Further, in the adaptive interpretive intelligence aspect of the invention, agents can use and compose complex dynamic mental models of the environment and use these models to more readily adapt to the environment, increase production efficiencies, provide higher quality information results, operate more autonomously, and interact with users more easily.

Primary advantages of the invention over prior art approaches to intelligent web based agents include:

(1) The invention provides means to have a one size fits all approach to agent construction, where there is a common engine architecture for all agents.

(2) The invention provides means for client side desktop resident or laptop resident or personal digital assistant agents with permit maximum capability for users to enjoy fair use copyright laws.

(3) The invention provides means for web search and web browsing automation which has the ability to prune the search based on different types of findings about any hypertext document or web page.

(4) The invention system is equally deployable in either a desktop client side application environment or in a server-side application environment.

(5) The invention provides means for non-programmers to specify and construct agents using ‘software wizard’ agents to assist in the construction.

(6) The invention provides means for informative intuitive network navigation by users using a plurality of user selected and user defined visualization display types.

(7) The invention provides means to visualize complex populations of information in three dimensions, including the ability to collapse information from three dimensions into two dimensions and apply the remaining dimension to representing another aspect of the information findings, such as quantitative metrics.

(8) The invention provides means to permit users a preferential range of incremental qualitative information zooming, from simple node graphics to fill web page display, thereby assisting in reducing the experience information overload and increasing selective summarization for users.

(9) The invention provides means for users to be compensated in a plurality of forms for creating and contributing new agents into a community of users.

(10) The invention provides means to auto-provision new agents or updated agents to users while maintaining user privacy of the actual usage of any agent since the agents operate from the desktop or client side and not the server side.

(11) The invention provides means to incorporate non-Boolean and extended Boolean logic evaluation methods to agent search methods.

(12) The invention provides means to effect comprehensive user-relative network interaction agent community resource management.

(13) The invention provides means to incorporate a plurality of agents in concert with each other to accomplish complex tasks using data-driven, forward chaining inter-agent inference mechanisms.

(14) The invention provides means to manage individual agents in relation to an adaptive deep knowledge base formation infrastructure architecture.

(15) The invention provides means to create single agents which are equally deployable manually, including as browsers extensions, browser-independent applications, or autonomously, such as automatic activated screensavers.

(16) The invention provides means for multi-path encryption management to permit a high degree of agent utilization privacy and anonymity by users.

(17) The invention provides means for deploying agent activity in concert and individually across peer-to-peer user networks without the need of a centralized server.

(18) The invention provides means to distribute large scale live web search tasks across peer-to-peer user computer networks with or without using a centralized server.

(19) The invention provides means to visually navigate network and linked web page visualizations using a plurality of cursor highlighting and network display browser tracking control methods.

### BRIEF DESCRIPTION OF THE DRAWINGS

The present invention is illustrated by way of example and is not limited to the figured of the accompanying drawings.

FIG. 1a is a block diagram of the integrated agent search, retrieval and email notification system.

FIG. 1b is a block diagram of ten interaction goals of ubiquitous personal agents

FIG. 1c is a block diagram of four types of agents encompassed together within an example personal desktop single agent capability.

FIG. 2a is a block diagram of interactive agent construction wizard module directing agent configuration and user interface creation.

FIG. 2b is a block diagram of the agent construction set up modules

FIG. 2c is a flow diagram of the agent construction process.

FIG. 3 is a block diagram of run-time, testing and navigation modules within the integrated system of the present invention.

FIG. 4 illustrates a display control panel window for inputting search terms, link test terms, metric terms, and search mode set up.

FIG. 5a illustrates alternate search navigation search and pruning modes combining only Page and Link navigation options.

FIG. 5b illustrates conditional use of metric channel elements to expand or prune the search.

FIG. 5c illustrates alternate search navigation search and pruning modes combining Metric and Link navigation options.

FIG. 6a illustrates a display panel that indicating the current status of the search activity of the present invention and the URL and text of the dimensional visualization pointer.

FIG. 6b illustrates a display log of a linear chronology of web site document pages visited by an agent

FIG. 7 illustrates a display control panel window for setting up and controlling the dimensional display of web documents that have been searched and or identified.

FIG. 8a illustrates the dimensional display window of web document pages discovered, with an associated control tool bar for activating different sub-control panels and displays.

FIG. 8b illustrates multiple windows open including the web browser report generated, network dimensional display, search term entry, search status, and visualization controls.

FIG. 9 illustrates a display control panel window for setting the network options for the agent search activity on the Web, including operations, time outs, and search depth.

FIG. 10 illustrates a display control panel window for formatting the results of the search and information collection results stored locally.

FIG. 11 illustrates a display control panel window for setting agent actions associated with the integrated system, including start, finish, special tests, notification, new actions, and information content media capture.

FIG. 12a1 illustrates the agent chain and application shell execution command line argument set up window.

FIG. 12a2 illustrates the preferred embodiment of agent chaining and external application launch capability.

FIG. 12a3 illustrates an example multi-agent chaining schema for an application.

FIG. 12a4 itemizes Agent-to-Agent URL Transfer Conditions.

FIG. 12a5 itemizes Agent-to-Agent SEARCH TERMS Transfer Conditions.

FIG. 12a6 itemizes Agent-to-Agent LINK TEXT TEST TERMS Transfer Conditions.

FIG. 12a7 itemizes Agent-to-Agent WORD METRIC TERM Transfer Conditions.

FIG. 12a8 itemizes Agent-to-Agent NUMERIC METRIC TERM Channel Transfer Conditions.

FIG. 12a9 itemizes Agent-to-Agent ACTION SETTINGS Transfer Conditions.

FIG. 12a10 itemizes Agent-to-Agent REPORT FORMATTING Transfer Conditions.

FIG. 12a11 illustrates interdependency within Agent Export Functions.

FIG. 12b illustrates a preferred hierarchy for agent and compound agent operational management and deep knowledge abstraction.

FIG. 12c illustrates a spectrum of agent and compound agent application domains facilitating one-to-many and one-to-one network interactions for users.

FIG. 13 illustrates two three-dimensional animated display windows showing web site document nodes and links in a fan display format.

FIG. 14 illustrates both complex and simple three-dimensional animated display windows showing web site document nodes and links in a spherical star display format.

FIG. 15 illustrates an example three-dimensional animated display window of web site document nodes and links in a fan tree format with fish eye perspective lens

FIG. 16a illustrates an complex three-dimensional animated display window of web site document nodes and links in a color coded cubic type domain layering format of the NASA web site with fish eye perspective lens.

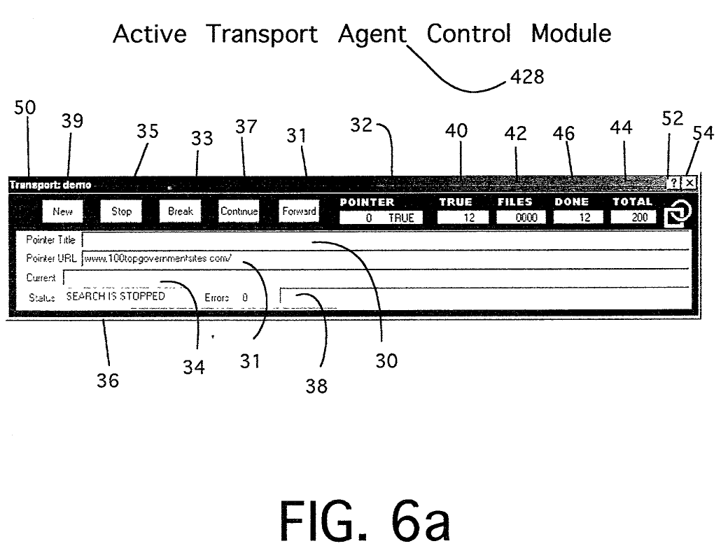

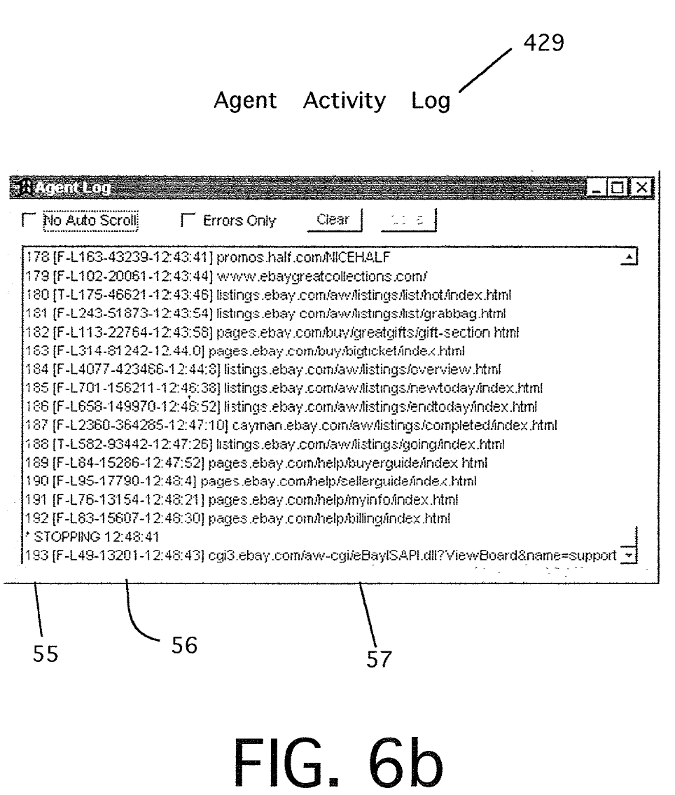

FIG. 6b illustrates an example three-dimensional animated display window of a portion of the NASA web site in planar shadow cast sphere display format with triangular bar chart elevation metrics.

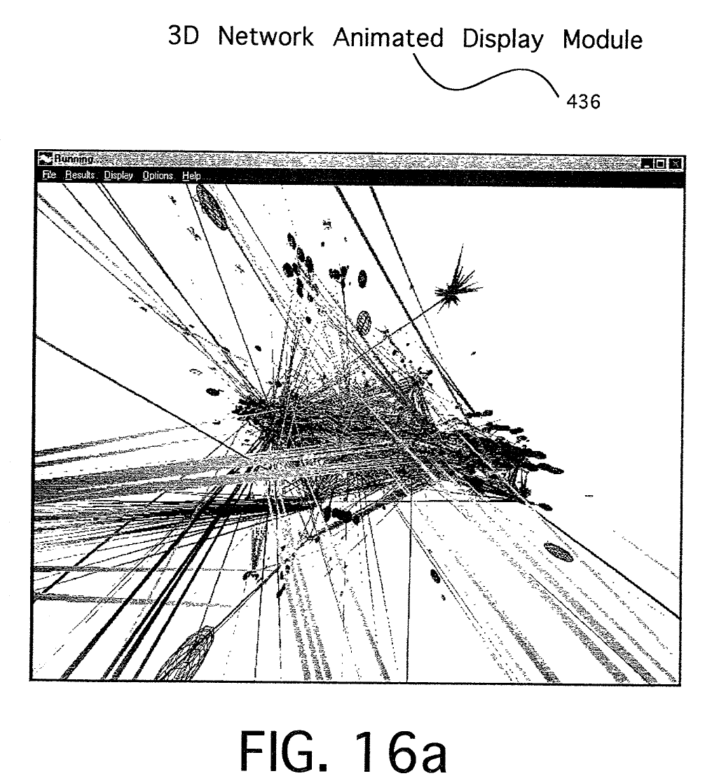

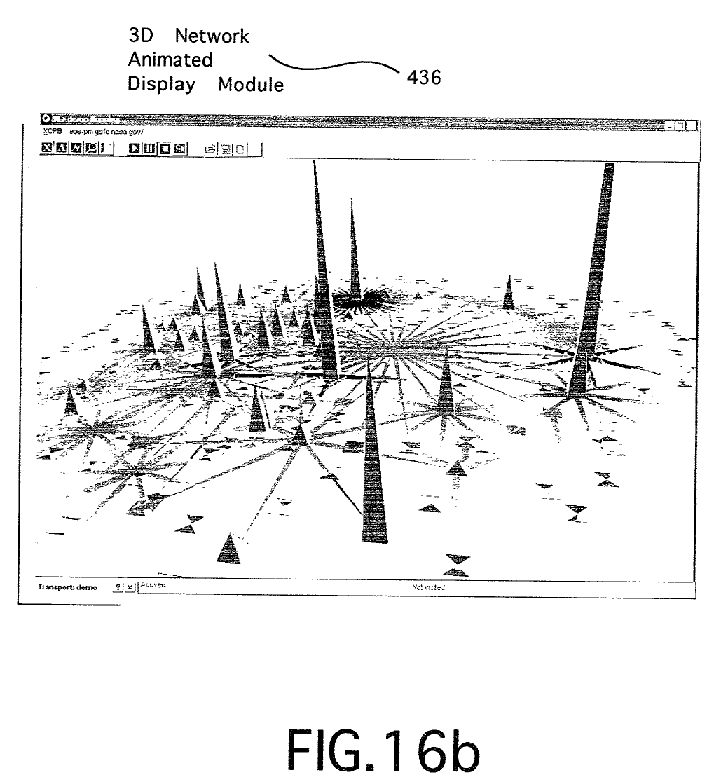

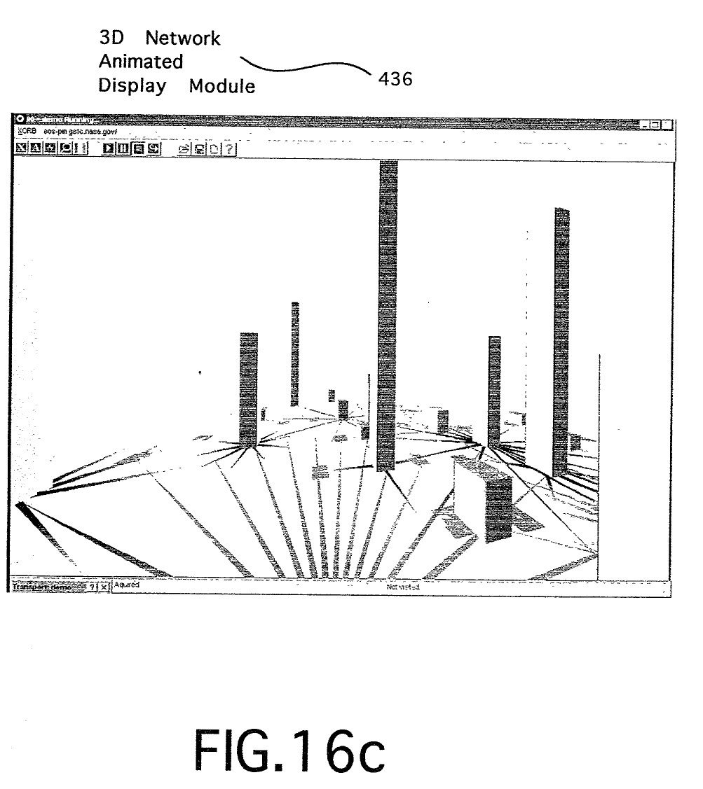

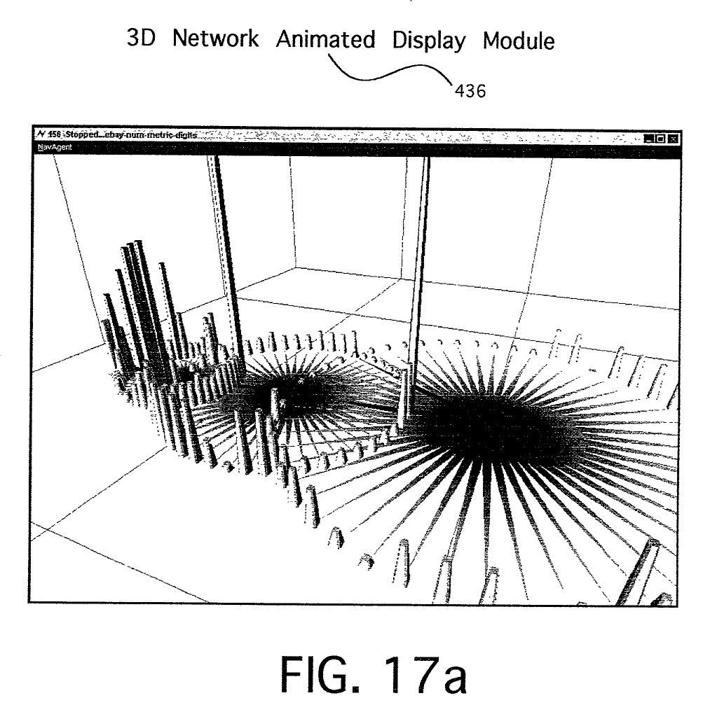

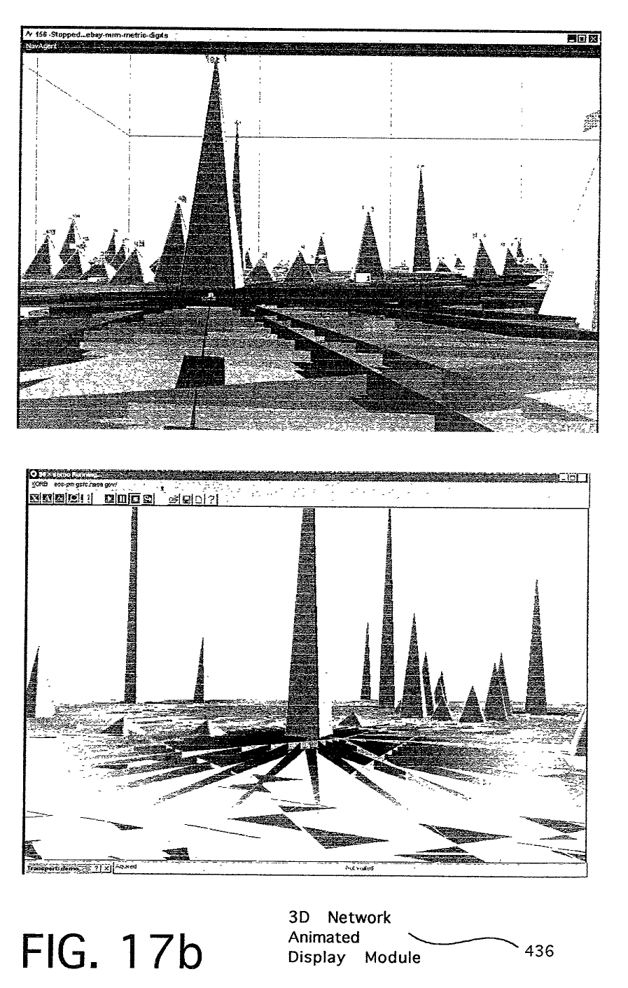

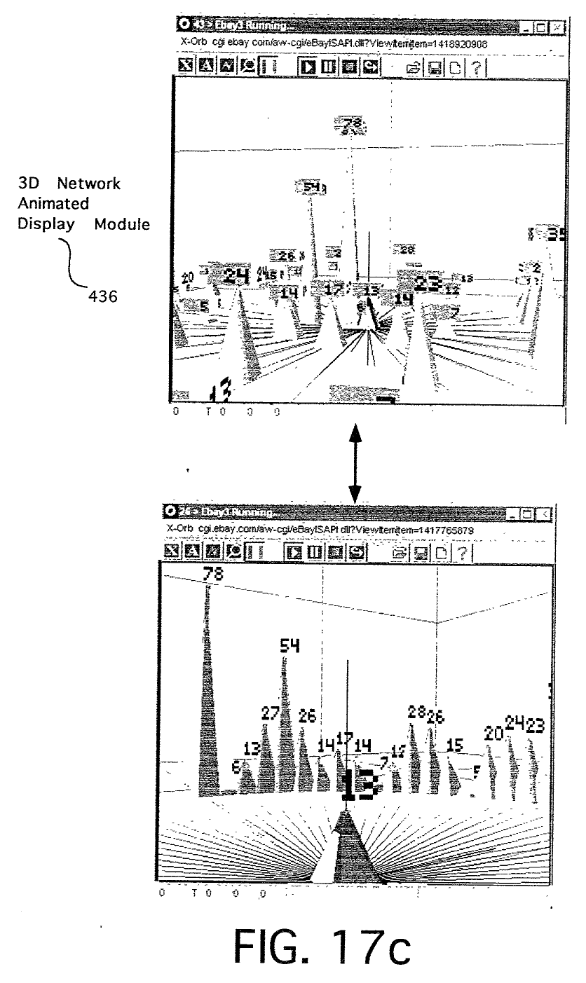

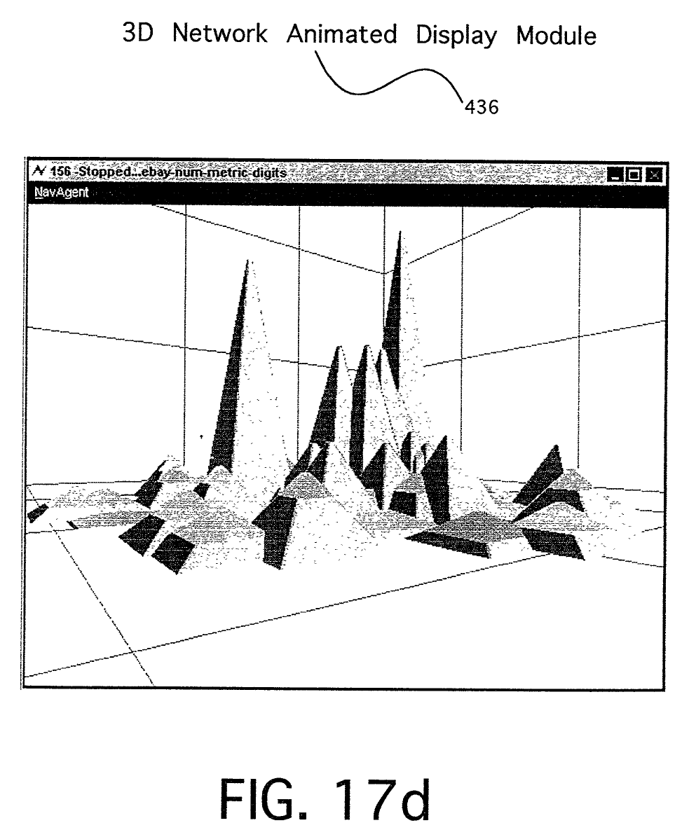

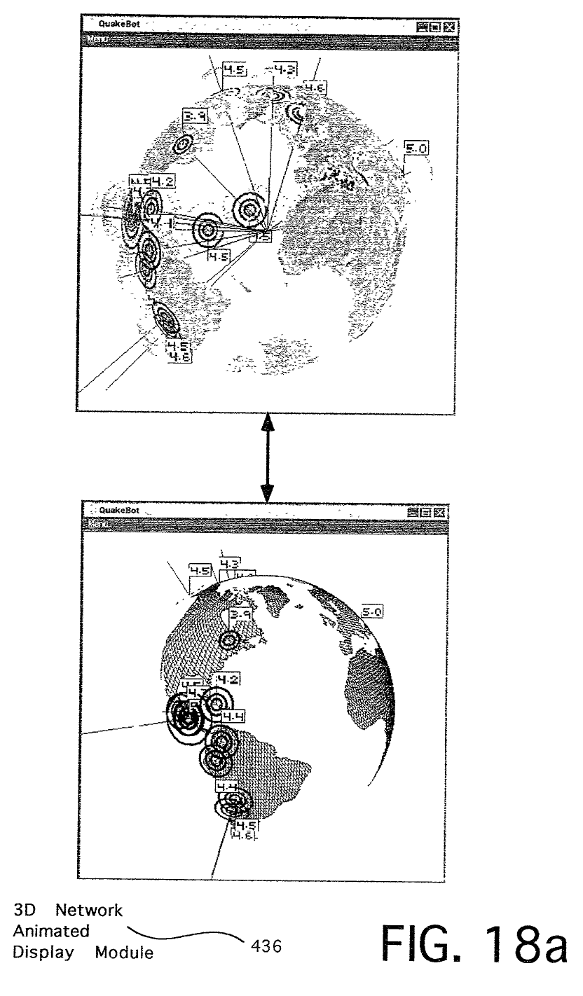

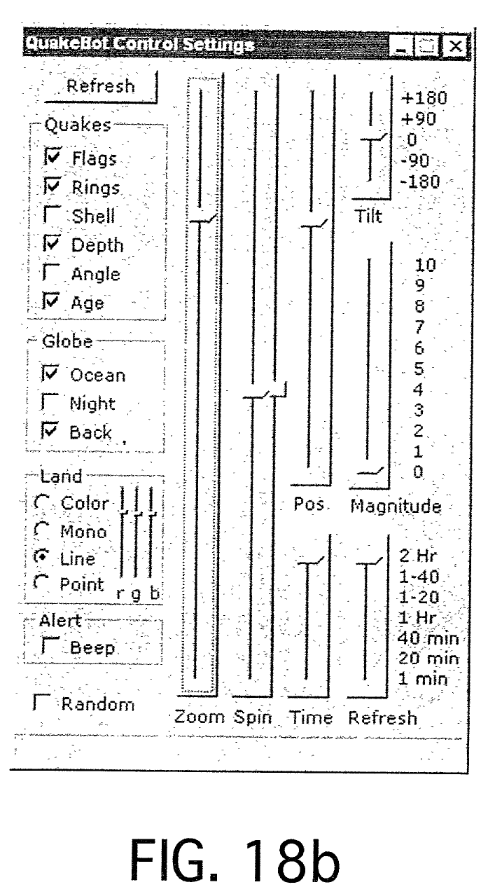

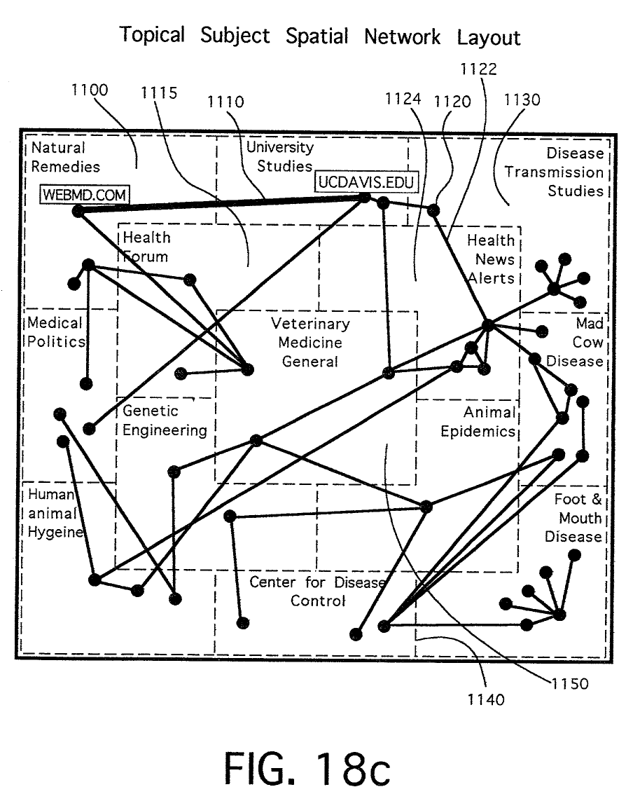

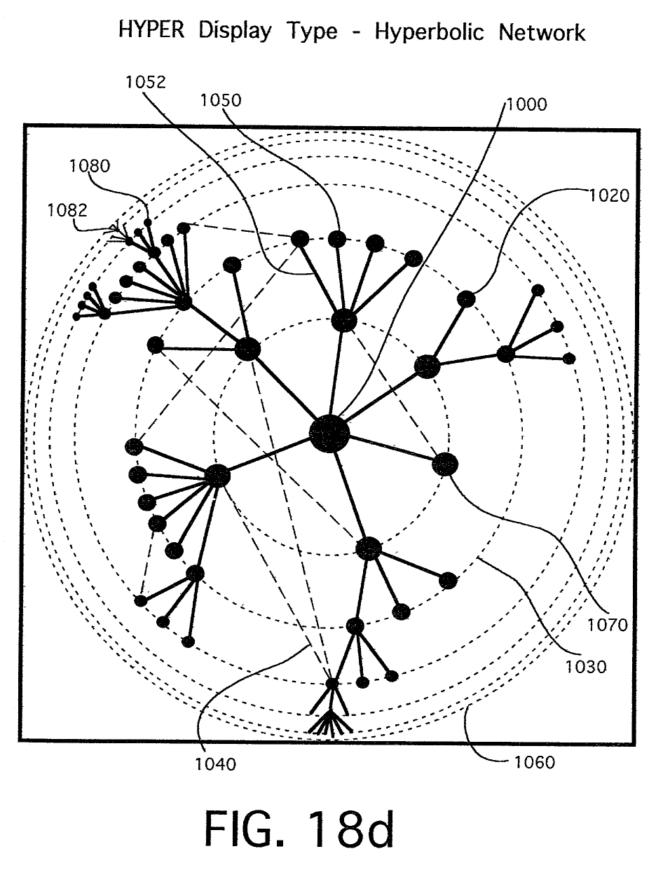

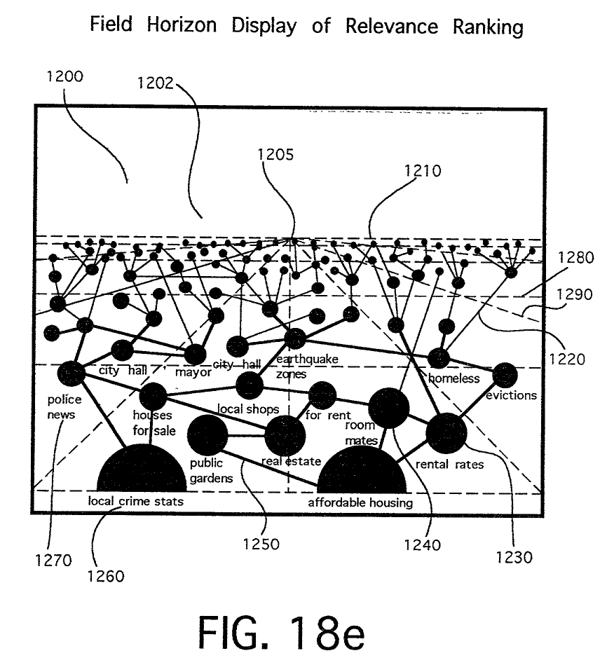

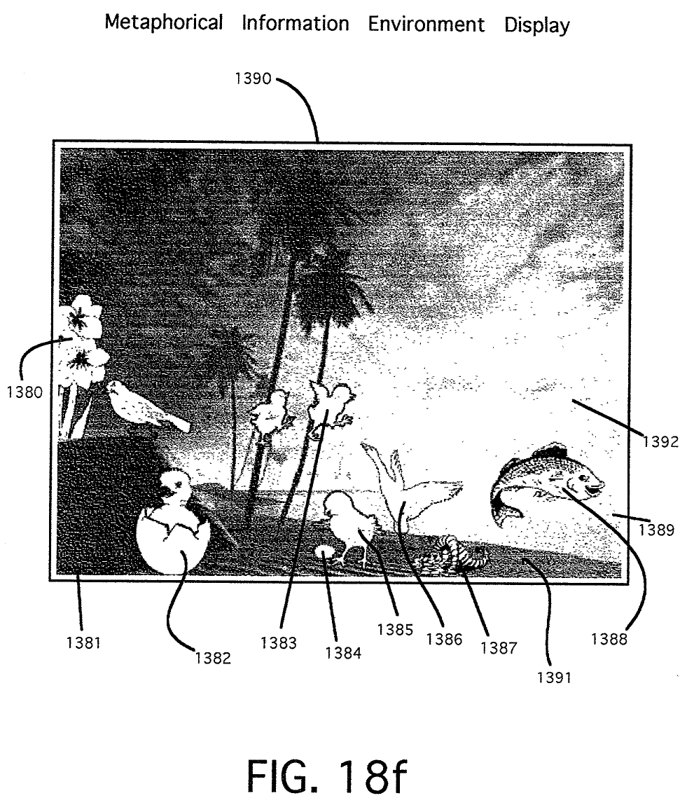

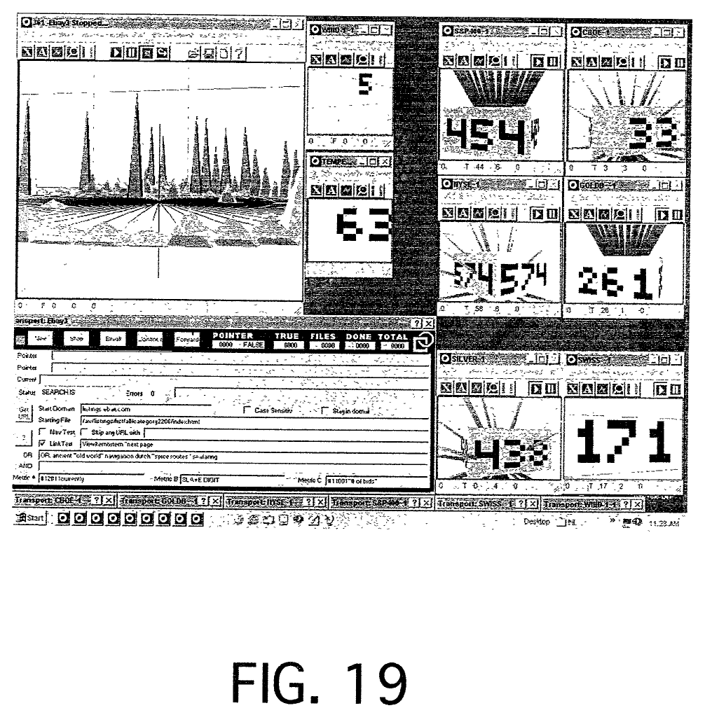

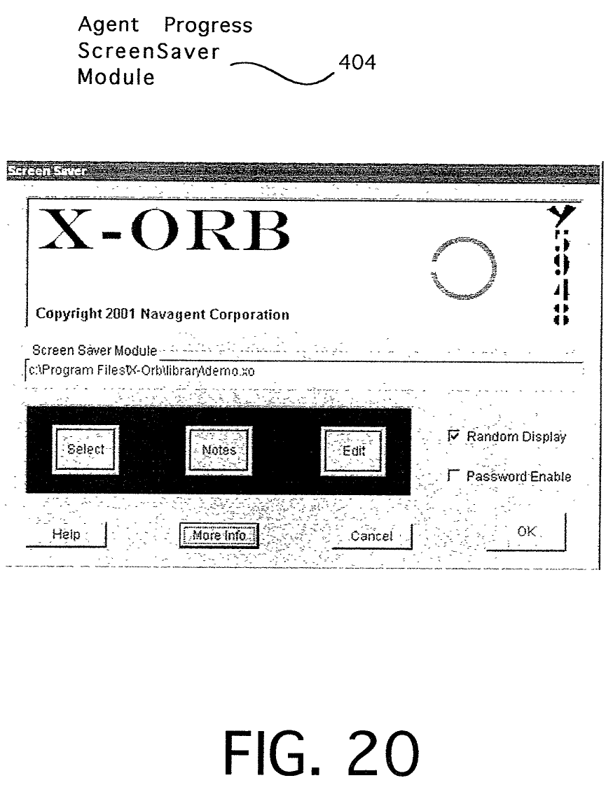

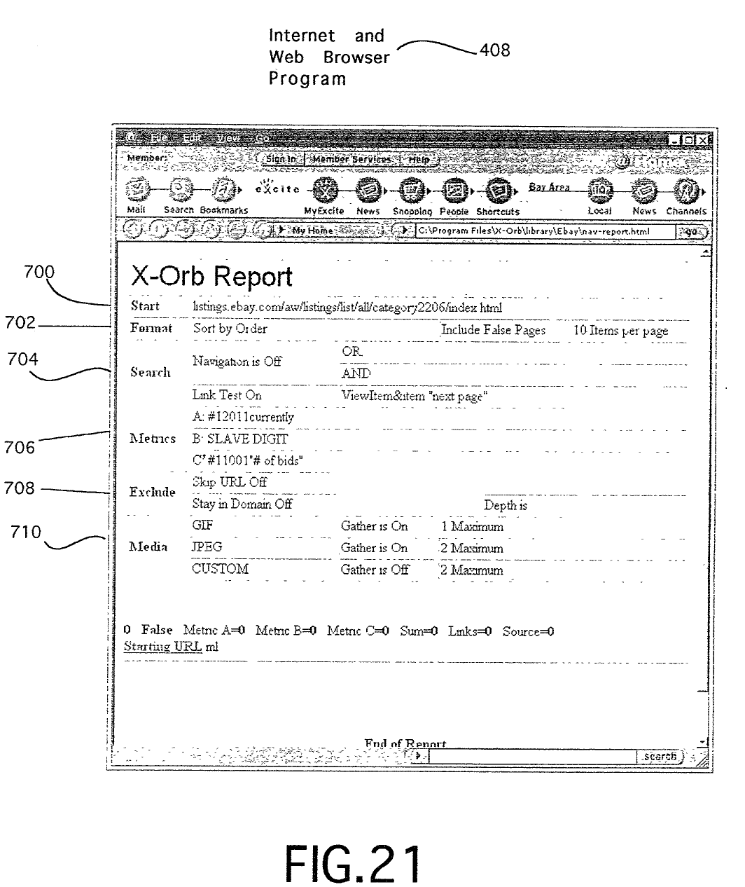

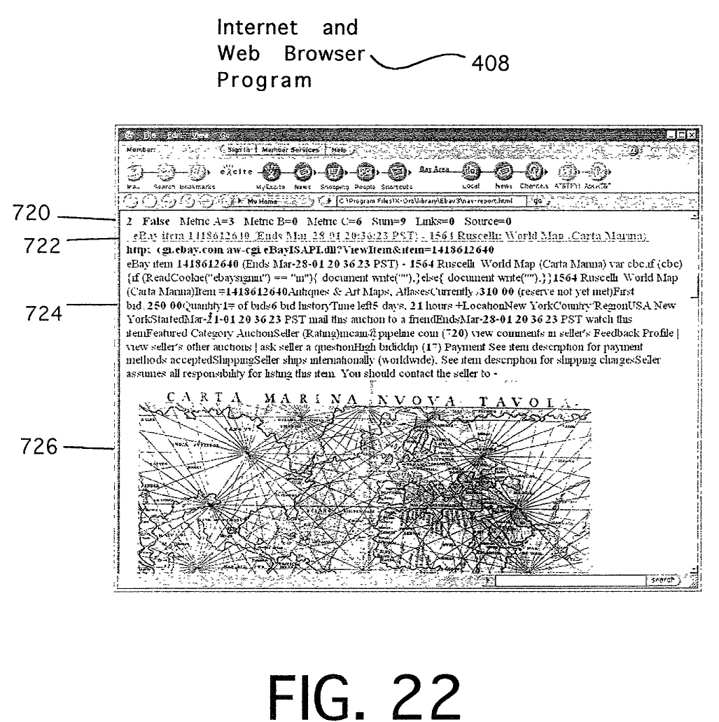

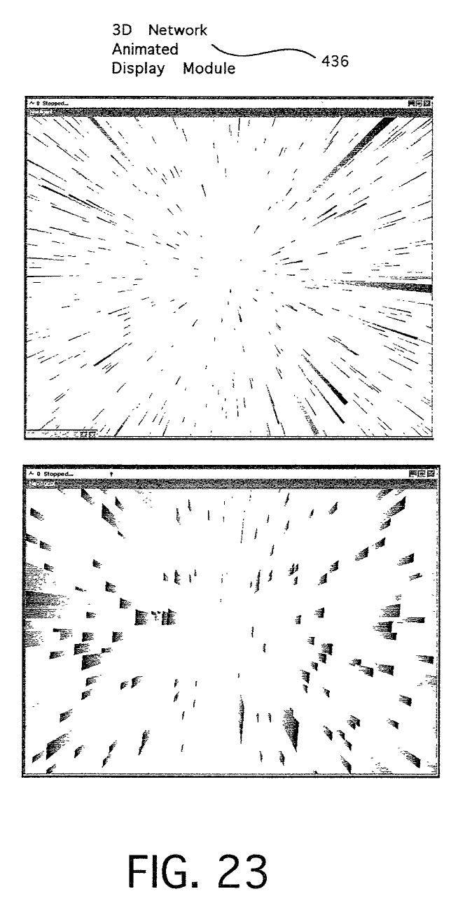

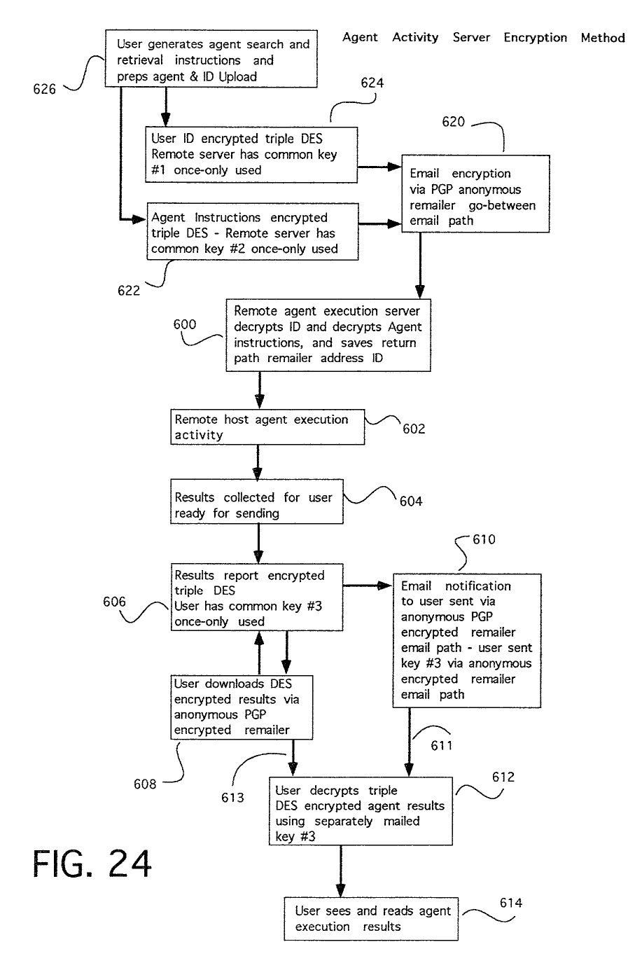

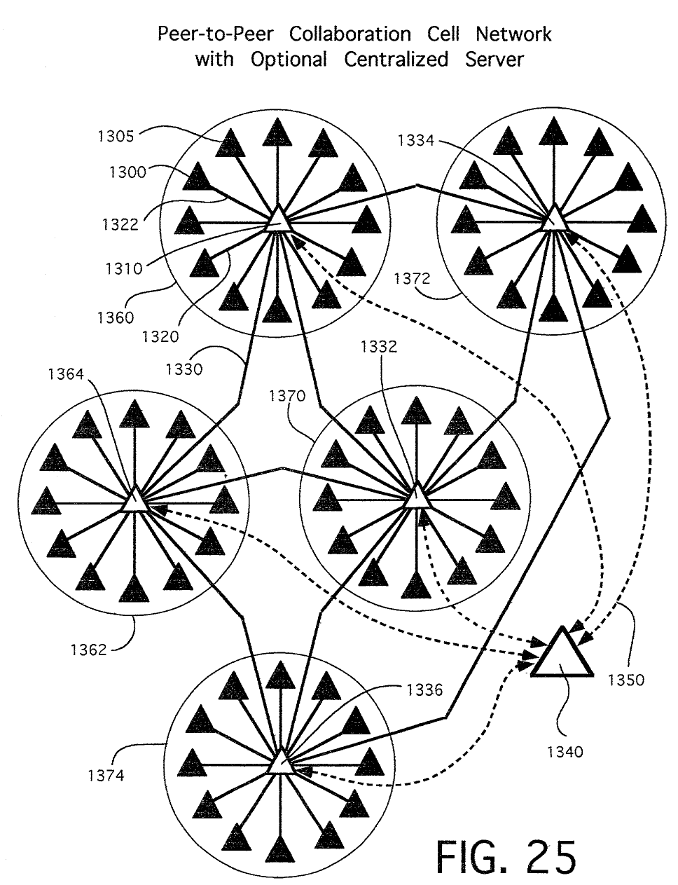

FIG. 16c illustrates an example three-dimensional animated display window of a portion of the NASA web site in planar shadow cast sphere display format with rectangular bar chart elevation metrics.

FIG. 17a illustrates an example three-dimensional animated display window of web site document nodes and links in fan format shadow cast onto a plane with metrics in a bar chart elevation format.

FIG. 17b illustrates two examples of three-dimensional animated display window of web site documents and links in a triangular bar chart elevation format.

FIG. 17c illustrates two three-dimensional animated display windows of the same web site document nodes and links in bar chart format with metric digit labels in both shadow cast tree fan format and shadow cast star format.

FIG. 17d illustrates an example three-dimensional animated display window of bar chart display with triangular bars to create a mountainous appearance for height discrimination

FIG. 18a illustrates a geo-spatial three-dimensional animated display window of recent earthquakes around the Earth.

FIG. 18b illustrates the earthquake display settings control panel interface.

FIG. 18c illustrates a topical layout display.

FIG. 18d illustrates a hyperbolic display format.

FIG. 18e illustrates a 3-D graphical Field display.

FIG. 18f illustrate a Metaphorical information environment display.

FIG. 19 illustrates an example of a group of agent three-dimensional animated display windows showing different numeric digits associated with different agents persistently tracking prices of commodities on the Web.

FIG. 20 illustrates the control panel for setting up an agent to launch in screen-saver mode.

FIG. 21 illustrates an example report format summary provided at the top of an on-the-fly produced HTML document of agent search and collection results.

FIG. 22 illustrates an example of a HTML click-able report detail listing for a web site discovered.

FIG. 23 illustrates an example of the network visual display occluded in cloak mode

FIG. 24 illustrates the sequential flow of multi-key, multi-path encryption.

FIG. 25 illustrates an agent work distribution peer-to-peer network.

### DETAILED DESCRIPTION OF THE INVENTION

A intelligent personal agent system is described for searching, navigation, content retrieval and results reporting of information and media content available on the World Wide Web, the internet, intranets, extranets, virtual private networks, and databases.

In the following description, for purposes of explanation, numerous specific details are set forth to provide a complete understanding of the present invention. It will be evident to one skilled in the art that the present invention may be practiced without these specific details.

As will be described below in detail, the present invention includes techniques for executing search for particular documents, symbolic dynamic animated representation of the found documents, three-dimensional (3-D) visual navigation between the documents in a virtual space. Further the present invention accomplishes document data set retrieval and local or remote storage, results ranking formatting, results notification, and flexible content delivery to the user on the desktop or via any email or HTML enabled device.

A client-side or server-side software application retrieves hypertext documents executing a user-selected search algorithm, which search results are displayed in several alternate three-dimensional graphical visualization formats. Hypertext documents are displayed as symbol or thumbnail nodes with connector lines representing links between the web documents, and nodes and connector lines are color coded for the user according to the truth of search terms tested for those documents, or according to domain type, link density, or metric counts. Different symbols can represent search and Boolean determination status, document type, and thumbnails can represent reductions of the whole or portions of a document page or type document found.

The 3-D displayed nodes can be navigated, tracked, positioned and cursor selection highlighted relative to the point of view of the user, and scrolled or browsed in different orders, such as ordered according most recent discovery, chronology of discovery, word or numeric metric count ranking, multi-axis spatial rotation, multiple Cartesian spatial references, zoom control, and free flight simulation of the user point-of-view throughout the three-dimensional network representation.

The result of searches performed by the system can be to retrieve the user selected documents or content media from the network. Then, the system can automatically format the results of the search and content retrieval according determined by a plurality of ranking methods, and provide alerts or content delivery to users locally or remotely using email or instant messaging methods.

A method and apparatus for search is employed which is a dynamic “live” search which can identify web site documents that have changed in the last few minutes, whereas prior art search engines are static in that the their databases are only refreshed once or week or even a longer interval.

The user provides a URL starting point, search terms, and optionally link terms, text or numeric metric terms, excluded terms, to the user interface control panel, and selects a “live” search algorithm to be employed. The URL starting point may be located on a server, and the server may already have served a page of web page address URLs embedded into the starting web page URL.

Alternatively in a second preferred embodiment, the user may provide a URL starting point which serves a list of non-URL addresses, such as ICQ chat or instant messaging user addresses, or the starting URL may contain other network address schemes which can be used to access other user computers which are active in the network.

The starting point may be an HTML document that resides on the user's computer, and which HTML document on the user's computer may contain one or more URLs, or other types of addresses, including dynamically assigned addresses of other individual users. The starting point may be an email message that contain a list of addresses, either in URL format or other individual user machine identifying addresses.

The present invention first preferred embodiment is limited to starting from URL or user machine HTML document pointers. The second preferred embodiment can include starting from addresses for computers and users connected to a network which are referenced by the user computer via other addressing schemes or schemes which layer on top of the traditional web URL addressing schema, which addresses are stored locally, or on a remote server, or in another users computer which is connected to the network.

In the first preferred embodiment, once the URL address or local HTML document is specified, the search can be commenced, either manually or automatically. If the user has a web browser open to the web page on the network from which they wish to begin their search, there is a button that can be clicked in the program in order to get the URL from the browser window to be entered as the starting point for the search.

Alternatively, the program can be configured to always be automatically collecting the URL address which the web browser is pointed to, and automatically engage certain search and document retrieval activities on behalf of the user. In addition, the program can be configured to develop a temporary database of the text and the document types which the browser is visiting, and develop statistical counts of the words and document types the user is visiting. This temporary database of statistical word and document type counts then provides a mechanism to direct the navigation of the prospective live search to only find pages and words of documents the user has been visiting.

This automatic web browser activity triggered search activity by the present invention can be further controlled by the user selecting particular words or documents on a page being visited using the web browser, which words become the entered terms for the program to use as Boolean search terms.

The search terms that are selected by the user, or automatically culled by the program watching the browser window contents, can be additionally referenced to a subject thesaurus which can add more similar words into the search word terms, link word terms or metric word count terms automatically entered into the program for searching.

This thesaurus may be present as a resource on the users computer or served from another computer on the network, and the reference thesaurus may be changing to reflect those similarity associations of words that are statistically relevant to the type of search, the time of day, world events, or selective third party reference paid inclusion.

The search terms are collected from a thesaurus, on the users computer or remotely, and may additionally be linked to URL pages of remote web sites on the network. Sites may be connected based on paid or preferential referrals that control which sites the search terms may invoke as possible suggested search and retrieval collection browser visiting destinations or as program search starting points.

Suggested alternative or additional URLs and web pages which can be offered to the user to pursue, can be manually selected for visiting by the user with a traditional browser, or may be entered automatically into the search subsystem of the present invention for search pursuit.

In the simpler configuration, regardless of how and where the user obtains and activates URL starting points for the search subsystem to pursue, once collected as a starting URL or as local HTML document, with one or more URL starting points, the program is then enabled to commence the search.

The present invention has a plurality of uses, such that any agent created using the tool aspect of the system can be run as a turn-key application. Therefore, the invention can be used as both a search and retrieval agent development environment and used as a completed agent executable application.

What distinguishes the present invention from other search and retrieval agent systems available for application to the World Wide Web, is that it provides a open ended flexible agent creation and configuration tool that does not require any programming experience to use, and thereby permits non-programmer users the ability to generate sophisticated web search and retrieval agents and suites of agents.

Another aspect of the preferred embodiment of invention is that it is designed to co-operate with a standard web browser to enhance user browsing productivity.

There are several methods described herein as to how developed or provisioned agents can automatically enhance user web browsing productivity in conjunction with using a standard web browser such as Internet Explorer available from Microsoft Corporation for example. Manually activated agents selected to execute automatic search, retrieval and browsing tasks include:

(1) TV-Guide site using their search features. After the user sets the preferences' (time zone, provider, etc.) the site sets a Cookie on the user system which holds these values. From this point on, the user can use the URL that is found on the browser after a search is performed. If the user looks at the agent search path setup display they will see their search terms embedded in it. This is only possible if the agent can handle cookies, which it does. What this means is that before the user can use agents on their site, they will need to visit the site at least once to set the cookie values.

The following simple examples of one aspect of what the present invention search and retrieval agents can provide for users, are described in second person procedural instructional form:

(2) AUCTION: Using your Web Browser, go to Ebay, do a search for what you are looking for, and when the results come back to your browser, go to the Agent window, click one button to grab the URL, and another button to start the retrieve, All pictures of rare coins current at auction are all combined into a single HTML doc for you to browse along with other auction data

(3) SEARCH RESULTS: Using your Web Browser go to Alta Vista search engine, do a search for what you are looking for, and when the results come back to your browser, go to the Agent window, click one button to grab the URL, and another button to start the retrieve. All or some pictures or text or site-metrics of choice are ALL combined into a single HTML doc for you to browse along with other and relieve you from having to go to all those search engine site results yourself to get stuff, whatever it is. You come back from a phone call or two, and voila, all results are there, without the hassle to endless clicking trails to check out the search engine results.

(4) UPDATE: Using your Web Browser go to Yahoo finance, select a page with all the data you want to track. Go to the Agent window, click one button to grab the URL, and another button to set the checkup internal, and click to start the regular update checkup of some site info, that is brought to your desk however often you want it.

(5) COMMUNITY FORUM: Using your Web Browser go to your favorite user group forum and select a topic area, and then leave the browser and go to the Agent window, click one button to grab the URE, and another button to start the find and retrieval. Any discussions and postings meeting your topic criteria are gathered and focused onto a combined HTML page for perusal, so you don't waste time going through everyone's post to find the discussion details you are interested in. If the site has a forum search engine, then use it and when the results come back, leave the browser and click on the agent to get the URL, and the same result occurs. You do not have to wade through it all yourself. The Agent concentrates your ‘vista’ to peruse and browse exactly what you wanted all at one, no more paging all around to get what you want out of all the forum postings.

(6) CHAT ROOM: Using your Web Browser go to your favorite chat room, jump to the Agent and click to get the URL, and the chat discussion transcript is captured live for later perusal.

(7) NEWSFEED: Using your Web Browser go to your favorite news feed site, and do a search using their site search engine, or go to any upper page with lots of choices embedded in it, and switch to the Agent. Click to get the URL and then click to start live search and retrieval of any info sources or topics you wanted to follow, (after you type them into the Agent search line) which are then concentrated into a single combined HTML result for later and ongoing perusal.

(8) KNOWLEDGE BASE: Using your Web Browser go to Britannica Online, enter a search term on their search line, and when the results list comes back, click the Agent to get the URL you are at with all these search results. One click later the Agent is going to get text associated with all those listings, and gather and bring back any pictures or audio files for example, all available in a combined HTML, where the order of appearance of deep results in the Agent created HTML are ranked by # of time the search term was present in the encyclopedia body content sections, or even by additional new metrics of value you think of, on the fly.

(9) E-COMMERCE INFO: Using your Web Browser go to Amazon to search for books on a certain topic, and when the search results of a long list come back, leave the browser, go to the Agent. Click once to get the URL, and find and retrieve just all the pictures and text reviews for books on this topic. Vome back after one short phone call and all the book covers and reviews you wanted to see are all combined into a single web page for easy perusal.

(10) E-COMMERCE INFO: Using your Web Browser go to CNET to check latest for latest prices and availability for laser printers for sale. When the listing of the laser printers of your choice appears on your browser, jump to the Agent, click to get the URL from the browser. Select for retrieval of text or pictures or spec sheets, click to start, and come back in a few minutes (or run it in the background while doing other tasks), and all the collected spec sheets and printer pictures are gathered for you into one continuous HTML file for browsing, When viewing the Agent results, click on the printer URL that meets your needs the most, and jump back to the browser to now go to that web page.

(11) WEB LINKS: Using your Web Browser go to your favorite Links page with the browser, and click on the Agent to get the URL, and enter search terms you want to pursue, select what you want to retrieve. Click start the Agent to find and gather any links and web page contents from those links, whether text, or media. In a few minutes to twenty minutes later if on a slow access connection, come back to view the result gathered, thereby saving time to drill down all those links to find and then get information and media you want to browse all at once combined into an HTML file.

(12) EDUCATION RESOURCES: Using your Web Browser go to the Harvard.edu web site and search for faculty in the computer science department using browser. When the results list is returned, go to the Agent window and click to get the URL, and enter in a few target search terms like “agents”, and file types like .PDF and PS. The Agent will gather all the academic papers by the faculty that are about “agents” and place them all in a folder on your hard drive for later perusal using a postscript reader or Acrobat.

(13) GOVERNMENT RESOURCES: Go to Nasa.gov web site and click to go to Malin Space Systems, which has all the latest Mars pictures, click on the submenu you want to gather from, then go to the Agent window, click to get that URL, and enter .JPEG in the gather line, and click to start to grab all those Mars pictures that take so long to download with a 28.8 modem. Come back after lunch after the job is done, and all the Mars pictures are in one HTML document folder to browse and peruse. Pick one you like the most and go there using the standard browser. Then click on the hi-resolution version to download that to your desktop.

(14) INTERNIC: Go to Internic to click and capture the URL address searches internic.com for the availability of “PQRSTUV.com”. It is setup to scan a single page and look for the occurrence of “no match”. This indicates that “PQRSTUV.com” is not registered to any one. If the result is false, it will wait 1 minute and then try again. It will do this ‘N’ times before it gives up and goes away.

(15) PRICE MINDING:

In all these above examples, the resulting HTML web file report is already resident on the users hard drive for off-line perusal. At anytime, the returned rich-media results of the Agent can be then used to get back online and launch the standard browser to go to the desired site and browse it filly.

In all the above examples, there is the trend towards using the standard Explorer or Netscape browser the way it normally would be used. Then the user jumps off the browser when reaching a particular URL or results page URL, and activate an Agent to go search, find, visualize, and/or retrieve and concentrate the web information and data set collecting the user wants into a compact, one-stop viewing experience.

The system provides a plurality of different functional capabilities, including being equally identifiable as many different types of product in one. This includes being:

(1) a form of network ‘browser’,

(2) a web ‘browser extension’,

(3) a network ‘spider; or ‘web crawler’,

(4) a network ‘search engine’,

(5) a network ‘desktop search tool,

(6) a network ‘update notifier’,

(7) a network ‘visualization tool’,

(8) a network ‘navigation method’,

(9) a network ‘data mining tool’,

(10) network ‘media content retrieval system’,

(11) a network ‘autonomous agent system’,

(12) ‘a multi-agent network’,

(13) a network ‘applications generator’,

(14) an online ‘productivity screensaver’,

(15) and a ‘peer-to-peer distributed search system’.

The object of all of these characterized methods is to permit users to search for and find information and file content they want on a partly or fully automated basis. A further object is to personalize and deliver the results to the user in a timely and effective and remote manner. This object is accomplished regardless of whether the user is local or remote from the computer system used to perform the tasks of search, retrieval, visualization, navigation, ranking, data set compilation, notification, delivery and presentation.

A primary object of the present invention is to provide a leap forward in enabling users to manage information overload. The invention accomplishes this by providing integrated and also modular means for users to intelligently, search, identify, retrieve, analyze, sort and deliver information on a network to themselves or other users.

A benefit generated is saving the user time, increasing information collection productivity, expanding exploration and choice horizons, concentrating the value and personal relevance of results, and not requiring a large investment of time to learn the skills to create custom solutions for themselves personally or for their business.

A key difference is this invention introduces the capability for active autonomous browsing as an improvement beyond existing manual reactive browsing as provided in conventional popular browsing tools such as Internet Explorer or Netscape Navigator, for example. In the current preferred embodiment the present invention provides users with a complement capability to the standard web browser. In one embodiment of the invention the capabilities described are fully merged with the current complement of web browser features.

The present invention includes a productivity screen saver mode of operation, where agents launch when the user leaves their computer idle yet still online on the network. Agents launched during client computer idle time are typically not real-time or near-real-time sensitive. Alternatively, such agents may be performing real time sensitive tasks, and when finished can be configured to notify the user. Notification can occur via remote email, such as voice enabled email served to a cell phone for example, or notified via an audio bell alert if the user is in the physical vicinity of the computer for example.

In another embodiment of the present invention, user authority proxy agents for executing user purchase transactions are implemented. Proxy agents which can effect, for example, web form and database query form filling and submission for effecting user purchase and subscription transactions, log-in transactions, and user agreement acceptance transactions These are called User Identity Agents, and store encrypted user identity and user authority password information, email address, phone numbers, address data, credit card data and any other supplemental user identity related information.

User Identity agents operate in conjunction with search and retrieval agents to enable access to portions of the network which are protected or restricted areas and require access privileges to be entered or user. User Identity agent thereby permit search and retrieval agents to operate in these protected areas. Identity agents can be pre-set as user proxy agents to automatically engage in purchase or bidding transaction on behalf of the user.

The present invention includes techniques so agents can be directed to search and retrieve documents of any type over Local Area Networks, Extranets, Virtual Private Networks, databases, and user local hard drive storage. Agents can search any file type, including the internal text, audio and video and stills of all kinds of documents that exist locally on the user computer storage or remotely linked to a user storage facility.

Further, agents can search and retrieve component internals of documents at large which are hosted or posted on the web or in web server connected databases. Further, agents can thereby determine whether to gather for the user different document file types and titles based on what was searched and found within the documents, such as a .PDF document or an MP3 document, for example.

The present invention includes the capability of agents to parse Java script pages, and agents which can search and parse Java applet generated text and images, and agents which integrate with enterprise Java Bean systems, and additionally read and search a variety of XML database systems.

The present invention includes the capability of having search and retrieval agents configured to watch a particular users browsing and uploading or downloading and email activities over an ISP and gather behavioral and content identification data based on stored preferences as a surveillance system.

The present invention permits agents to issue commands through the network to adaptively operate and control external interface devices via the internet or local area external device network command protocol.

This can include cameras, microphone, ovens, toasters, lights on or off, calling the police or fire department after verifying crime or fire or theft activity for example, The agents are adaptive by developing a database profile of user habits and activities in order to anticipate, suggest, and autonomously reproduce user control behavior based on manually set user preferences.

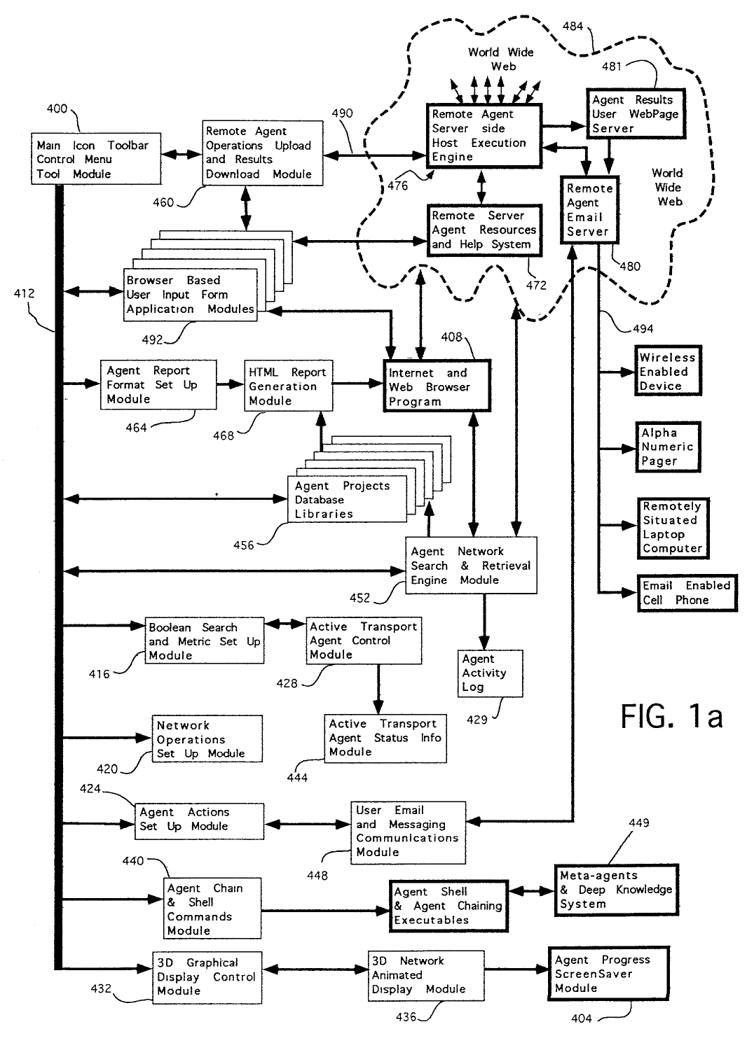

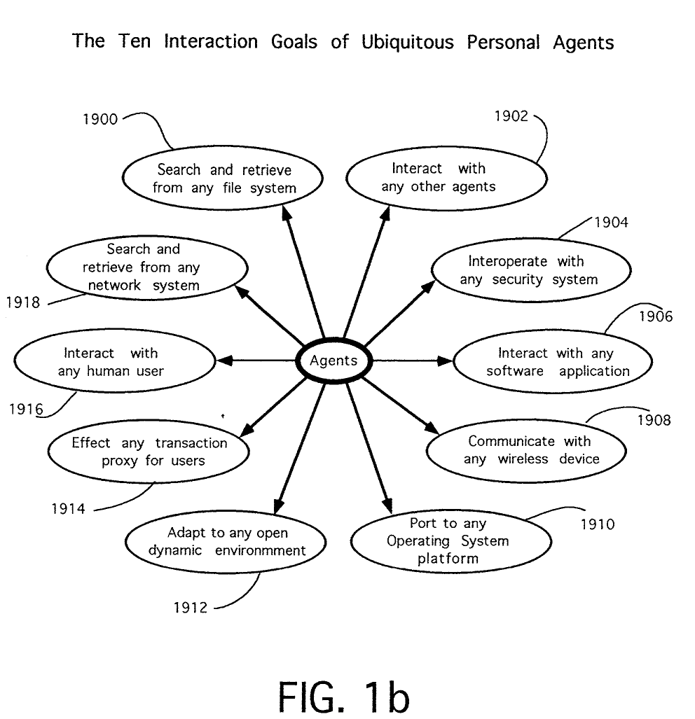

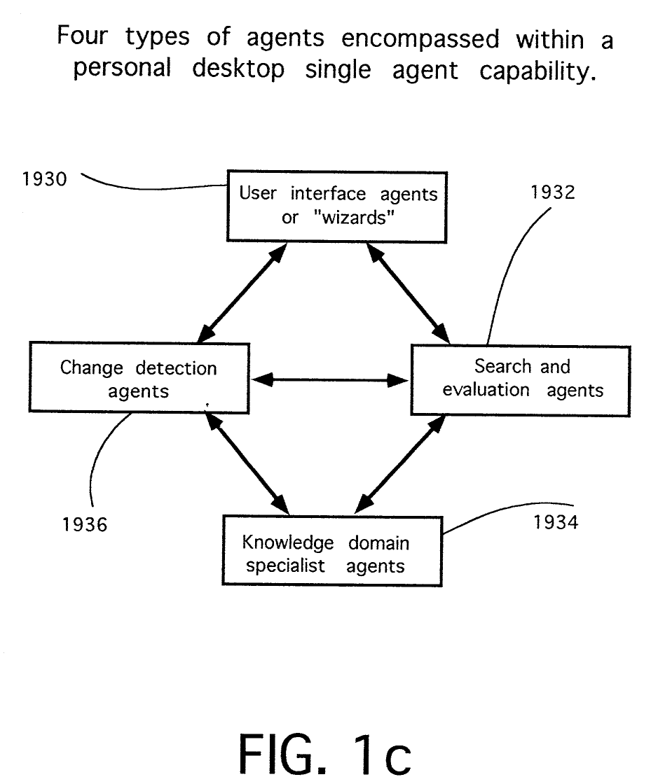

FIG. 1 illustrates a block diagram of the modular components of the present invention, which together implement the preferred embodiment. The software operates as an application resident on a user computer, running under a standard operating system such as Windows, Macintosh or Linux Operating Systems for example. Software communication bus 412 is a bi-directional messaging system channel between the execution modules of the program.

The program has a Main Icon Toolbar Control Menu interface 400 which permits the user to access and control the various module functions of the program. This toolbar 400 is used when the user is configuring and controlling a search and retrieval agent activity using the system. One of the alternate modes of operating the agent system after an agent activity and control configuration has been set up, is to launch the agent as a Screensaver 404.

Alternatively the user can select agents to run by double clicking on agent project icons stored in the agent projects library or from the desktop using a shortcut icon.

When the user is attending the agent set up and run time activity, they can move between the standard internet browser such as Internet Explorer, and the agent system, including having the system manually or automatically collect the current URL displayed by the browser.

Further, the user can have the browser launch to visit a remote web page document selected by the system, or having the system use the browser to display the results of a search and information retrieval activity during or after the agent activity is completed.

If agent activity results are displayed in the browser before the agent activity is finished, the HTML report generator 468 will display the results collected so far.

Another mode of operation of the system is to launch based on an agent action launch scheduler set up previously using the Agent Actions window 424.

Another mode of operation of the agent is to utilize a remotely situated server side agent execution engine 476 which performs the agent activity remotely from the user's computer or web enabled device and returns the results via Email 480, or via automatic upload and download provisioning system 260.

FIG. 1a Remote server agent resources and help system 472 is automatically notified when agent activity is launched. It can provide local agent control, registration confirmation, agent usage suggestions based on popularity or observed user browsing and agent activity, and may automatically serve the local agent application system advertising banners for inclusion in the agent results report generated by the HTML generator 468.

FIG. 1a Boolean search and metric set up module 416 is used by the user to enter the search terms, metric counting targets, and network navigation preferences. The Network operation set up module 420 is used to set preferences for the network interaction operations, including specifying the user machine identity, operational preferences, search depth settings, and time outs.

The Agent actions set up module 424 is used to set preferences for agent actions on start and finishing, including agent shell commands 440 which can be used to activate or chain multiple agents. Additionally it can used to activate other applications based on prior agents results, and including remote email messaging 448, and which agent actions settings are stored and used by the agent network search and retrieval engine module 452.

FIG. 1a Active transport agent control module 428 is the user manual control for starting, stopping and continuing agent activity by the engine module 452. Engine module 452 activity and user agent control activity using module 428 provide inputs that are displayed in the Active agent status information module 444.

Toolbar 400 opens 3D graphical display control module 432 which sets the animated network display and visual navigation interaction preferences of the 3D network animated display module 436. Display module 436 inputs to the status information display 444. A remotely activated server side agent engine 476 activity can launch a local agent activity 452 via Instant messaging module 448.

The remote agent operations upload and download module 260 interacts bi-directionally with the remote server side agent execution host 476.

As the agent network activity execution module 452 generates collected results, the agent project database library 456 is filled with collections of documents. On user command use preferences stored by the agent report format set up module 464 to direct the HTML generator 468 to produce an HTML document display in the standard browser 408.

Results produced either through the local agent engine 452 or the remote agent engine 476 can be opened by the screensaver 404 or main toolbar 400 for viewing in the network 3D display module 436. This is based on user preferences set by the 3D display control module 432 or downloaded preferences of as third part via web site 472, or default settings provided from the remote agent engine execution host 476.

The FIG. 1a client side local agent engine 452 engages operations with the network connection 490 to a portion of the open world wide web network 484 or 480. Remote server 472 and remote host agent engine 476 reside on remote servers on the web or network, acting as servers to act on local user commands from the local agent application and to supply commands to the local user agent application.

The screen-saver mode is initially set up and previewed by the user doing the following actions:

(1) install the program;

(2) go to the Windows screen saver panel and select X-Orb;

(3) press PREVEIW to see what it looks like;

(4) go into the SETTINGS and check the “random settings” box and press OK; and

(5) press the PREVIEW button to see the screen saver display. The present invention can be interactively controlled and operated using a so-called ‘application wizard’ software shell, such as application wizards for setting, up and configuring individual agents or groups of agents and related operations.

A set-up and operations wizard can employ a natural language interpreter and a natural language synthesizer, for example, to provide a purely conversational interface for the user who is not inclined to take the time to understand the other available means to set up and configure the agent.

The elicitation process the wizard engages can provide a easier to use method for creating agents, modifying agents, interacting with the traditional browser such as Internet Explorer for example.

In one embodiment of the present invention the entire search and retrieval agent system provides a animated digital character representing individual agents or suites of agents. The digital character becomes the anthropomorphic representative identity of the natural language interpreter and natural language conversational synthesizer.

FIG. 1b is a block diagram often major goals of ubiquitous personal agents, including:

(1) the ability to search and retrieve and read any file 1900;

(2) to interact with any other types of agents 1902 through any common agent communication language;

(3) interact with any type security 1904;

(4) interact with any software application 1906;

(5) communicate with any wireless system 1908;

(6) port to any operating system platform 1910;

(7) adapt to any open dynamic environment 1912;

(8) effect any transaction proxy for users 1914;

(9) interact with any human user 1916, and

(10) the ability to search and retrieve information and content from any network system 1918, such as the web, intranets, extranets, peer-to-peer networks, and virtual private networks for example.

FIG. 1c is a block diagram of four types of agents encompassed together within an example personal desktop single agent capability, This compliment of capability can exist resident within a single agent or within a collection of agents on desktop system. The compliment includes user interface wizards 1930, search and evaluation agency 1932, change detection agency 1936, and knowledge domain specialization agency 1934.

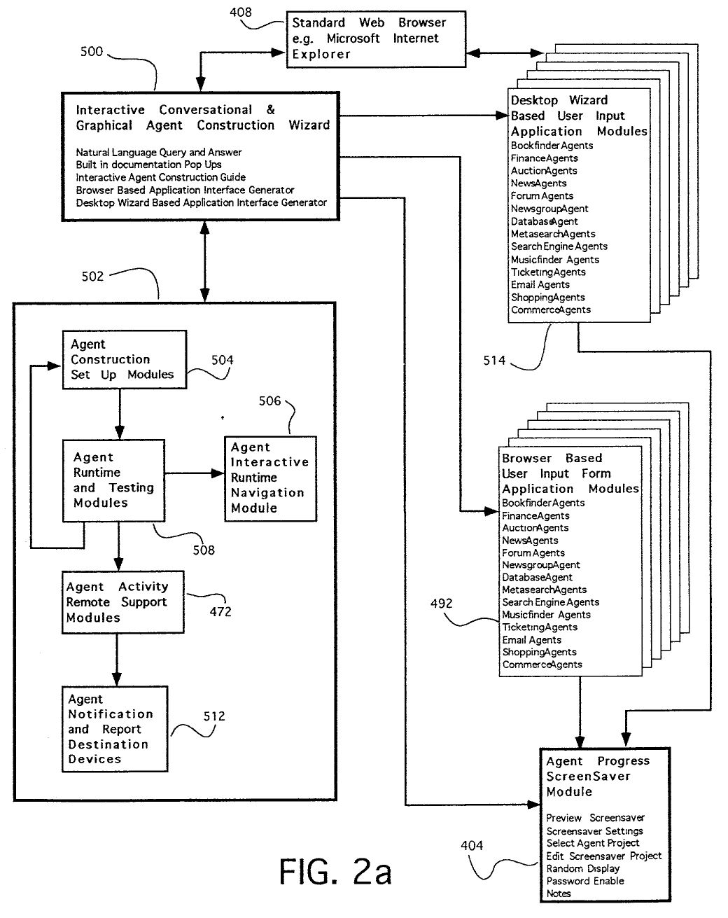

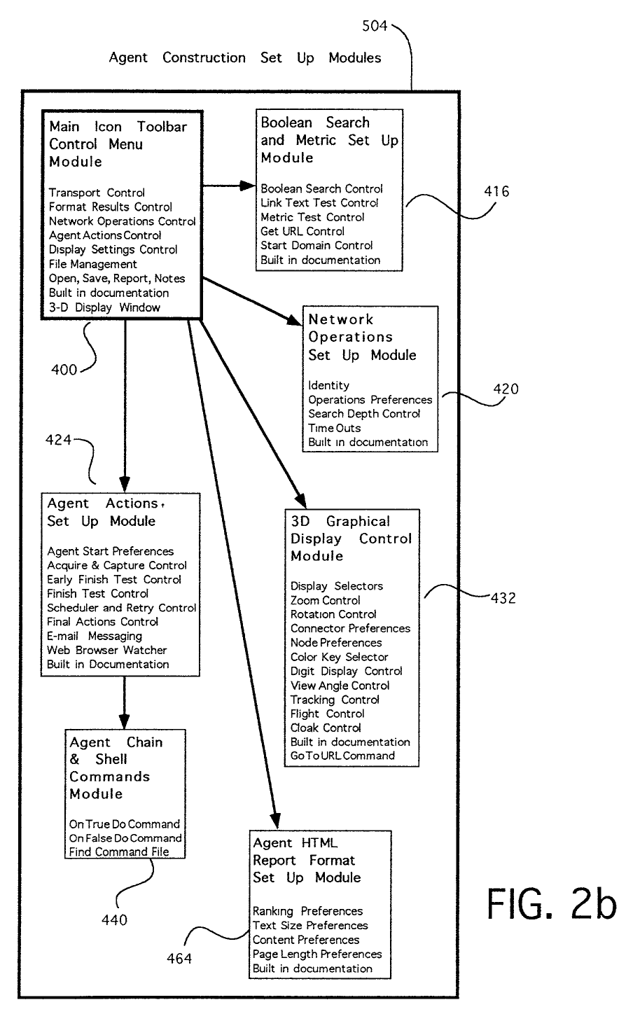

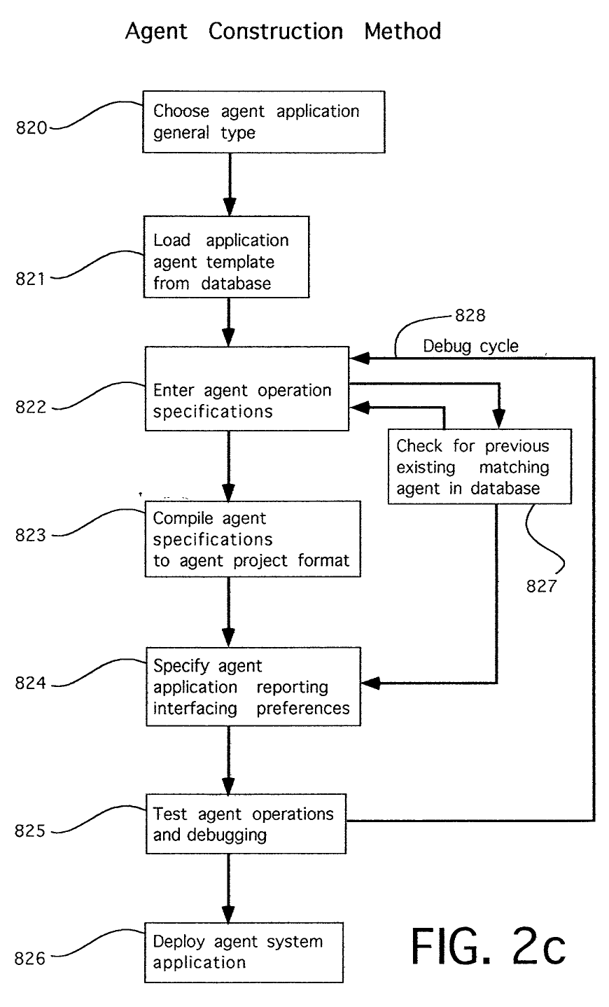

The FIG. 2a block diagram illustrates the general arrangement of modules used to construct agents. This method includes the use of user interaction sequencing that is led by a software wizard that asks questions in a conversational manner, and provides line entry and multiple choice entry for users in order to construct agents without foreknowledge of the details of the agent construction tool. The FIG. 2a Construction Wizard 500 engages the user in a sequence of actions that configure a single agent or a chain of agents or a group of agents.

The construction wizard interface uses graphical and text components to proceed in assisting the user in creating agents. The construction wizard 500 engages in interaction with the user to configure the various agent building modules of 502.

The agent building modules 502 include the agent construction set up Modules 504, which are configured with appropriate agent activity description. Once the activity descriptions have been completed the agent run time and testing modules 508 are engaged to check if the set up has been properly completed. If not, then the construction set up 504 activity is engaged again.

The FIG. 2a runtime testing modules 508 can be augmented using remote network server based agent activity support modules 472. The testing modules 508 can also engage the user during testing using the interactive Navigation module 506. Once the agent search and retrieval activity using testing modules 508 and preferred user navigation activity 506 are completed the agent notification and report destination devices 512 are set up. The agent notification and reporting devices 512 are enabled using email or instant messaging or wireless device messaging systems.

The FIG. 2a user interaction wizard 500 during the agent construction process interacts with the standard internet browser 408. This browser 408 and the wizard 500 work as companion systems to set-up 504, test 508, navigate 506 and provision reporting 512 the agents. The wizard 500 outputs as a result of this activity two components, the configured agents and simplified configured user interfaces 514 or 516 for using the agents.

Additionally the wizard 500 can output a screen saver configured agent 404. This process can produce a plurality of different agents usable via either browser 514 or as stand alone or embedded software applications 516, that accomplish different kinds of functions for an end user, including but not limited to, for example:

Book Finder Agents

Finance Agents

Auction Agents

News Agents

Forum Agents

Newsgroup Agent

Database Agent

Meta-search Agents

Search Engine Agents

Music Finder Agents

Ticketing Agents

Email Agents

Shopping Agents

Commerce Agents

Knowledge Agents

News Group Agents

Each of these different example agents are further configurable for specific needs by end users using the simplified interaction interfaces produced by the agent creator.

The auction agents are open-ended as to what items the user is looking for, for example.

The meta-search agents are open ended as to which search engine resources on the network the user wishes to consult, for example.

The news agents can be open ended as to which particular types of news items the user is seeking to be informed of, for example.

The MusicFinder agents are open ended as to what type of music or what artist the user want to find information and MP3's, for example. Each of the browser based 516 or other application based 514 agent interfaces can be activated in screen saver module format 492, if desired by the user.

In one embodiment of the present invention the entire interface is reduced to a single tool bar and control console that is appended to the shape and size of the standard browser, or become integrated with the browser as a plug-in using the standard plug-in implementation techniques.

Alternatively the invention can be used as an entirely browser based capability that is either served remotely from the client computer interface or is locally operating as part of the browser capability and technology. This can include integrating the present invention with the Netscape Inc. distributed open source browser Mozilla for example. In one embodiment of the present invention a single moveable window tool bar is used as a browser companion application.

The FIG. 2b block diagram shows the different agent building modules that comprise the elements of the FIG. 2a 502 single block. The main icon tool bar 400 interface control module accesses each of the modules used.

The FIG. 2b Boolean search and metric set up module 416 is used to enter search terms, establish link text tests to be performed, metrics to be counted. Module 416 further provides a button to collect the current URL displayed by the standard internet browser. Module 416, when configured, contains the starting domain URL information, the chosen metrics to be identified and associated search terms to be used. If the search terms are open for end user decision, the agent may have a sample text entry in the search term lists or may be left empty. Further, using module 416 the user sets the particular search pruning approach to be engaged by the agent.

The FIG. 2b block 420 provides network operations set up options to provide a machine identity, operations preferences, search depth control, network time out preferences, which limit the search and control various core network operations.

The FIG. 2b block 424 provides agent action set up options for how the agent is to be started, what it will acquire and capture, and how it will finish its activities. Further, the agent actions set up module 424 provide means to schedule persistency of agent activity, and final report notification messaging information and device destination preferences. Further, the block 424 provides an option to have the agent launch to be triggered by what web pages the user is visiting using the standard internet or web browser. Further agent action 424 configuration can include other agents or applications triggering using the agent chaining shell commands module 440.

The FIG. 2b block 432 provides a variety of options for visualizing the agent activity using 3D dimensional display configuration. The 3D graphical display control module 432 is used to select the type of display desired, and orient the user perspective using different options. Display control 432 options include point of view positioning using zoom, rotation and network representation selections. The network is normally displayed using connectors to represent hyperlinks between web documents, and nodes to represent the documents themselves. Various preferences can be set as to the appearance the connectors and the nodes will have, The module 432 further provides means to display metric numerical data both as relative bar graph type display and as digit displays associated with different nodes and bar graph tops. Further, the display and visualization of the network can utilize flight simulation whereby the user can glide through the 3D network user mouse or touch pad control. Further, the user can use the control module 432 to cloak the network display from other unauthorized users.

The FIG. 2b additionally shows the agent HTML report format set up module 464 for configuring report information inclusion and sorted information preferences based on the collected database acquired from the network.

FIG. 2c illustrates the general method users employ to construct and configure agents. The user interacts with the interactive wizard of FIG, 2a box 500 to access aspects of the agent development environment. In FIG. 2c the user chooses 820 an agent application general type. The chosen agent causes the system to load 821 an agent template from a database. With the template opened, the user enters 822 agent operation specifications and instructions as a configuration process.

The system checks 827 to see if there are any matching pre-configured agent in a database available that may be alternatively used or used as agent specification guide. The agent specifications are compiled 823 to the standard agent execution project format. Then the user specifies 824 the agent application reporting and interface preferences. Blocks 823 and 824 can occur in interchangeable order. Then the user tests 825 the agent operations and engages debugging 828 if necessary. Once the agent is operating as desired, the agent is deployed 826 as an agent system application.

The present invention interacts with remote agent servers, where the latest updated or most popular agents available in the user community, or the paid placement agents can be automatically served to the client desktop or laptop computer for usage. Remote served agents are configured for auto-provisioning by user or server default preferences, which can include providing agents for potential usage to the user by Topic, particular Function, Popularity, by Vendor, or other preferences.

Users have the option to subscribe to certain types of agents to be provisioned to their client computer. Further, agents which are automatically provisioned to the user from the remote server can be either manually or automatically launched. If automatically launched, local preferences can be set to limit the auto-launched agent behaviors, such as depth of search permitted for example, or number of hits to be returned before finishing, for example.

Further, the remote server can monitor the users standard browsing activity, and when an agent match for that web page URL location or sub-page interaction is found, the remote server which securely monitors the user browser then will automatically suggest the agent to the user to enhance the browsing experience. The remote agent server provisioning can enhance browsing and network link proximal information search collection productivity for the user. Agent provisioning occurs based on what web pages the user has opened their browser on the web. This method provides the user, based on set preferences or default open provisioning settings, with the latest and most effective best auction agents, finance agents, update agents for news sites, forum agents, starting page lists, and integration with a group of web based meta-search tools.

This method permits user client machines to be automatically provisioned with agents which are most recent, most popular or most authoritative, for example. Alternatively to automatic download provisioning, and automatic activation of agent activity, the user may be served a banner in a pop up window or served a banner in the browser for manual user click and download. Agent provisioning can offer banners and may suggest agents packs that can be purchased or rented by the user.

In this context, the agent configuration detail are kept from the user, and user specific application of the agent is limited to Boolean terms and Metric terms to be entered by the user. Alternatively, the remote server provisioned agents may be open source agents which are fully editable, as available from agent user community agent exchanges, which may rank agents and focus topic conditions for provisioning based on popularity for example.

Further, a business entity serving banners for inclusion into user agent reports can be compensated for user click-through and subsequent business referral. If the user agent system is enabled for banner inclusion, or alternatively required to have banners included in user agent reports, the agent product seller or agent product provider can be compensated. This compensation can be realized as a click-through payment and/or by receiving transaction referral payments from the merchant vendor based on user purchases of goods and services.

The merchant vendor server and the agent system vendor are both notified of user click-through and subsequent associated purchase transactions. Pre-negotiated interest in transaction referral percentage or interest in flat fees per transaction are established between

(1) the agent system vendor,

(2) the third party banner vendor if any, and

(3) the merchant vendor.

Further, merchant vendors can pay the agent serving business to include a certain number of impressions of banners in user agent reports.

If an agent expects a particular web site configuration, for which the agent has been constructed, and instead an agent encounters a different or changed web site, the user may need to update the agent configuration to properly read or parse the site for intended purposes. If the user can registered with a server site that is used to post and provision latest up to date agents, the user can click one button labeled “Agent Check”. This causes the local user computer to send the server a message containing the particular agent configuration to check it against latest agents available for the target web site page. The server compares the user's current agent with the latest agent available for that network URL, and if a newer agent is available, will automatically download the updated agent to the users local computer.

If the server finds no update is available, and the user already has the latest update, the user will be sent a message back notifying the user that no update is currently available. The server will also notify the meta-agent or entity or persons maintaining the agent update service.

The notification will show that a request for an updated agent has been made for which no update is available. When the server administration parties receive a certain number of update requests, someone is notified to check the agent configuration for the site page in question to see if the site has changed in some way that requires the agent configuration to be changed to suit.

If the user on their own has created an updated agent that suits the changed site, the user can submit the updated agent to the server. The submitted updated agent, if it varies from the agent stored at the server used for provisioning users, will cause a notification of the server administration to occur to consider updating the agent being used to provision users.

The entity operating the server may offer incentives to users to submit updated agents or new agents, which incentives can include:

(1) cash, and/or

(2) discounts on new product or agent suite purchases, and/or

(3) free access to certain agents which otherwise have a purchase price, and/or

(4) purchase coupons, and/or

(5) credit vouchers, and/or

(6) published recognition and acknowledgement of the agent author, and/or

(7) royalties on future sales of the submitted agent which the server entity may sell to other users, and or

(8) submission can constitute an offer to sell the use of the agent or agent suite to the entity, which purchase price can be

(a) standardized and fixed according to agent type by the server business entity,

(b) determined and requested by the user and accepted or counter-offer price negotiated by the business entity, or

(c) determined by a pool of available funds which is dynamic based on how much has been contributed to the fund for the production of certain types of agents.

Further, submitted agents may be ranked according to download popularity. The most popular agent for a particular type of task can automatically become the default agent that the server provisions to future users an users obtaining agent updates. In this instance, the user may receive compensation incentives to produce the best agent or agent suites for a given type of task. Such compensation incentives can include one or more of the same compensation incentives (1) through (8) aforementioned.

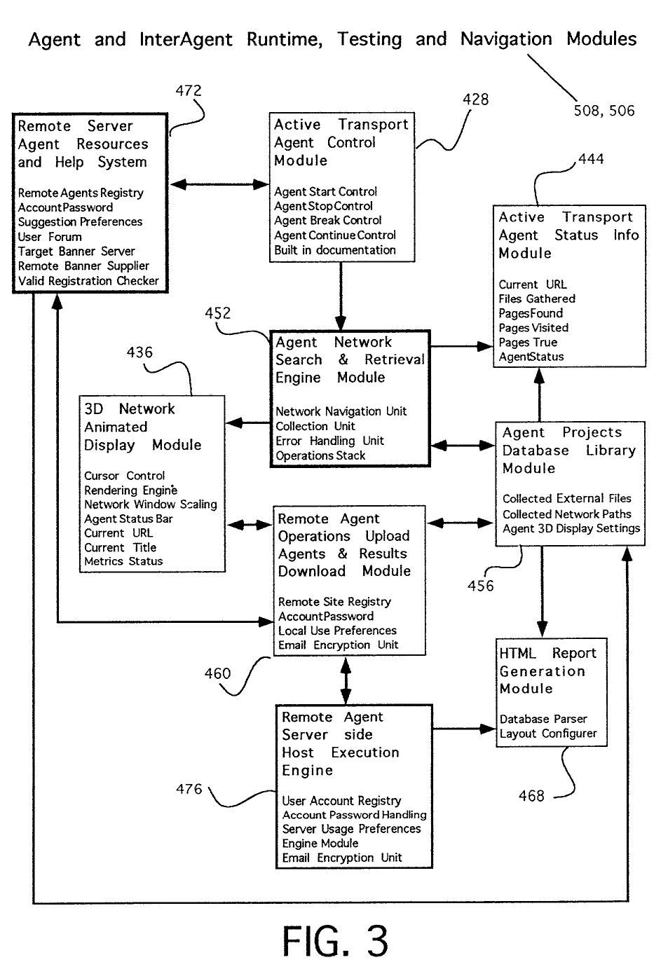

The FIG. 2a runtime testing modules 508 are further illustrated in FIG. 3 agent and inter-agent runtime, testing and navigation modules. Distinct from FIG. 2b modules and elements which are configuration and set-up oriented, FIG. 3 modules are dynamic operations control and execution components of the present invention.

The core module of the run-time agent activity is the agent network search and retrieval engine module 452, which includes a network navigation unit, and information collection unit, an error handling unit and the dynamic agent operations stack.

The engine module 452 is actuated manually using the active transport agent control module 428. Agent engine 452 run time execution activity can be assisted manually or automatically using the remote server agent resources and help system 472 which resides remotely on the network from the user.

If the user uses a particular web site, the help system can watch the local user activity and suggest or automatically download or remotely execute agents on behalf of the user. The user can thereby have agent activity executed locally or remotely on their behalf without manually causing the activity in that web browser activity time period.

The user may select preferences to be alerted about the existence of an agent to assist their current internet browsing activity. The user may select preferences have a remote agent host execution engine 522 execute agent activity on their behalf and provide the results to the user.

Further, the user may prefer to only have agents downloaded to the hard drive and execute locally, not remotely. Further, the user may choose to allow the remote host to cause a chat dialog window to appear on their internet browsing device and query the user as to particular agent execution activity it may pursue on behalf of the user.

When an agent is to be downloaded automatically for local engine 452 execution, or uploaded automatically for remote host engine 476 execution, the remote operations agent upload or agent and results is engaged. The module 460 is used to control and store the remote site registry if their is a plurality of execution sites, or agent download resource sites. Further, the module 460 can be password protected, use encryption methods to secure privacy and anonymity on behalf of the user, and also store local use preferences of the user.

The FIG. 3 module for 3D network animated display 436 gets network information from the engine module 452 and the agent project database library module 456. The dynamic network visualization display module 436 can display real-time agent execution activity 452, and previous executed and stored agent activity logs 456.

The FIG. 3 engine module 452 provides collected status information to the active transport agent status module 444, including current URL bring visited by the engine, number of files gathered, types of files gathered, total web pages found and visited. Further the status module 444 displays the total number count of pages that have been found to be true as matching the Boolean search terms used. Further, the status module displays the current global status of the agent, whether it is running, paused, or stopped.

The FIG. 3 HTML report generation module 468 receives dynamic information input from the files collected by the engine 452 or engine 476, and parses the database of collected results according to desired ranking and layout preferences set up previously the user.

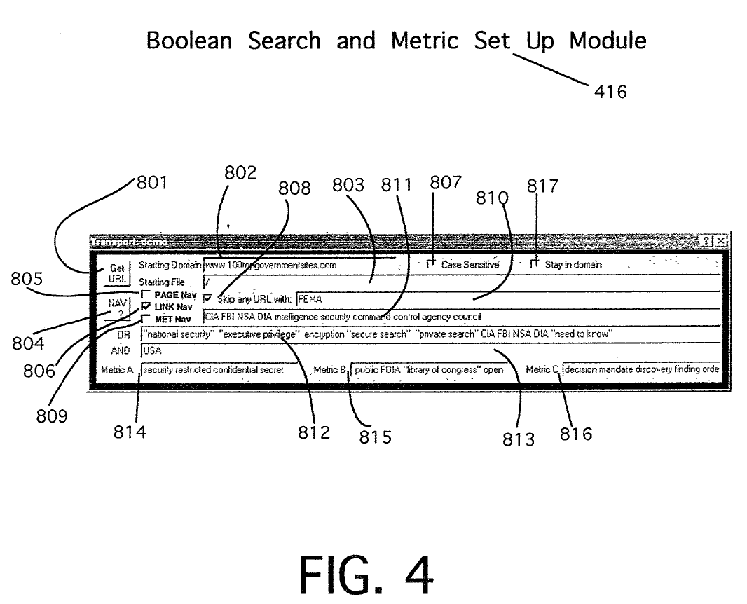

FIG. 4, represented in FIG. 1a as 416, illustrates the search set up portion of the TRANSPORT WINDOW in the first preferred embodiment which is a display control panel window for inputting search terms, link test terms, metric terms, and search mode set up.

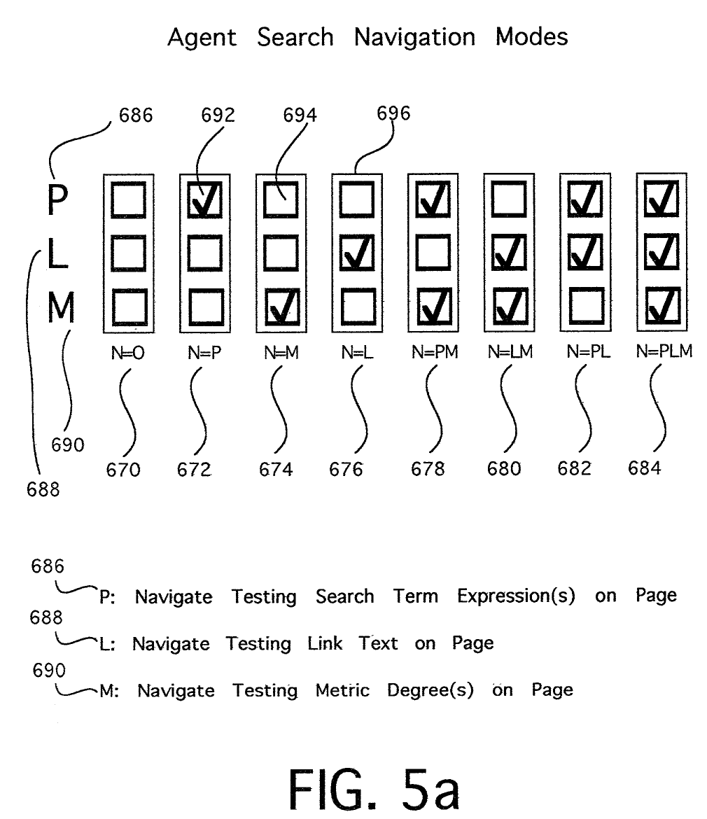

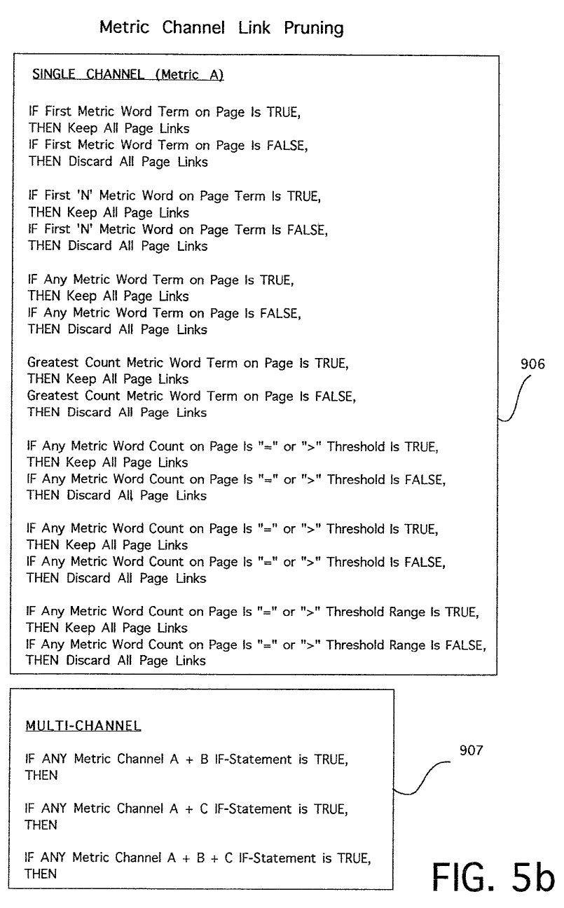

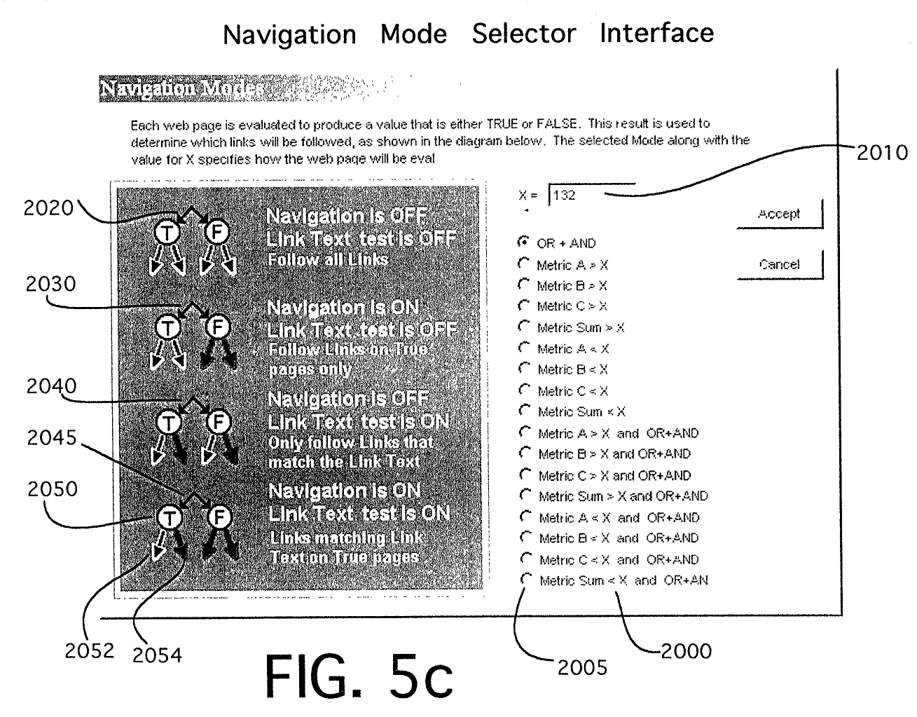

The “Get URL” button 801 gets an URL from Internet Explorer and puts it in the Starting Domain 802 & File-path 803 entry lines. The Starting Domain 802 contains a portion of the starting URL—www.example.com, and does not require entering the text “www.”. and the Starting File 803 contains the path and file of the starting URL—“/index.htrl”. The button “Nav?” 804 when clicked shows the FIG. 5a Navigation Chart illustrating the different search modes, with attached short explanations for each.

In FIG. 4, the check box 805 for “PAGE Nav” when checked to the ‘on’ position, only accepts links from TRUE pages evaluated against terms on the Boolean “OR” line 812 plus “AND” line 813, for further evaluation. The check box 806 for “LINK Nav” when checked to the ‘on’ position, only accepts individual URL links that have matching text in the URL or associated text line 812. The check box 809 for “METRIC Nav” when checked to the ‘on’ position, only keeps links that match metric degree testing from “Metric A” line 814.

The check box 807 for “Case Sensitive”, when selected, makes the search case sensitive. The check box 808, “Skip any URL with”, when selected, enables URL rejection—for filtering out a list of domains or partial domains entered into the line 810. The check box 817 “Stay in Domain” confines the search to the domain of the starting URL. The text entry line 810 identifies text to match for URL rejection, as separate multiple words with spaces between them.

The text entry line 811 contains possible text for link test, which are entered as separate multiple words with spaces between them. The line 811 may use quotes for phrases to be evaluated as unified strings of text and spaces. The line 811 text entry may contain words preceded with an “!” character, to designate to reject links from evaluation. In line 811 words are evaluated left to right on a first match basis.

The text line 812 is where “OR” test words are entered or automatically placed. Following a Boolean expression evaluation convention, the system must find ANY of these words in order to return a True. In line 812 the multiple words to test for are separated with spaces. In line 812 use quotes for phrases, and precede NOT words with the “I ” character. To search inside of HTML tags as well, precede line 812 words with an “@” character.

The text line 813 is where “AND” test words are entered or automatically placed. The search subsystem must find ALL of these words to return a True. Line 813 terms are separate multiple words with spaces between them. Line 813 terms can use quotes for phrases, and precede NOT words with an “!” character, such as “!chemical” for example; and to search inside of HTML tags as well, words are preceded with an “@” character, such as “@author” for example. If a word is NOT and the @ character is used, both forms: @!sample or !@sample are valid.

In text line 814 “Metric A”, is where terms to be counted as metrics are entered. This is text to match for Metric A text count which counts the total number of occurrences of the test words entered. Separate multiple words or quoted phrases with spaces may be entered to be included in the whole count for the Metric A evaluation. In Metric line 814, line 815 or line 816, text to match for NUMERIC MODE is identified and used to extract a numeric value from a web page.

To use the NUMERIC MODE, the metric text MUST be preceded with a code that describes the extraction method. This code is:

(1) an # followed by five digits:

(2) # signifies the Numeric mode,

(3) the first X sets number of text matches (0-9),

(4) the second X number of ‘number’ matches (0-9),

(5) the third X sets case sensitivity (0=off 1=on),

(6) the fourth X sets ‘skip tags’ (0=on 1=off), and

(7) the fifth X scales the result (0=100 1=1 2=1/10).

For example, “#35001gold” finds the 5th number past the 3rd occurrence of the word ‘gold’. This embodiment permits the user to merely look at an HTML page document to identify the numeric elements desired to be tracked, without looking at the HTML source code. The user can visually counting the occurrences of the word “gold” on the page from top to bottom and left to right, for example, will arrive at the identification of the third occurrence of the word “gold”. The numeric forms supported in the preferred embodiment include base 10 numbers, either negative or positive signed up to five digits, with decimal points.

More than one metric test of a number on a HTML document can be contained within a single metric testing channel. For example, the user may wish to test to identify the number for the asking price for gold on several different pages representing different world markets for buying and selling gold as a precious metal commodity. This testing for the price of gold on more than one HTML document within a single metric count channel can be accommodated if there is sufficiently unique numeric metric test codes that each apply exclusively to one HTML document where the price of gold is mentioned.

If additional unique identifiers are needed to separately distinguish the word term “gold” for example in more than one HTML document. Yet within the same metric channel, numeric identification tests can be more uniquely identified to avoid any confusion for the search mechanism mis-identifying a gold metric as valid from an unintended area of a target HTML document page being tested.

If words in any metric channel are preceded with an @ then search will also examine content within HTML tags, which would require to use the standard browser to view the HTML source. The HTML source can often provide additional unique identifiers that may be used to know a developed numeric test code will exclusively pertain only to the target HTML document page, amongst a group of other HTML document pages. In this manner, the numeric metric test component of the invention can provide numeric metric capture from a plurality of HTML document pages using a single metric test channel.

The objective is to be able to readily test for multiple instances of the price of gold on multiple HTML document pages at different web sites, and thereby produce a visual display of more than one price for gold as attached to each site. Each site is then represented as a separate node in the 3-D visualization display of the system, with numbers connected to each node in the display. If using 3-D bar graph formatting within the 3-D display subsystem, would additionally show different heights for each different price of gold, for example.

Enter “*TEXT” to key text extraction to metric words for any metric channel, A, B or C. This enables the user to identify what segment of text will be extracted for retrieval from an HTML document page containing more than that instance of text. The entry of “*Cheney” for example will signal the extraction of the whole sentence text in the HTML which contains the word “Cheney” for the user.

For any Metric channel text line entry 814, 815, or 816, A, B or C respectfully, the user may enter the text: “REVISIT” or “REVISIT WATCHDOG” to obtain comparisons to the previous search. Using the text REVISIT retains and repeats the last search. WATCHDOG sets the Metric to #255 if the node web HTML document page content has changed since the last visit, otherwise it is set to zero.

This is implemented as a check sum test to identify if the HTML document page component has changed. The use of the REVISIT WATCHDOG command in a METRIC channel, causes the search subsystem, if set to execute more than one search of the same network of HTML documents, to repeat the last search. It accomplishes this without erasing the 3-D visualization generated from the prior run on commencement of the successive run.

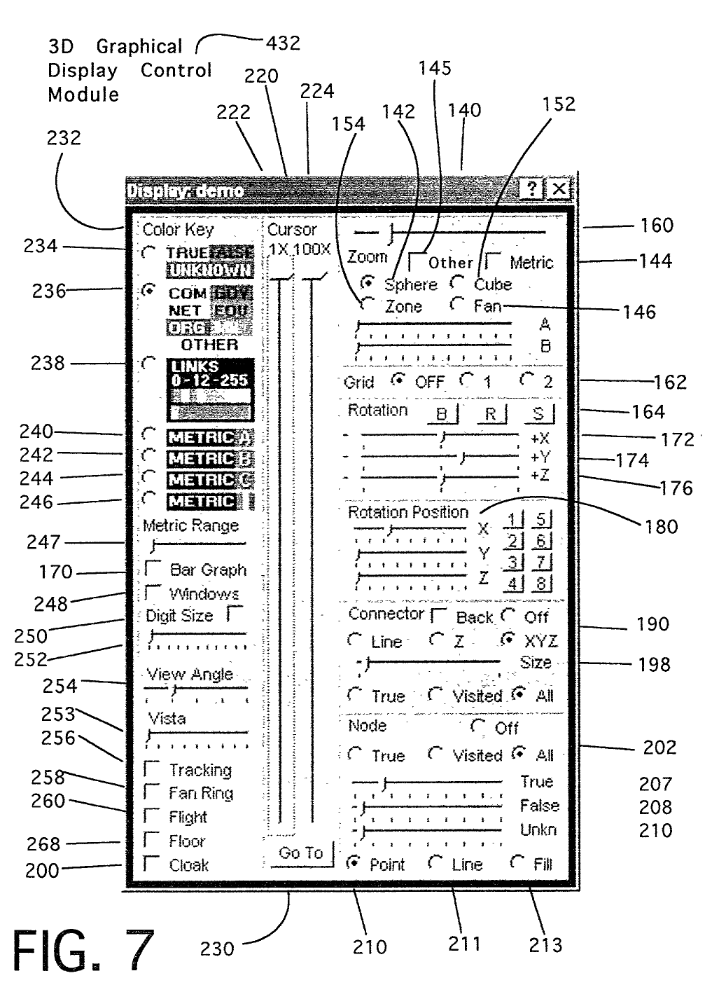

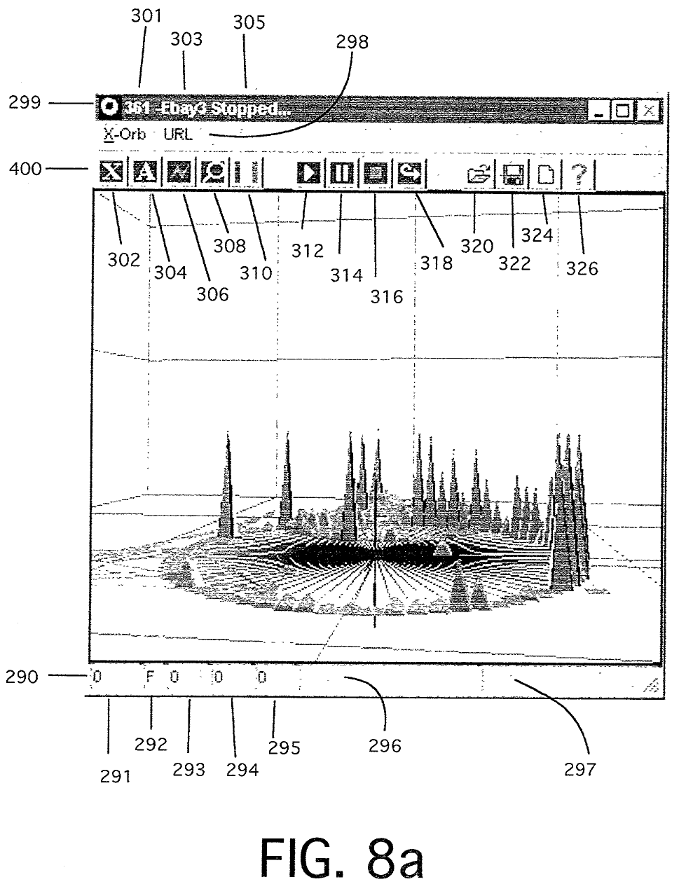

This allows the user to readily see in the 3-D visualization if any HTML documents have changed since the last run, in the FIG. 7 bar graph 170 display mode for example for with the node numeric display for example. When this is executed, the user may choose to generate an HTML document report of the entire search to be sorted to rank those pages that have changed with respect to the metrics contained in the channel, so that changed pages are ranked higher in the report than unchanged pages.

Unchanged pages in the 3-D visualization if bar graph mode is used will display as flat without any height whereas changed pages with respect to the target metric words or numeric value tests will display as higher elevation bars.

When the REVISIT command is entered, the search and display retraces the exact original search steps and HTML pages, without erasing the node and links displayed from the prior run, but if nothing has changed then the nodes are color coded Blue, so that changed nodes visually become readily apparent as a non-Blue color.

If the network of documents links within any document have changed, the 3-D network display, the network appearance will begin to alter to show additional nodes. Normally in the system, when these special change detection metric commands are not active, each time the search subsystem repeats the same search, the 3-D display is erased and the network display regenerated based on the current network search run.

The preferred embodiment can have any number of Metric channels, exceeding the examples above of only three Metric A, B or C channels referred to in the FIG. 5a illustration, which number of channels can be selected by the user according to application requirement.

In the acquisition of data about individual HTML document pages in a network of documents, each document is called a node and has a number of database cells associated with it, with these cells containing different aspects of information about the node, including but not limited to links, title, URL, metrics, and different gathered data sets from that node.

The system has been implemented to streamline the sorting process of the different classes of cells associated with nodes in order to nearly instantly execute sorts for the purpose of visualization, report ranking and other prospective interrelationship comparisons.

In order to devise a method to effectively reduce the search space associated with following links found on an HTML document or page under search examination and search processing, the search subsystem implements a selection of methods to limit which links to follow or not. This introduces a three means whereby the text and numeric counts of elements or values of numbers found on a hypertext page are evaluated in different ways in order to prune the further search of hyperlinks found on a hypertext page:

(1) The FIG. 5a test 686 is related to examining all the text in a hypertext page, and evaluating the Truth state returned for that test as search terms evaluated in the Boolean ‘AND’ and ‘OR’ lines 812 and 813 respectively of the FIG. 4. This is called the page navigation test, or “PAGE NAVIGATION” in the system. In the FIG. 5a diagram this is labeled “P: Navigate Testing Search Term Expression(s) on Page”, or “P”.

(2) The FIG. 5a test 688 is related to examining only the link text in a hypertext page that is the text label and the URL (Uniform Resource Locator) text of links on the page. It compares any link text against any pre-designated link text test words or text string terms entered in the Link Text line 811 of FIG. 4. If any links are found True, it keeps those links for further investigation. This is called the link text navigation test, or “LINK NAVIGATION” in the system. In the FIG. 5a diagram this is labeled “L: Navigate Testing Link Text on Page” or “L”.

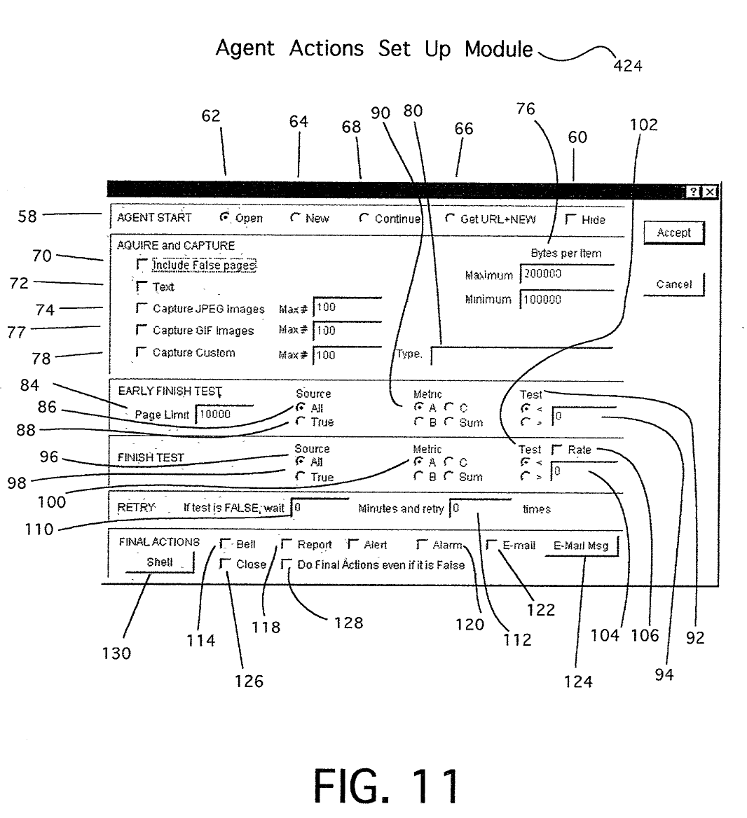

(3) The FIG. 5a test 690 is related to examining only the word counts or word string counts or numeric values present in a hypertext page. It evaluates these terms and degrees against the terms and formulae entered in a metric channel line 814 of FIG. 4. If applicable, it evaluates also against those preferences entered into the agent action FIG. 11 lines 94 and 104, and radio button selections 90, 92, 100, 102, and 106, which establish threshold or rate of change metric control based finish actions. This is called Metric degree navigation test, or “METRIC NAVIGATION” in the system. In the FIG. 5a diagram this is labeled “M: Navigate Testing Metric Degree(s) on Page” or “M”.

Each Navigation mode provides a different qualitative type of pruning of the page hyperlink investigation process, thereby providing different capability of the search to follow all links associated with a page or only to follow selective links associated with a page.

The PAGE-TEXT NAVIGATION test, the LINK-TEXT NAVIGATION test, and the METRIC-DEGREE NAVIGATION test are all separate tests. These tests can be not performed, as in FIG. 5a empty check box set 670 entitle “N=0” Alternatively, any combination of these tests can apply to a page or series of pages an agent is examining.

FIG. 4 checkbox 805 corresponds to FIG. 5a element 686 “P”.

FIG. 4 checkbox 806 corresponds to FIG. 5a element 688 “L”.

FIG. 4 checkbox 809 corresponds to FIG. 5a element 690 “M”.

The PAGE NAVIGATION test pertains to terms entered in the AND plus OR entry lines 812 and 813 respectively of FIG. 4. The LINK-NAVIGATION test pertains only to terms entered in the link text term entry line 810 of FIG. 4. The METRIC NAVIGATION test pertains only to terms and formulae entered in the “Metric A” channel entry line 814 of FIG. 4.

These different search navigation modes provide different pruning mechanisms to limit the search space or search paths to be pursued and evaluated.

Selecting different search navigation modes impacts the time required to automatically engage the live search by limiting the number of links to pursue, and impacts the quality of the links to pursue according to user preferences associated with terms entered and associated with each of the available tests,

Agent configuration control provides a three checkbox set, such as FIG. 5a checkbox set 696. Each set contains separate checkboxes, such as 694. The navigation mode associated with the checkbox is active when checked 692, or inactive when not checked 694.

If FIG. 5a Navigation Mode 686 is active, the agent evaluates the agent configured search terms against all the text on a hypertext page, and if any True Boolean conclusions are found, all links for the page are kept.

If FIG. 5a Navigation Mode 688 is active, the agent checks all the title and URL information associated with any link on the page, and if any terms match those in the link text line, those links are kept, and all other links are discarded,

If FIG. 5a Navigation Mode 690 is active, the agent checks all the page terms, number values, word counts, and or file counts on the page, and if any match those in the metric channel “A” line, all links for the page are kept.

The act of ‘keeping’ links on a page is the act of retaining those links for further investigation by the agent, otherwise links are discarded and not pursued.

There are eight different possible combinations of the three NAVIGATION Modes. Each mode is activated by the user selecting a checkbox toggle for the desired mode. The eight network search navigation pruning modes are most simply described as follows:

FIG. 5a, three checkbox set 670, “N=O” with no modes selected:

Keep all links on the hypertext page without any testing.

FIG. 5a, three checkbox set 672, “N=P” with only PAGE NAVIGATION mode selected:

Keep all links on the hypertext page if any search term test is TRUE.

FIG. 5a, three checkbox set 674, “N=M” with only METRIC NAVIGATION mode selected:

Keep all links on the hypertext page if any metric degree test is TRUE.

FIG. 5a, three checkbox set 676, “N=L” with LINK NAVIGATION mode selected:

Keep only those links on the hypertext page for which link text test is TRUE.

FIG. 5a, three checkbox set 678, “N=PM” with both PAGE and METRIC NAVIGATION modes selected:

Keep all links on the hypertext page if any search term test is TRUE, but only do so if any metric degree test is TRUE.

FIG. 5a, three checkbox set 680, “N=LM” with both LINK and METRIC NAVIGATION modes selected:

Keep only those links on the hypertext page for which link text test is TRUE, but only do so if any metric degree test is TRUE.

FIG. 5a, three checkbox set 682, “N=PL” with both PAGE and LINK NAVIGATION modes selected:

Keep only those links on the hypertext page for which link text test is TRUE, but only do so if any search term test is TRUE.

FIG. 5a, three checkbox set 684, “N=PLM” with PAGE and LINK and METRIC NAVIGATION modes selected:

Keep only those links on the hypertext page for which the link text test is TRUE, but only if any search term test is TRUE, and only if any metric degree test is TRUE.

FIG. 5b illustrates conditional use of metric navigation which uses metric channel elements to expand or prune agent search. A single agent can contain one or more metric channels, with the preferred embodiment containing at least three metric channels. A single metric channel can contain terms, formulae, and related rules which when applied in search navigation, can be used to determine whether the agent search keeps or discards links found on any web page for further search. When metric navigation is active, page navigation is inactive.

The filter to keep or discard links using metric navigation depends on the particular terms or formulae in the channel chosen to be active for search navigation.

In FIG. 5b, a plurality of different metric channel rules 906 can be used to broaden or prune the network search space. When metric navigation is selected, any of the metric navigation rules of FIG. 5b can be applicable to the search navigation. In one embodiment of the invention, multiple metric channels are used, and FIG. 5b 907 illustrates three examples of multi-channel dependent propositions.

The METRIC NAVIGATION mode in the preferred embodiment operates to conditionally keep all links, or alternatively discard all links, depending on the outcome of the metric search control rule employed.

The METRIC NAVIGATION mode of the preferred embodiment of the invention, works in an ‘all’ or ‘nothing’ manner. It executes page links ‘keeping’ or ‘discarding’ operation respectively. The METRIC NAVIGATION mode is modified in another embodiment of the invention to only keep certain page links, determined by means of calculating visual proximity, or proximity in the hypertext page source code, relative to the TRUE finding element relating to the metric degree testing.

Therefore, links spatially or linearly more proximal to METRIC NAVIGATION as TRUE findings are kept and not all links. This proximity binding can be preferentially set to examine different ranges of visual spatial or linear code implemented association positions of links as general rules to limit the number of links kept when METRIC NAVIGATION as TRUE findings occur on a hypertext page.

The metric channel search mode contains a plurality of sub-modes, or search rules, based on how the metric channel terms and or numeric formulae have been set up.

FIG. 6a, represented in FIG. 1a as 428, illustrates a display panel that indicating the current status of the search activity of the present invention and the URL and text of the dimensional visualization pointer. In one embodiment this is the Upper Transport window area.

In FIG. 6a the button 39 “New” starts a new search—erases any previous search results. The button 37 “Continue” continues a search that was Stopped. This allows the user to continue a search after loading it from disk where it was previously saved and stored after being suspended.

The button 35 “Stop” finishes processing the current web page and then stops. The button 33 “Break” interrupts and stops the search in progress. The button 31 “Forward” causes the search subsystem to skip over the current web page, however, the search must be first stopped for this command to function.

In FIG. 6a the display text line 30 shows the web page that is selected with the 3D display pointer using various tracking and spatial browsing actions configured using the controls illustrated in FIG. 7. In FIG. 6a, the display text line 30 shows title of the web page that is selected with the 3D display pointer. The display text line 31 shows the URL address associated with the web page text title 30.

In FIG. 6a the display sub-window 32 titled “Pointer” shows the assigned number of the web page that is selected with the 3D display pointer. The display sub-window 32 titled “Pointer” shows the logic state of the web page that is selected with the 3D display pointer. Text line 34 titled “Current” shows the web page that is currently being processed in the search process.

In FIG. 6a the text display line 36 titled “Status” shows the current status of the search. The text display line 38 titled “Errors” shows errors and associated messages. The sub-window 40 titled “True” indicates the total number of Pages found that tested TRUE. The sub-window 42 titled “Files” indicates the total number of Images and or Custom type files saved, such as “.PDF” or “.MP3” files, for example.

In FIG. 6a the sub-window 44 titled “Total” indicates the Total number of Links found. The sub-window 46 titled “Done” indicates the number of web pages that have been processed (visited and evaluated). The display 48 numeric display next to the line 38 indicates the number of accumulated errors. The color coded small square icon 50 indicates the status of the search process at a glance, where the box colored red indicates the search is stopped, the box colored yellow indicates the search is in transition to be stopped, and the box colored green indicates the search is engaged and continuing.

In FIG. 6a the question mark character “?” 52 when clicked, changes the user cursor to a question mark which when clicked on any portion of the window will activate a pop-up window that provides explanatory details for the portion or function within the control display. The sub-window 54 character “X” when clicked closes the search control display window.

In FIG. 6b, represented in FIG. 1a as 429, is illustrated a display log of a linear chronology of web site document pages visited by an agent. The left most log display data 55 shows the number assigned to the site by the agent as was sequentially visited, the middle portion 56 of the text shows the numeric domain address, and the right portion 57 shows the URL address.

FIG. 7, represented in FIG. 1a as box 432, illustrates the DISPLAY CONTROL WINDOW. The upper right section 140 of the window is the display type and display zoom control sub-window. The radio buttons activate different types of display, including SPHERE, CUBE, ZONE, and FAN, and using the same four radio buttons, different metric associated display types. Each of these display types at the selection of one of four radio buttons instantly reconfigures the mapped display of network nodes of HTML document pages into a different format. In the preferred embodiment, there are additional display types beyond the illustrated SPHERE, FAN, CUBE and ZONE display types and beyond the Metric display type. The same radio buttons for the four display modes double duty for other additional display types, when the Metric check box 144 in the same sub-window also checked.

Clicking on the Metric check box selects the alternate set of display types which use metric values for positioning. When an additional not illustrated check box is checked the same four radio buttons provide additional display modes title and show new display modes for viewing and selection, including TOPIC, HYPER, GEO, and FIELD.

In FIG. 7, the SPHERE display mode 142 maps the visited web HTML document nodes into a three dimensional radial network, with the central node of the network generated being the starting HTML document page of the agent network search run. The first set of links associated with the starting URL HTML page are plotted into 3-D space and distributed radially into three-dimensions relative to the start page node.

Each link is cast as a line or flanged spoke outward from the starting node, and depending on the number of nodes to be cast, are equally distributed into the surrounding radial space, with each link reaching a node representing the URL link that the starting page links pointed to. Links found within these nodes which are one link removed from the starting node are plotted, are in turn also radially plotted outward to nodes from their 3-D spatial positions.

For both the Sphere display type and the Fan display type, the relative length of the connecting link spokes to the next layer removed can be preferentially set. This is done by using a global display control, to be less than, equal than or greater than the prior set of link spokes plotted from the initial starting node.

Depending on the type of network being plotted, the ability to adjust the relative spoke length associated with successively searched links to nodes to links further removed from the initial starting node, can reveal clusters of links more accurately and easy to visually discriminate. These lengths preferences are available to set along a continuum of relative spoke lengths, using the slider controls A 148 and B 150 directly below the display type selection.

Control slider A 148 sets the relative length of the spokes, and slider B 150 sets the relative ratio of length between successively searched and plotted fan or sphere type link sets. Adjusting control A slider increases or decreases the absolute length of the spokes, and control B slider increases or decreases the relative ratio between successive layers of sets of link in the SPHERE or FAN display type modes.

In FIG. 7, the SPHERE type 142 radio button, when selected activates the Sphere display mode type, or, if the check box in the same sub-window titled “Metric” 144 is checked, then the Sphere type button selection is alternatively used. It is used as a double duty control to plot the identified web page nodes into an arrangement where counts for web page nodes relative to Metric A are plotted in the X axis, Metric B in the Y axis and Metric C in the Z axis.

In FIG. 7, the FAN type 146 radio button, the Fan display mode maps the visited web HTML document nodes into a three dimensional conical spoke fan network, with the central node of the network generated being the starting HTML document page of the agent network search run. The first set of links associated with the starting URL HTML page are plotted into 3-D space and distributed conically as a fan into three-dimensions directed along one axis relative to the start page node.

Each link is cast as a line or flanged spoke outward from the starting node. Depending on the number of nodes to be cast, are equally distributed into a conical ring into the directional axis conical space, with each link reaching a node representing the URL link that the starting page links pointed to. Links found within these nodes which are one link removed from the starting node are plotted, are in turn also conically plotted outward as a fan to additional nodes from their 3-D spatial positions.

In FIG. 7, the FAN type 146 radio button, when selected activates the Fan display mode type, or, if the check box in the same sub-window titled “Metric” 144 is checked, then the Fan type button selection is alternatively used. It is used as a double duty control to plot the identified web page nodes into an arrangement where counts for web page nodes relative to Metric A are plotted in the X axis, Metric B in the Y axis and the fan plotting display type mode into the Z axis.

In FIG. 7, the CUBE type 152 radio button, the Cube display mode maps the visited web HTML document nodes into a three dimensional network, where the placement of any nodes in the network is not based on order of starting position. Instead it is based according to a convention that arbitrarily places nodes into XYZ space based on the text of the title, the text of the URL, and the text of the file path of the URL being plotted.

The domain name and title carry the most XYZ placement strength. The file path within the domain to different pages under the domain carries a much smaller XUZ relative placement strength, This operates such that pages within a domain are clustered near to each other and other domain names are positioned farther away, based on the differentiation found in the domain name and title compared to another domain name and title.

Domain names with similar title text and URL domain name text are positioned more closely to one another than less differentiated domain names and titles, but often not as closely clustered as would be placed web pages that are all located and subordinate in a singular domain. The Cube display mode selects the XYZ coordinates for placing a given page entirely arbitrarily except for the considerations and constraints herein identified.

In FIG. 7, the CUBE type 152 radio button, when selected activates the Cube display mode type, or, if the check box in the same sub-window titled “Metric” 144 is checked, then the Cube type button selection is alternatively used as a double duty control. It is used to plot the identified web page nodes into an arrangement where counts for web page nodes relative to Metric A are plotted in the X axis, Metric B in the Y axis and plotting of the sequence of searched nodes into the Z axis.

In FIG. 7, the ZONE type 154 radio button, is identical to the CUBE display mode except the X axis is excepted from the placement algorithm and instead separated into seven laminar spatial zones representing seven domain types. These include .COM, .GOV, .EDU, .NET, ORG, .EDU, .MIL and OTHER domains. The number and placement layering of the zones in the X axis space may be changed, based on the preferred adjacency layering of domain types and based on the addition of more domain type suffixes as may be adopted for popular use on the internet and the web.

In FIG. 7, the ZONE type 154 radio button, when selected activates the Zone display mode type. Alternatively, if the check box in the same sub-window titled “Metric” 144 is checked, then the Zone type button selection is alternatively used as a double duty control to plot the identified web page nodes into an arrangement where counts for web page nodes relative to Metric A are plotted in the X axis, Metric B in the Y axis and plotting of the sequence of searched nodes into the Z axis.

When the checkbox “Other” 145 is checked, the four radio buttons in the same sub-window display titles of four additional display type modes, TOPIC, HYPER GEO, and FIELD.

The TOPIC display mode places web page nodes in the network into subject areas that are defined by the predominate Metric test for the agent where there is a number of Topic spatial areas allocated in A 2-D or 3-D space equal to the number of Metric channels being utilized. For example, three metric channels would plot three areas of topics, and the areas would be demarcated by a grid outline

An alternative mode of Topic includes a fixed number of topical subjects into which all web pages are mapped. The placement of a web page node into a given topical 3-D zone versus another depends on the general metric count of word terms on the page as sorted against a reference thesaurus that indexes words found on any visited web page to topics.

Topical sets can be limited to a particular domain, such as having a set of sub-topic boundaries within the single subject of Entertainment. For example this could include the subtopics of Celebrities, Radio, Music, Movies, Video, and Television. or this could include 3-D spatial topic set can be all encompassing, where all possible web topics are fitted into a finite set of topic categories, such as Computing, Health & Medicine, Sports, Business & Money, Entertainment, News & Media, People, Shopping, International, Travel, Government, Music, Gaming, and Reference, for example.

FIG. 18c illustrates an example topical layout with 2-D areas, such as 1100, 1115, and 1150 representing specific topical domains. Web document page nodes such as node 1120 represent a web URL address that has been discovered by an agent. Web page node 1120 in topic area 1130 has a link to another page that is located within another topic area 1124.

The user may specific a central or most general topic area 1150 to be in a particular area of the display. Topical areas may be separated by grid lines 1140 to define their boundaries. Adjacent topic areas 1100 and 1115 may be located so as to have more similarity than a non-adjacent topical area 1130 for example.

Links between topics such as connector 1110 may be highlighted. Clicking on a connecting link 1110 can generate a highlight of the web site URL or title, for example. Clicking on a node will display only that node's URL or title for example.

Alternatively, clicking on a node can display a user annotation or renamed label for the node. The spatial layout and size and shape of topical areas can have a plurality of possible forms and styles, depending on the available range of forms and styles available or generated by the user.

The HYPER display mode places web page nodes in the network into successive radial spokes that map onto a flat circular or 3-D semi-sphere, with the default center point on the semi-sphere surface representing the starting node of the network search process engaged by the agent. As each successive set of links originating from any node are identified, they are in turn plotted into the flat or semi-spherical surface in a radial pattern outward across the surface of the flat radial circle or semi-sphere.

As the network of nodes and links to additional sets of nodes develops the later searched and outer layered sets of nodes reach toward the edge of the semi-sphere.

In the HYPER display mode, a global control extends the node network to be occluded out of view behind as if behind or on the horizon of flat circle or semi-sphere, and therefore hidden, and the center of the semi-sphere is always the least populated node space in the network.

As the user moves their visual focus to different portions of the semi-sphere or hyperbolic sphere surface, away from the default starting node center point, then the position of the nodes on the new center of the sphere are dynamically animated to spread out, and into the new focal center of node display lens. The peripheral nodes on the hyperbolic semi-sphere are dynamically animated to shrink in size and increase or omit density, and thereby become less visible and even invisible relative to the focal point of the information lens.

This is similar to the appearance of a roving fish eye lens applied to a uniform network pattern layout. The point of focus is always larger, more spread out for visual discrimination, and the peripheral network nodes on the sphere are receded in size and collapsed into denser connected networks.

FIG. 18d illustrates an example hyperbolic display format in 2D. The same display may be configured to be 3D where the center largest node 1000 of the display is closer to the user point of view in ‘Z’ space. Further, the 3D display version of

FIG. 18d periphery 1060 of the hyperbolic sphere is furthest from the user point of view. The center node 1000 of the hyperbolic sphere can represent:

(1) the agent search starting point, or alternatively

(2) represent the central document node of most generality for a subject area where more peripheral nodes on more peripheral rings are more topically removed from nthe focal node 1000, or alternatively represent

(3) the current document node of interest to the user. The hyperbolic display has concentric embedded rings such as 1030 where document nodes such as 1020 are positioned along with other document nodes the same multi-link distance from the central focal node 1000.

Document nodes 1050 and 1020 are located on the same ring and thereby are the same number of links distant from the focal link 1000. The most peripheral nodes such as node 1080 are the current visible limit of the network node display in the hyperbolic display, although connecting links to further nodes not yet selectable may be displayed. Connecting links between nodes such as connector 1052 highlight connection between nodes linked from the focal node 1000. Connecting links between nodes such as connector 1040, highlight connection between document nodes which have separate links to other document nodes.

In FIG. 18d, depending on user navigation preference setting selected, clicking on a document node such as 1070, will cause the node to:

(1) display its URL and title, and/or

(2) launch the browser to go to that web page, and/or

(3) smoothly animate motion of the selected node 1070 into the center focal point where until that moment document node 1000 resided.

Node 1000 will move to a peripheral ring. Hyperbolic network animation will move all network nodes in the same general radial curvilinear axes of direction which the initiating node movement, by cursor clicking selection causes. For example, clicking on node 1070 moves it left-ward to the focal position currently occupied by node 1000, and node 1000 thereby moves out of the focal position in the same general left-ward axis of movement onto the opposite side of the same ring where node 1070 previously resided.

In FIG. 18d, depending on user navigation preference setting selected, clicking on a concentric ring grid line such as 1030 for example will cause:

(1) all document nodes located on the ring 1030 to have their URL and title displayed either overlaid on the graphic display or in a pop up text list window, or

(2) sort just the nodes located around and on that ring according to pre-established report ranking preferences, and generate an HTML report in the standard web browser of only those document nodes for perusal for example.

The GEO display primary mode places web page nodes in the network onto a spherical or flat projection of the Earth, which is accurate to the geographical positioning reference that can be discerned relative to the web page node. Alternatively as a sub-mode partially accurate with distortions introduced to emphasize the spreading of denser network spaces into more absolute spatial domains which are more sparse, thereby partially distributing the network node population into exaggerated sizing and view relative to the overall geographic representation. For example, the higher density of web pages associated with higher population metropolitan areas can be skewed into larger space such that the city of New York would be sub-window overlaid into an area larger than the state of New York. In the accurate GEO display primary mode, the geographical placement of web page nodes remains accurate to the identified designated location found or interpreted for the web page node

Different methods of discerning a geographical association for any given web page can be based on:

(1) word terms in the page identifying with a given location by name, place or by language, or

(2) associated page “contact and office address”, or

(3) based on the WHOIS look up of where the web domain name is registered to a physical address, or

(4) this can be based on the interpreted general topic of the web page being associated with a general location assumption that can be made based on a thesaurus of word to location references, or

(5) based on ZIP code or phone area code found on the page or other pages subordinate within the same domain name.

The system stores URL addresses or data sets locally, for the remote or local look up of data sets that provide:

(1) Latitude and Longitude of for example 5000 largest cities in the world or five thousand largest cities in the United States, center coordinates of any country in the world,

(2) Latitude and Longitude for any United States and international postal zip codes, and the headquarter addresses for the five thousand top global corporations, and addresses for the top thousand non-governmental organizations, for example.

FIG. 18a illustrates a 3-D globe dynamic animated presentation of current earthquakes around the world. The upper portion of the figure shows one quake presentation setting configuration with oceans transparent and the relative angle of the quakes shown relative to the center of the Earth. The lower portion of the figure shows another presentation format with no globe transparency.

FIG. 18b shows the control panel for customizing the presentation attributes of earthquakes around the globe, including controls for quake representation symbols and data, globe transparency, and globe surface representation types. When an earthquake occurs somewhere on the Earth within the preferred settings for tracking, the computer or other device can provide an audible beep.

Using slider controls the globe can be zoomed in and out, the direction of spin changed, a static positional viewpoint selected, the tilt of the Earth selected, or left as a default setting showing the seasonal tilt of the earth relative to orbit around the sun. Further, using additional slider controls, the recency of quakes shown can be selected, the magnitude of quakes shown can be selected, and the refresh rate of checking on the network for new Earthquakes can be selected. A “random” button can be checked to automatically change the quakes presentation settings for quakes, globe and land surfaces.

The FIELD display mode positions web page nodes relative to the user view into a horizon field that is distributed in a 3-D space but partly subordinate to a particular planar area, with nodes that are closer to the user point of view and further from the user's view placed according to:

(1) preferred relevance to the user, or

(2) based on chronological recency of visitation via the standard browser, such as Internet Explorer or

(3) based on recency of application and visitation by the agent or by groups of agent prior used by the user, or

(4) based on relative popularity of the pages according to available dynamic indexes that rank popularity, or

(5a) based on central or peripheral relevance to the user which is based on a thesaurus ranked word analysis of page text content relative to the Boolean search terms used by the user or

(5b) link test terms or

(5c) metric terms used by the user.

Each of the different horizon network node distributions can be instantly selected using radio controls for each of the alternate preferred views of search Relevance, Chronology, Popularity, Boolean association, or preferred Metric A, B or C association alternatives, for example.

FIG. 18e illustrates a possible 3-D graphical Field display of a collection of document nodes found on the World Wide Web for example. Horizon 1210 represent the furthest visible horizon of network nodes. Space above the horizon 1200 supplies a sense of sky or open space for the user, and alternatively can be used to:

(1) display detail data and thumbnail images about any user clicked-on and highlighted nodes, or

(2) as a default, display show textual detail and node associated page document image thumbnails of the one or more nodes which abut the lower edge of the display, for example.

Nodes nearer to the user virtual point of view can have text labels such as 1270 or 1260 attached and visible. Depending on the navigation preferences set by the user, clicking on any node not closest to the user virtual point of view can cause an animated motion of the user to move up to that node so it will be the largest and closest node, as a flying traveling motion.

In FIG. 18e, clicking above the horizon in position 1200 for example can center the field display of nodes to that position for example, thereby moving out of visibility the foreground nodes entirely, but providing the advantage of moving to another node topical area of interest for example.

Further, in the preceding example navigation, the center 1205 horizon vanishing point perspective lines such as 1290 can be topical boundaries which contain nodes of similar subject matter.

As such, the proximity of nodes in the foreground or in the background relative to the user virtual proximity point of view can be placed based on the various ranking schema associated with virtual distancing for the Field display mode. Therefore clicking above the horizon in position 1202 can laterally move the node network display to the right.

Clicking above the horizon in position 1200 can laterally move the node network display to the right:

(1) to a greater lateral position translation degree, and or

(2) with greater speed to the same lateral positional displacement.

The object is to navigate subjects by moving the point of view in a lateral flying motion, and navigate subjects of greater or lesser interest based on the alternate distal ranking methods, based on moving in and out of the Z′ space If flight simulator mode 260 is enabled, the user can free fly in any direction over the field plane and circle back or back-up to any prior position as desired.

As a new position is held, as a virtual hovering of the user point of view over a section of the field plane, the user can point and click on any network node to:

(1) display its associated detail data, or alternatively this action can

(2) launch the browser to visit the associated document node page, and or

(3) clicking on the node from higher above looking at a steeper angle downwards onto the plane where the horizon is no longer visible. This can cause the point of view to move back to low, lover position and have the selected the node become the most foreground node as illustrated by FIG. 18e.

Each of the plurality of different 3-D display type modes can be dimensionally collapsed from three dimensions to 2 dimensional rectified representations:

(1) the SPHERE network display mode becomes a flat planar projection of a circular hierarchical radial representation,

(2) the FAN network display mode becomes a flat planar projection of a hierarchical tree structure,

(3) the CUBE network display mode does not rectify to a flat planar projection,

(4) the ZONE network display mode rectifies to a flat planar projection divided into domain type areas,

(5) the TOPIC network display mode rectifies to a flat planar projection divided into topic areas,

(6) the HYPER network display mode rectifies to a flat planar circular radial projection where all spokes from all nodes are generally radial outward from the center of the circular visual lens,

(7) the GEO mode network display mode rectifies to a flat map projection of several types, including Mercator, Robinson, and other world map flat projections, and

(8) the FIELD network display mode rectifies to a flat linear column based layout with elements ordered in the columns and rows according to the ranking.

The special metric display modes which are used as double duty projections for the four radio buttons when the Metric check box is checked are not applicable to rectified 3-D to 2-D planar projection.

All network display modes provide different means to visualize the network connections in relationship to different connectivity emphases and ranking criteria The network 3-D display modes of SPHERE, FAN, CUBE, ZONE, TOPIC, HYPER, FIELD and GEO can all be flat projected from any 3-D multi-axis rotational orientation onto the ‘floor’ as flat projected network layouts.

The ‘floor’ is one of the extremity plane of the plotting spatial grid, and then the Metric word count information associated with all nodes can be projected as elevation bars when the “Bar Graph” 170 checkbox is checked.

This enables the user to see the network layout of a plurality 3-D display types flat projected onto a plane and then project elevation bar graphs up from the plane to illustrate the relative ranking of the Metric counts which have been collected. For example, in FIG. 17, is illustrated a flat projection of the FAN type that is oriented to produce a series of flat projected radial spokes and circles of different sirs on the grid floor. The fan type also display the Metric ranked hits based on counts as elevation bar graphs in order to illustrate and discriminate valuable information as to the density and relative ranking of selected metric counts collected.

When the user selects a new display layout format, there are two alternate means of transitioning between display formats, “Jump” and “Morph” transition. When the instant transition occurs, the default transition method, the node network display type format switches to the new display format locations in a single frame to the frame switch.

When the ‘glide’ or ‘morph’ transition is enabled, the entire network display smoothly animates from one position layout to the next positional layout. The morph display layout transformation calculates the current and subsequent position layout relative differential distance so all nodes begin and complete their positional motion transition in the same time interval.

In this method, if the distance between origin and destination node positions is short for one node and greater distance for another node, the rate of animation motion between positions occurs so that the motion of both nodes begins at once and ends at once together.

In this method, each network node layout becomes a 3d morph target point, and trajectories between targets are computed and the smooth morph animation between targets from one network display layout to another is produced. This morph transformation process is identical to that which is used in the computer graphic animation industry for morphing faces of different people or characters into none another. In the present invention however this is applied to the transformation between different information network display types, where the same common information nodes or sit page nodes are the morph targets which are transformed.

The system includes means to convert discovered information sources and resources into user personalized dynamic animated environments which by analogy represent a collection of network locations as links or bookmarks on the display. The user specifies which elements of an agent results report, or manually imports their recorded bookmarks from web browser into any arbitrary graphical representation style format. Network web site page locations are stored as bookmarks by the agent search and retrieval activity. Users engage in ordering, ranking, and sorting the sites of interest according to interest and perceived value.

The collected bookmarks are sorted into any number of a plurality of ranking orders and categorizations. Ranking orders and classifications of category are made according to:

(1) arbitrary user chosen relevance and interest,

(2) automated agent estimated relevance and interest,

(3) manually chosen topical subject inclusion,

(4) automated topical subject inclusion,

(5) recency of web page change as site page updates,

(6) frequency of user interaction,

(7) recency of user visitation,

(8) current or historical popularity in a community of users,

(9) third party expert community judged focuses.

The user chooses from a plurality of different metaphorical environmental representation layout formats which can be represented visually in two dimensional or three dimensional layout, and/or represented sonically in tonal, melodic and harmonic forms, and/or tactilely in different textures.

Metaphorical environment representations can be created solely by the user. This done with different visual rendering tools or audio synthesis and sequencer construction tools. Alternatively, metaphorical environment representations can be selected out of a plurality of available options, which are used as templates to correlate and map to preferred user bookmark information. Users can further modify different environmental representation templates. Users can employ a plurality of templates, which are mapped as represented elements into higher level representation style templates.

Users can assign different templates on a time scheduled basis to be used and active as defaults according to different times of the day, or times of the week, or in different months, or according to different seasons of the year. Users can assign different templates to be active as defaults on an emotional preferential status basis, which emotional status can be selected from a emotional states template collection selector interface.

Users can manually assign different templates to be active as defaults on an emotional preferential status basis, which emotional status are automatically selected from a emotional states template collection selector interface which is governed by different input sources.

Automatic emotional metaphor template selection methods can include a plurality of means to determine an estimate of what mood the user is currently in, and thereby make active the template which is synonymous with the user mood. Alternatively an appropriate counterpoint template to the user mood as preferentially desired by the user to be selected.

The metaphorical environment representation maps elements within the representation in some pre-designated associative relationship to real world network information sources.

Metaphorical environment representations can be:

(1) iconic representations as thumbnails of the actual network sources and sites, or can be

(2) exaggerated caricature representations of the same site source identities, or can be

(3) symbolic iconic forms that provide simple yet immediate recognition value to the user for the site pages, or can be

(4) entirely user preferential arbitrary metaphorical representation elements within a plurality of environmental elements.

A bookmark or agent network node collection of network sites can be dynamic, and only become visible on the display as an element within the whole environmental representation if certain thresholds have occurred which are chosen as indicators of sufficient value to be made visible.

A browser exported bookmark collection, or alternatively an agent exported node network collection of represent a population of network sites or web pages. The plurality of pages can be sorted by any arbitrary method meeting the preferences of the user. The collection is sorted according to user interest.

The metaphorical environmental representation form and format is selected according to user interest or agreement. The for foreground or background or lateral spatial or front-back occluded positioning relative to one another of the population of pages to be represented is selected according to user interest.

Different metaphorical environments have different inherent complexity carrying capacity. If the population of the desired sites to mapped into the metaphorical representation exceed the complexity of the representation chosen, more than one site bookmark may be associated with single objects or attributes in the environment.

If the population of the desired sites to mapped into the metaphorical representation is less than the complexity of the representation chosen, many elements of the representation may be inactive and present only for esthetic value or contextual recognition. Elements within the environment are used to aid recognition and at-a-glance recognition of active mapped elements, objects or attributed within the representation to web site pages.

A user may choose to have a complex environment that carries representations of populations of bookmarks mapped as environmental features. A plurality of sites associated with a give object form or feature attribute within the environment, and also have a plurality of components within the environment not be mapped to any external linked web site or local activity.

In addition, the user may choose to include a variety of different other network and communication interaction related elements mapped as different environmental features and attributes, such as email, chat resources, local software applications, or network served software applications.

A metaphoric environment becomes a method for the user to preferentially and readily perceptually monitor, access, and interact with web site pages, email, communities and local or remote applications software programs, all, at-a-glance in a desired theme and style.

Metaphorical or analogous or iconic or accurate thumbnail representations of network accessible sites, current or historical email, and local or remote software applications is always available as a dynamic environment.

The environment is selected and cast according to user preference, and changes in the environment metaphorically correspond to changes in the sources of information or information applications which are mapped to the environmental object features or attributes.

As an agent search and retrieval system discovers, collects and analyzes remote or local changes in conditions, or finds new sites or sources of interest according to a user developed interest profile, the metaphorical representation environment is changed. It is changed in specific ways to highlight the presence of such changes in an existing set of preferred sources.

Additionally, new sources of interest found within the remote network or local network settings can be emerge as new features or objects within the metaphorical environment representation, or can be mapped into association with an existing representation object feature or attribute.

Since the environment can be multimedia in representation, including graphical visual, audio and even tactile interface component aspects, as the preferred mapped real world undergoes change and modification, the local metaphorical environment undergoes changes.

If, for example, the user has chosen the metaphorical environment of a forest, or alternatively an underwater aquatic ecology environment, the user becomes familiar with different elements of those environments to be associated with and represent particular real world referents within the network.

The user may have means to navigate around the environment, including for example, fly, walk, switch between viewpoints, or zoom in and zoom out from areas pointed at using a pointing device such as a mouse.

A particular bird in the forest environment, or a particular fish in the aquatic environment are found to be moving about in a certain manner, exhibiting certain behaviors if some information source has changed.

When the information source changes, as reported by an update agent, the corresponding element in the metaphorical enviroment undergoes some related metaphorical change.

Alternatively if new information sources are emergent, new elements in the metaphorical environment representation are emergent into view and presence.

Alternatively if the bird or fish have a changed size, coloration or even shape, these can become user recognizable indicators of certain types of new information. This new information may be relating to changes in the given or group or type of network site pages the agent is monitoring for the user.

Furthering this example, the user can engage in different ways with the bird or the fish. Following the metaphorical model of interactive behavioral preference, interaction with the bird or fish can be in the form of:

(1) pointing at it with the mouse, clicking on it, or

(2) dragging it to a particular location in the representation, or

(3) pointing and clicking on the area of the representation where the user wishes the bird or fish to be located.

The bird may be instructed to land on a particular tree branch which the user uses for that kind of bird or that kind of highlighted bird. The fish may be instructed to join a particular school of other fish, or swallow a hook on a user fishing line.

These types of interactions effect environmental representation element associative changes as categorization or relevance assignments.

Further, the user may single click on the bird that that action instructs the system to show a textual label title that is a incremental indicator of what the bird currently is representing as a URL title for example.

If the bird has changed in appearance or behavior, this single click action may provide a textual title label of what changed information the bird represents. The textual label may be accompanied, as the user pre-established preferences have selected, to also show a visual thumbnail in addition to the text label.

The textual label may be located and visually attached or proximal to the bird, and if the bird is still moving, the textual label follows the bird as an attached element. Alternatively the textual label or visual thumbnail may be appear in a pre-designated area of the display dedicated to textual information display.

A user preferential method of sequential previewing zoom into greater and greater degrees of information can be assigned. A user may prefer one click on the changed metaphorical environment representation element feature to open the standard web browser, such as Internet Explorer, to visit the page. Alternatively, the user may set preferences so that there is a plurality of incremental steps of information zoom into the actual source of the information to which the local representation element is associated.

For example, the user may identity a different range of incremental steps to be associated with different types of information sources and different types of information source changes.

For example, one click on a fish may produce a default static label of what network information source the fish is connected to. Multiple clicks must occur within a desired default maximum time interval. Two clicks may produce the static text label and text referring to the change associated with the information source. Three clicks may produce a visual thumbnail of the information source to appear, or alternatively collect all the changed information from the information source and display it in a window or region of the metaphorical environment representation.

A multiple set of metaphorical environmental representations of the real world network information sources and associated changes may be used by a user.

Multiple metaphorical representations may be redundantly mapping the same set of information sources and associated changes. In addition, representation environments do need to have internal integrated consistency as an environment, and can merely be a collection of elements collected together as a ‘potpourri’. As such, a metaphorical environment can consist only of icons or unrelated images which have no overriding common theme.

The user may choose to switch from one information environment metaphor to another. When this occurs, the information source elements within different metaphors which are common between the used metaphors become graphical morph trajectory anchor points between two metaphors. Each information environment metaphor is treated as a complex object containing a plurality of common information source anchor points, which anchor points have either a one to one correspondence or a one to many correspondence as morph targets.

Any two information environment metaphor representations can have a population of objects and locations which are a statically or dynamically mapped to real or external environment information sources. An information source or population of sources can be another information environment metaphor. Information sources are by definition merely linked to or external from a given information environment metaphor. As such information environment metaphor elements may be mapped to other local or remote information environment metaphor representations and not be a particular web site page information source for example.

A web site information source or population of sources of information existing on a single web page, as designed and laid out by a third party, can have corresponding elements within the user local information environment metaphor representation.

If there are plurality of elements in a web site and a corresponding plurality of elements in a information environment metaphor, the two or more information representation environments may be correlated where elements represented in both have identified common locations relative to each other.

Identified element locations in multiple representations, which common elements correspond to the same information referent elements, can undergo graphical animation morphing between each other for the user's benefit. Common spatial element locations in different information environment metaphors or source referent information sources, are common morph target anchor points.

The user can select one information environment metaphor to undergo an animated transformation of form into another information environment metaphor representation by morphing the location of common anchor points of one environment into the different spatial locations of a another environment.

Simultaneously, the other related shape, color, texture and lighting elements associated with one information environment metaphor are smoothly transformed into the shape, color, texture and lighting elements of another environmental representation.

Alternatively, the user can select an information environment metaphor to undergo an animated transformation of form into the information sources themselves, if such sources exist on a single web page. This is done by graphically morphing the location of common anchor points of one environment into the different spatial locations of the information source environment.

Further, if the information sources represent a plurality of web site pages for example, the metaphorical information environment object morph targets can morph into a pre-designated tiling layout of the plurality of web pages.

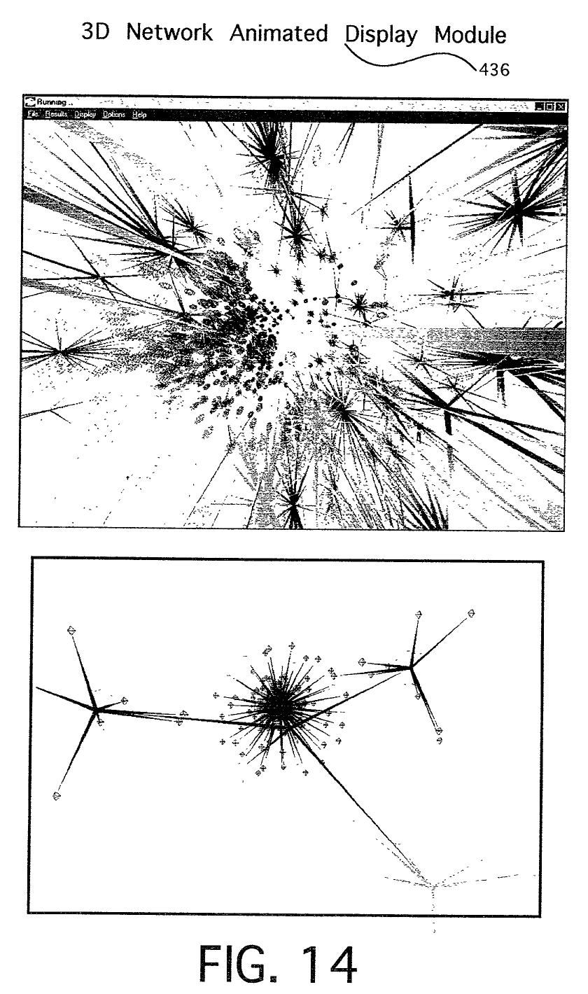

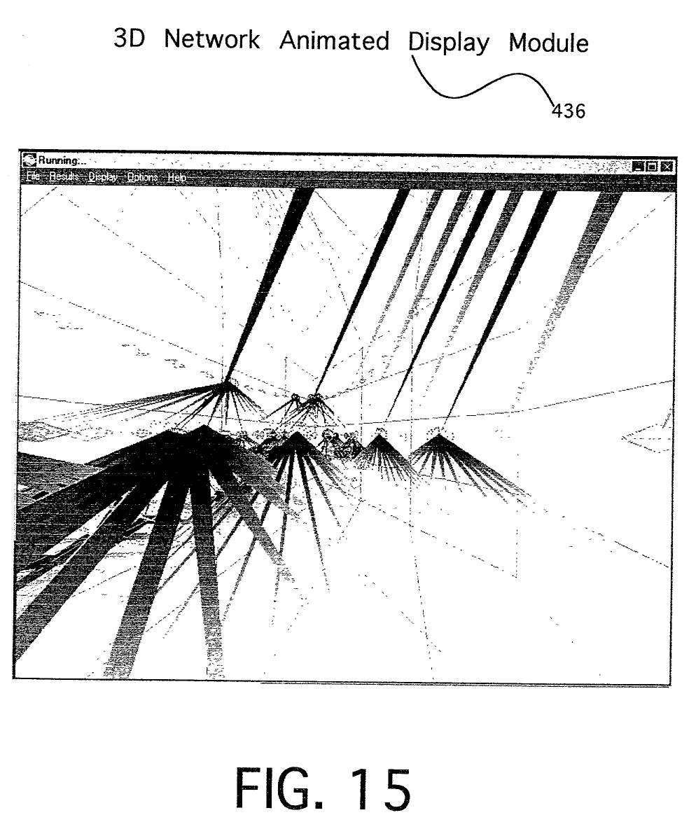

The information environment metaphor can be morphed into a variety of different network lay out formations, including for example any the 2d or 3D network visualization display layout styles of FIG. 13, FIG. 14, FIG. 15, FIG. 16a, FIG. 16b, FIG. 16c, FIG. 17a, FIG. 17b, FIG. 17c, FIG. 17d, FIG. 18a, FIG. 18c, FIG. 18d, or FIG. 18e.

FIG. 18f illustrate an example Metaphorical information environment display. The display shows a metaphor of a beach environment 1390 populated by a number of different objects, each in context to the general environment. The general features of the environment have been chosen by a user to metaphorically represent different areas of interest.

The rock formation 1381 represents must-see changes in a web site which the user regularly frequents. The beach sand area 1391 represents the topics of web site vendor purchase deals and related news information that can be ‘beach combed’. The ocean region area 1389 represents the subject matter about that has not surfaced yet for the user. The sky areas 1392 represents an undefined topic area where unclassified new information found by agents can be placed for opening.

In this example, network site nodes are mapped as different foreground objects and the areas in which the objects are found represent topical areas of potential interest. The fish 1388 jumping out of the ocean represents current unread news a agent has found in the topical area of ZZZ, the horn of plenty 1387 on the beach represents a desired shopping deal an agent has found is available for the user in the subject area of 1391.

The chick 1385 on the beach represents a recently retrieved and read web site relating to maternity products and news, and the chick 1385 stands next to the egg 1384. The egg represents an agent discovery of some new maternity related information that was not on the display before, that the user has tasked an agent to seek. The egg can be clicked on to see what news or new information has been brought back by an agent.

The flying chick 1383 represents web site time-limited offer opportunities that must be taken advantage of before they fly away and are no longer available. The newborn chick in the broken egg 1382 represents partly retrieved newly emergent information from a web site page that relates to natural birth techniques.

The goose flapping its wings 1386 on the beach represents another source of time sensitive of information relating to planning for motherhood, following the ‘mother goose’ metaphoric reference.

The flowers 1380 on the rock represent a collection of web page sites an agent has found for the user which relate to an upcoming baby shower and the users registration for certain gifts they wish to receive from their family friends. When the flowers are complete or approved by the user another agent will send the URL's and titles for the gifts as emails to the list of the user's friends who will be attending the baby shower.

All of the character animals and plants on the beach are animated, and are showing new behaviors to specifically highlight changes in the information resource environment of interest to the expectant mother.

The selection of the character types is predetermined by a metaphoric environment display template selector, which permits the user to select what animals and plants and what behaviors will comprise their personalized dynamic information map.

This FIG. 18f example represents information culled from the web by a plurality of agents, which information represents items of time sensitive interest to the user according to user interest preferences. In this example, the user is a pregnant woman who is thinking a lot about maternity, baby shower gifts,

The FIG. 7 zoom control slider 160 brings the point of view of user as the screen window closer to or further away from the whole plotted node network space. Moving the slider bar to maximum zoom factor inward places the view to inside the generally bounded plotting space to near the further edge of the bounded plotting space. Moving the slider bar to maximum zoom factor outward placed the view to far outside the generally bounded plotting space where the entire plotted space in held within a singular view and surrounded by uninhabited space.

The FIG. 7 “Grid” 162 radio buttons of “OFF”, “1”, and “2”, turn the grid reference outlines off, or turn Grid reference on, or turn Grid Boundary reference on. The grid reference demarcates the 3-D plotting space for network page nodes and link spokes. The standard “Grid” reference format provides a detailed cross-hatched multi-level outlined cubic plotting space, and the “Grid Boundary” reference provides only the outline of the whole cubic grid edges.

Having different grid types on can provide visual orientation for the user discrimination of the plotting space, since the user point of view can move to the exterior or interior of the whole plotting space, where when outside the plotting space the user may see the entire cubic grid plotting space as an outline even before an network search and agent has even commenced any search and network topology collection.

The FIG. 7 sub-window “Rotation” 164 provides controls for altering the animated rotation of any display type. Clicking on the “B” button causes all the rotations to reverse and go backwards relative to the prior rotation settings in three axes. Clicking the “R” button resets the grid orientation relative to the user view and stops all rotations. Clicking the “S” button stops the rotations without resetting the grid orientation, retaining the last multi-axis rotated position prior to clicking “S”. The “+X” horizontal slider control 172 sets rotation rate for the X axis (center position on the slider is zero rotation). The “+Y” horizontal slider control 174 sets rotation rate for the Y axis (center position on the slider is zero rotation). The “+Z” horizontal slider control 176 sets rotation rate for the Z axis (center position is zero rotation).

The FIG. 7 sub-window “Rotation Position” 180 provides controls for altering the initial rotation position of the entire grid space relative to the user view. The “X” horizontal slider control sets the initial rotation position on the X axis, the “Y” horizontal slider control sets the initial rotation position on the Y axis. The “Z” horizontal slider control sets the initial rotation position on the Z axis. Immediately to the right of these slider controls are preset initial global grid orientation position controls for quick selection of a preferred orientation for the network visual display space. Selection buttons “1”, “2” through “8” are eight buttons which each ‘quick set’ the initial rotation position to a preferred orientation for the user.

The user can use the default eight positions or can preset these buttons to select a position that was manually generated using the slider controls of this rotation position sub-window. To preset and apply a manually set rotation position, the user must press a keyboard ASCII key “P” and then click on the orientation button to which that initial rotation position will be later selected when desired.

The FIG. 7 sub-window “Connector” 190 provides controls that modify the appearance and selection of links connectors between web page nodes. The “Back” check box, when checked, shows all “backward” links that were previously considered ‘duplicates’ and ignored. The “Off” radio button turns off the Node to Node connectors so they are not visible.

The “Line” radio button when selected causes the display to use Lines for the Node connectors. The “Z” radio button when selected causes the display to use two dimensional spoke Flanges for the Node connectors. The “XYZ” radio button when selected causes the display to use 3-D dimensioned Flanges for the Node connectors.

The horizontal slider control “Size” 198 sets cursor cross-hair size, or sets the Flange size, or alternatively, sets the end width of flanges when the display is set to cloak mode 200. The “True” radio button in the ‘Connector’ sub-window when selected shows TRUE to TRUE node link connections only, the “Visited” radio button shows VISITED connections only, and the “All” radio button shows all page to page link connections.

The FIG. 7 sub-window “Node” 202 provides controls that modify the appearance and selection of web page nodes in the network. The “Off” radio button when selected turns off the Node display so they are not visible. The “True” radio button when selected shows TRUE nodes only. The “Visited” radio button when selected shows VISITED nodes only. The “All” radio button when selected shows ALL nodes in the network which the search agent has discovered.

In FIG. 7 sub-window “Node” 202 the horizontal slider control “True” 207 sets the size of TRUE nodes or sets the Bar-graph bottom dimensions, or alternatively sets cloak mode trails when cloak mode is active Bar-graph bottom dimensions control of this slider is only active when the “Bar-graph” 170 check box is checked, and the cloak mode trails control of this slider is only active when the “Cloak mode” 200 check box is selected.

In the sub-window “Node” 202, the horizontal slider control “False” 208 sets the size of FALSE nodes or sets the Bar-graph top dimensions or sets cloak mode trails B. The horizontal slider control “Unkn” 210 sets the size of UNKNOWN nodes, or Bar-graph window dimensions or Sets the number of stars in cloak mode.

Cloak mode is a display mode that hides the normal network display mode from viewers when the users wishes to keep the network display confidential. It instead provides a display of animated graphical stars and shafts of light, which are colored to indicate the status of the agent search and retrieval in terms of True, False and In-progress states of search agent progress.

The cloak mode can be configured to display animated stars in the Color green when the agent has found any True hits for during the search while it is still progressing. Alternatively it can be limited to display green stars only when it is finished altogether, and these status indicator colors thereby provide for the user an at a distant glance report to the user as the progress of the agent search and retrieval activity.

The “Point” 212 radio button in this sub-window when selected displays nodes using only points in plotting the symbol shape used to represent the node. The “Line” radio button 211 when selected displays nodes using only lines in plotting the symbol shape to represent the node. The “Fill” radio button 213 when selected displays nodes only as a solid color fill symbol forms. These three different options for point, line and fill rendering of the node symbol shapes permit different degrees of plotting speed and transparency for complex network topology space visual discrimination by the user.

The FIG. 7 “Cursor” sub-window 220 provides vertical slider controls to select any page node in the display network according to the natural order of discovery sorted into True, False and Unvisited nodes. Alternatively the slider can display nodes according to the order of a selected metric, or according to recency of change, ranked popularity and other ranking attributes.

The “1X” vertical slider control 222 moves the pointer cursor to select a node within the network, and the vertical slider control 224 moves the cursor “100X” to select a node. The slider 222 selects up to one hundred nodes one by one and is the ‘fine’ control and the vertical slider 224 selects nodes by one hundred for each increment and is the ‘coarse’ control. At the bottom of this narrow vertical sub-window 220 the button “Go To” 230 when clicked open the web browser, such as Internet Explorer, to visit the web page correlated to the visual Node that is selected by the vertical slider control cursor.

In one embodiment of the present invention the cursor tracking slider is enabled to accomplish a continuous non-linear information lens control. Nodes near the slider position in the tracking sequence order are visible in finest detail, that is inclusive of all nodes within the proximity sequence selection position. Nodes which are incrementally more distal to the current tracking node selection are displayed with in less density of available viewing display.

The purpose of this is to provide a linear ‘lensing’ inclusion and exclusion of the member nodes tracked through in a sequence. A bell curve of available visible nodes within the display is effected where the top of the bell curve is always the current highlight focal position in the linear sequence, and nodes positioned in the linear sequence proximal to the finest resolution highlight are incrementally less resolution.

Nodes more and more incrementally distal, that is further away towards the boundary edge of the bell curve ‘lensing’ of the linear list are increasingly less visible and increasingly omitted from the visible display of the node network.

This provides a linear list visible density control mechanism to dynamically display from maximum network list display sequence inclusion to maximum network list exclusion, and which technique can be applied to ‘lensing’ fine control as including all list members, to coarse control as including the least list members.

This method provides an effective means to focus attention on list adjacent members near the pointer highlight focus and minimize appearance of distal node members in the list.

The FIG. 7 “Color Key” sub-window 232 provides several types of color keying of the network display using one of seven radio buttons. The “TRUE FALSE UNKNOWN” color key radio button 234 when selected uses green, red, and blue to show and discriminate TRUE (green), FALSE (red), and UNKNOWN (blue) nodes respectively.

The “COM GOV NET EDU ORG MIL OTHER” color key radio button 236 when selected uses color to show and discriminate domain type, including “COM (green), GOV (red), NET (yellow), EDU (violet), ORG (dark blue), MIL (gray), and OTHER (light blue)”.

The “LINKS 0-12-255” radio button 238 when selected uses a color gradation scheme to show and discriminate the number of links associated with any node, such that nodes with the same number of links will have the same color. Different numbers of links per node will be colored different colors.

The “Metric A” radio button 240 when selected uses red gradated to green to show and discriminate Metric A number of counts. The “Metric B” radio button 242 when selected uses red gradated to green to show and discriminate Metric B number of counts. The “Metric C” radio button 244 uses red gradated to green to show Metric C number of counts, and the “Metric” radio button 246 in this same series of radio buttons uses metric values A, B, and C color coded as Red, Green, and Blue color respectively to show Metric Sum.

All color coding of nodes is extended to also color the links between nodes, such that any two differently colored nodes color the links as a flange or line between them in a gradation between the two colors.

The “Metric Range” horizontal slider control 247 when moved to the right magnifies A, B and C Metrics or sum of A+B+C Metric values. When the Metric radio buttons 240, 242, 244, or 246 are individually selected, the metric range slider control intensifies the red to green saturation and luminance.

When the “Bar-Graph” 170 check box is selected, the metric range slider control scales the relative elevation of the metric elevation bars to larger or smaller size.

Check box “Bar Graph” 170, when checked enables the Bar Graph mode, and check box “Windows” 248 when checked enables the Bar windows, which are a rendering effect applied to the bar charts to make them appear as if they were architectural buildings.

When the bar graph display mode 170 is selected, the “Node” sub-window 202 slider controls are double duty utilized to scale the bars themselves to take on different shape appearances, such as bar base width and bar top width.

For example, the base of the bars can be widened to extend substantially beyond the width of the flat floor projected nodes they are associated to within the node network, even to overlap and intersect with other node bar base width extensions. The upper tips of the bars can be minimized to a point width, with the resulting metric bar chart graphical display appearing as a mountainous landscape with diagonal edges representing the angular sides of the mountains and hills within the ‘bar graph’ 3-D rendered landscape.

The FIG. 7 “Digit Size” 250 check box, when selected, enables single sided metric display digits as opposed to four sided 3-D boxes associated to nodes or bar graph tops, with the appearance of the same digit information from four different ninety degree angles.

Selecting the “Digit Size” check box for some computers reduces the digit display to a single reading which stays normalized to the screen view of the user regardless of the rotation of the network space as a whole that is used, The “Digit Size” slider control 252 sets the metric digit size, or alternatively sets the end width of animated flanges in cloak mode as an esthetic option.

The FIG. 7 “Vista” 253 horizontal slider control sets the vertical position of the display relative to the network display, and operates only when the display is not in “Flight” 260 network display control mode or “Tracking” 256 network display mode. The vista control default value is in the middle of the slider.

The FIG. 7 “View Angle” 254 horizontal slider control sets the display field of view from gradations of telephoto to wide angle display of the network. Setting the view angle slider to the extreme left disables this control.

The FIG. 7 “Tracking” 256 check box, when selected, causes the display to enter and tracks the node that is selected by the cursor, This tracking function highlights the node selected to be bright white in color, with a 3-D three line XYZ axis cross-hair if desired visible for visual location identification of the node.

Additionally, when tracking mode is enabled, the point cursor moves the entire visual network display space to have the selected node become centered onto the screen. If rotation of the 3-D space is already occurring, then the newly fixed to screen center node becomes the new center of rotation of the entire node network display.

As the Cursor pointer control vertical slider 222 is moved up and down through the sequence of nodes available, the cursor selects through and highlights to bright white those network nodes in the order selected. The orders of sequence can follow:

(1) the natural discovery order,

(2) the recency of page change,

(3) the metric value, or

(4) other ordering useful schema for sorting and sequencing through the page node 3-D visualization network.

If the vertical slider bar is set to a virtual node that is higher than the total nodes discovered, the tracking mode will cause the display to re-center to the node being currently visited while the agent is engaged in the live search process. This affording the user a means to easily locate and view the current web page document node being visited and evaluated.

The FIG. 7 “Fan Ring” 258 check box when selected causes the display to render fan rings associated to the FAN display type.

The FIG. 7 “Flight” 260 check box when selected enables the system flight simulation mode. The flight simulation mode provides a means for the user to free fly through the 3-D network space using the mouse or touch pad control or other spatial motion control input device.

Dragging the mouse or finger on the touch pad to the right causes the flight direction to move towards the left, or dragging the mouse or finger on the touch pad to the left causes the flight direction to move towards the right.

Dragging the mouse or finger on the touch pad upwards causes the flight direction to move downwards in 3-D space relative to the users orientation.

Dragging the mouse or finger on the touch pad to downwards causes the flight direction to move upwards in 3-D space relative to the users orientation.

Selecting number keys on the keyboard changes the forward flight speed, from least ‘1’ to fastest ‘9’, and ‘0’ stops forward motion altogether.

Clicking the right mouse button on the mouse, or the right click button on the touch pad causes any prior motion up, down or left or right to freeze still.

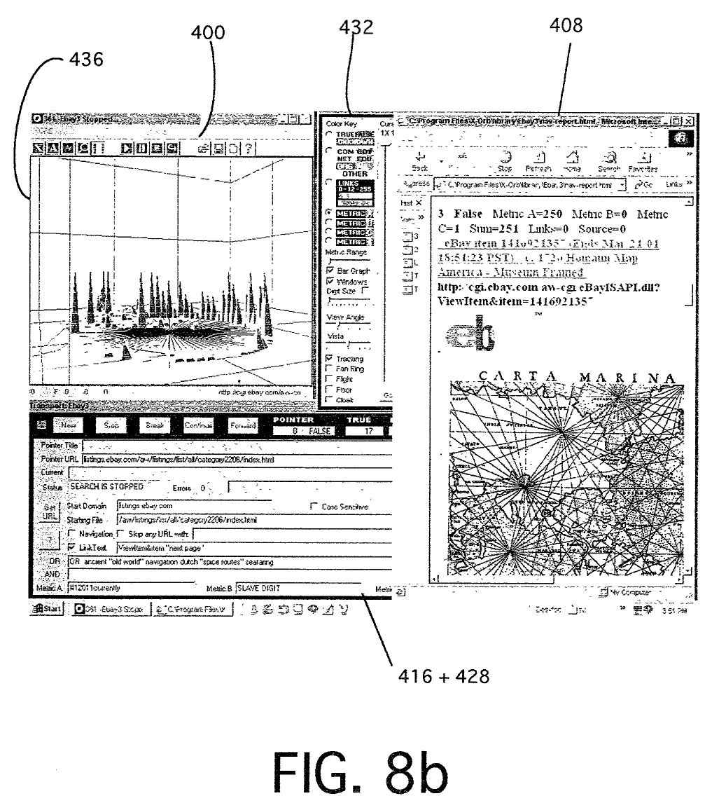

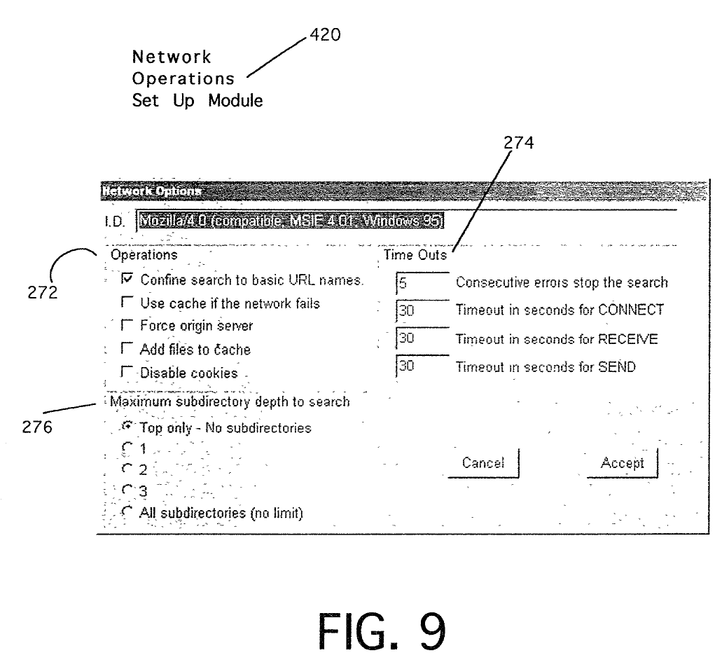

The FIG. 7 display controls correlate to the FIG. 8a graphical animated network display which includes the master tool bar and dynamic pointer and agent status information. When “Flight” mode check box 260 is checked, there are four modes of 3-D cursor control to highlight and select nodes within the network display, including “Beam”, “Spheric”, “Planar” and “Point”. The 3-D cursor is a special node highlighting cursor that is unrelated to the standard computer display cursor.

When the user is in Flight mode, the cursor mode of operation is selected by pressing the keyboard “BB”, “S”, or “P” keys, or by pressing graphical buttons with those letter characters available on the main tool bar 400 associated with FIG. 8a animated graphical display.

Changing the capture scope of the chosen cursor is accomplished by pressing the ‘up-arrow’ and ‘down-arrow’ character keys on the standard computer keyboard or by clicking on the ‘cross-hair’ icon on the tool bar 400 control on FIG. 8a. This pops up a graphical display control window with graphical ‘up’, ‘down’, ‘right’, and ‘left’ arrows.

As the scope of the cursor mode is modified, the window shows the size. The settings for the cursor can be saved to the agent for later default usage. The four cursor modes, as follows are applied to the animated graphical 3-D display of FIG. 8a:

(1) The Beam 3-D spatial cursor mode is the normal default. The “Beam” cursor selects a single node at a time. The node is within a narrow virtual Z-axis tubular beam line zone of selection, which highlight beam is in the user's center-of-screen as a straight Z axis line of activation relative to the X-Y reference screen plane of view of the physical display monitor. A small circle and cross-hair can be optionally overlaid on the network display screen for reference.

The absolute Z-axis length of activation can be set so the beam length is limited, thereby avoiding selecting nodes too far ahead relative to the user's virtual screen plane of view reference.

If two nodes fall within the beam at once, the node closer to the user screen plane of view is selected over the further away more distant node found within the beam.

If two nodes are the same distance away from the user in Z-space measurement and both fall in the highlight beam, then the only one is highlighted based on the first highlighted. Alternatively this is based on selecting a right or left arrow on the computer keyboard to change the selection. The beam depth in Z-space is modified using the ‘up’ and ‘down’ arrows described above.

(2) The Spherical 3-D spatial cursor mode highlighter selects nodes within a spherical or ovoid zonal volume, which spherical zonal volume is sized larger and smaller by pressing the ‘left arrow’ for smaller and ‘right arrow’ for larger buttons or keys. It is positioned closer or further from the relative user screen plane of view using the buttons or keys of ‘up arrow’ for further and ‘down arrow’ for closer to the screen plane of view.

The spherical volume can be set to highlight and select only one node which is closest to the spherical highlight center point, or set to highlight and select all nodes within the spherical zonal volume in use. The spherical zonal volume is always centered on the X-Y screen plane of view, that is, positioned in the middle of the screen, so that as flight and motion occurs, changing the portion of the network in view, it remains fixed to center of the screen.

(3) The Planar 3-D spatial cursor mode highlighter selects nodes within a planar or laminar zonal volume, which planar zonal volume is sized in length and width of the zonal plane using the ‘left arrow’ for smaller disc plane and ‘right arrow’ for larger disc plane. When using this mode the default is a disc plane that encompasses the entire network plotting space. The laminar thickness of the planar zonal volume is increased in thickness using the ‘up arrow’ and decreased in thickness using the ‘down arrow’.

The position of the planar laminar zonal volume is always a horizontal width which in the screen center relative to the user screen plane. This always has the closest edge of the zone abutting the edge of the screen plane, such that when sized in length and width, the planar zone is always growing outwards or inwards on the far leading edge of the laminar plane only.

If the FIG. 7 “Vista” 253 slider control is used while in Flight 260 mode, the plane will move up and down the X axis of the entire network display, however, still remaining fixed to the vertical center of the screen plane. This mode can be set to select only one node at a time, resolving selection conflict by selecting the nearest node to the screen plane within the planar highlighter zonal volume. The mode can also select all nodes falling within the planar zonal volume.

(4) The Point 3-D spatial cursor operates in either Flight mode or in any non-flight mode. In Flight mode the user has stopped the flight motion, or while in any non-flight modes including pointer Tracking. The user moves the cursor to point over any area of the screen plane to highlight point at any network node. When the node clicked, will select the node pointed at, and then the user can activate the incremental preview click sequence mode or activate the browser to launch to open at the URL represented at that highlighted node.

In one embodiment of the invention the pointing action is accomplished through the use of touch screen based pointing, or gesture based pointing on what the user points at with their finger, or alternatively eye tracking input interfaces where the user highlights the nodes they are looking at.

Highlighting and selecting more than one node at a time is accomplished using the cursor to draw an arbitrary shape on the screen plane around a group of nodes, as in a ‘lasso’ highlight and grabbing action. The arbitrary shape drawing is accomplished using a pointer cursor controlled by a mouse, or a by a hand or finger gesture motion, or drawn by eye tracking interface device enabled motion.

These different types of input point and select and lasso control can also be applied to controlling and highlight selection of any of the controls within the present invention, including buttons, check boxes, and sliders.

Any node or group of network document page nodes that are highlighted using any of the 3-D cursor modes, can be selected in order launch the standard web browser. The user can set whether the opened web browser visits the actual web or network page document, or can be set to generate an HTML document showing only the previously collected results for those the selected nodes. This is a dynamic method for setting the report format and prior setting for HTML report formatting are still active for the selection of nodes to be shown using the standard browser.

When any node is white highlighted using the flight simulation mode, the user can press the ‘space bar’ on the keyboard to direct the standard web browser to open at that web page. The preview of both the URL and page title displayed in the transport window FIG. 6a, or the status bar located at the bottom of the window in FIG, 8a.

When the cursor tracking mode 256 is selected, which is a mode that is mutually exclusive to the flight simulation mode, the user clicks on the “Go To” 230 button to activate the browser to open at the cursor selected web site. However while in the flight simulator this same button 230 may be used to cause the flight simulator pointed and highlighted node to instruct the web browser such as Internet Explorer to open to that highlighted web page document.

The FIG. 7 “Floor” 268 check box when selected turns on the grid floor, which is a solid or many lined or dotted gray colored plane on one face of the 3-D network plotting grid space.

In the preferred embodiment of the present inventions the graphical display interface is implemented in several forms, as a Windows OpenGL based implementation, a Macintosh OpenGL based implementation, or as a Linux OpenGL based implementation. OpenGL is a Silicon Graphics originated graphical standard that has been adopted by most major computer operating system manufacturers, including Apple and Microsoft. In one embodiment of the present invention the graphical display subsystem is implemented in a Java applet based 3-D graphics system.

All settings for network display control, including last position of the user while in Flight mode for example, are saved when the agent is saved to disk. This allows the re-opened agent to display the network in the exact last saved preferred user screen plane position and network display settings. It also permits new users of the agent to have a preset display appearance and control to maximize ease of use and productivity using the network visualization navigation aspect of the present invention.

In one embodiment of the present invention, following the active user tracking through the network node display is accomplished using the tracking slider controls 222 and 224 of FIG. 7. Alternatively following the flight simulator mode 260 of FIG. 7 directionally point highlights web page symbol nodes, and successive preview pop-up windows will be displayed.

These two primary network display navigation and node highlighting modes of Tracking and Flight, which produce automatic highlighting of page nodes, and display associated text of the page title and the URL address. When the user clicks the mouse after visually and textually highlighting any individual node, this action will then generate a pop-up overlay window that shows increasing successive detail preview of the searched and partly or fully retrieved web page. This occurs according to default settings for user selected order of web page previewing.

For example, clicking once on a highlighted node shows in the pop-up window a web page thumbnail picture or the first captured textual data set corresponding to the page node discovered Boolean Match. Clicking again on the same node without changing nodes, will show the text label name for the first file name under image or custom capture extension set up for the agent. If the file extension refers to a web page active file, such as JPEG, GIF, or WAV, or MOV file for example, the file will display or play in the pop up window.

If the web document custom captured is not a standard browser displayed file content, clicking will display the name of the file, which then clicking again will launch the local application that displays or plays the file. The click selection order of pop-up display may be configured to show:

(1) the first textual Metric match, or

(2) the first image captured, or

(3) the first .WAV file collected, or

(4) may be configured to show or play all of a particular captured document type, whether image, sound, or movies enabled for display in the standard browser, or

(5) requiring an external application to open to display the file contents, such as Adobe Acrobat in order to display all collected .PDF file extension documents for example, or

(6) opening a word processor to display a .DOC file, for example.

These sequential document opening options effect an information content access focal zoom for the user as a means to manage information overload. The display sequencing preferences can be selected to display all the browser enabled contents of the captured web page by automatically opening the browser. Alternatively, the system can be configured to display incremental increasing detail previews of increasing amounts of information captured from the web site page. These features are provided in addition to the ability to click the ‘Go To’ 230 button in FIG. 7, or pressing the ‘space bar’ of the computer keyboard or function key of other enabling input devices.

The present invention incorporates the capacity to have the control display titles changed to foreign language, and have the title changes to a customer identity, and logo as ‘private branded’ tool, or have third party private branded agents and suites of agents.

The FIG. 8a graphical display control window controls and corresponds to the visualization that is presented in a separate graphical display window. Animated graphical network display visualization and agent status information is dynamically updated and displayed in the display window with a status bar text display line 290 at the bottom edge of the OpenGL display and an main control toolbar 400 located at the top of the OpenGL display.

The status text bar 290 has seven text display sections in one single line height text bar across the bottom of the OpenGL display, including, from left to right:

(1) ‘visual network display cursor pointer number’ 291,

(2) ‘pointer associated true or false’ indicator 292,

(3) ‘pointer associated metric A value number’ 293,

(4) ‘pointer associated metric B value’ 294,

(5) ‘pointer associated metric C value’ 295,

(6) ‘pointer associated web page title’ 296, and

(7) ‘pointer associated URL’ 297.

When the user tracks using FIG. 7 vertical slider controls 222 and 224 through the web page node network represented in the display, the title line and the URL line change to correspond to the tracking highlighted node in the graphical display.

The FIG. 8a has an ‘active current URL’ 298 display on the menu selector bar which shows the current node being visited by the agent. The top window bar 299 displays the number of pages 301 collected by the agent, the name 303 of the agent and the current status 305 of the agent, including whether it is ‘Stopped’ or ‘Running’.

The FIG. 8a icon tool bar 400 comprised of a row of icon controls which have pop-up rollover text labels. When the control windows are opened or actions initiated using these icon controls, the icons remain highlighted until the associated control window is closed or action changed.

From left to right:

(1) the ‘X’ symbol icon 302 “Show or Hide the Transport Window” toggles the transport window open and closed;

(2) the ‘A symbol’ icon 304 “Set the Format for the Results” toggles open and closed the agent report formatting window that will generate a results report in a formatted HTML document;

(3) the ‘Lightning bolt symbol’ icon 306 “Set the Network Settings for the Agent” toggles open and closed the network operations settings window;

(4) the ‘magnifying glass’ icon 308 “Set the Agent Actions” toggles open and closed the agent action and capture settings window;

(5) the ‘striped vertical colors’ icon 310 “Set the Graphics Display” toggles open and closed the 3-D network visualization controls window;

(6) The ‘right arrow play’ icon 312 “Start an Agent” when clicked launches an agent search and retrieval activity;

(7) the ‘two vertical stripe pause’ icon 314 “Stop the Agent” when clicked stops the agent activity after it completes the last network operation engaged,

(8) the ‘square box’ icon 316 “Interrupt and Stop the Agent” when clicked breaks out of the current network operation and stops the agent activity;

(9) the ‘curved right pointing arrow’ icon 318 “Continue the Agent” when clicked re-commences the agent activity from where it last left off in its search and retrieval activity;

(10) the ‘open folder’ icon 320 “Load an Agent” when clicked opens the open file dialog window for selecting an agent to load;

(11) the ‘disk’ icon 322 “Save an Agent” when clicked opens the save file dialog window for entering the agent name to save as, or saves over the currently named agent that was previously opened;

(12) the ‘document page’ icon 324 “Opens the Results in a Browser” when clicked opens the collected search results in HTML format in the standard web browser; and

(13) the ‘?’ icon 326 “Show the Notes for the Agent” when clicked shows the agent associated text description and annotations, or if no description is available, permits the user to enter a description or add annotations to the agent description using the local computer notepad function.

The preferred embodiment of the present invention permits more than one agent to be executing at once, so that the user may activate and run a plurality of agents simultaneously on their client computer. This enables a single user to operate numerous agents that each perform different desired tasks for the user.

FIG. 8b illustrates multiple windows open including the web browser report generated, network dimensional display, icon control tool bar, search term entry, search status, and visualization controls. The upper left window shows the network display 436. The upper left window tool bar 400 abuts the top of the network visualization display. The upper right window web browser 408 shows a sample report for a given web page. The upper middle partly occluded window shows certain visualization display controls 432. The lower left window shows a combined window with both search set up in the lower portion 416 and 428 respectively and transport control and status display in the upper portion 416 and 428 respectively.

The FIG. 9, represented in FIG. 1a as 420, “Network Options” window activated from either the pull down menu or from the FIG. 8a tool bar associated with the 3-D graphical display window, provides selections for machine identification to the network, preferences associated with network operations, time-outs, and limit of the search depth to pursue.

The text entry line “I.D.” 270 is where the user enters the machine identification which the network will see as the agent is engaged in search and collection activity, such as “Mozilla/4.0 (compatible; MSIE 4.01; Windows 85)”, which identifies the machine as running Internet Explorer for instance.

The FIG. 9 “Operations” 272 sub-window provides a series of check boxes that can select different preferences for the operations of the agent. This includes:

(1) a check box for “Confine search to basic URL names”,

(2) a check box for “Use cache is the network fails” which uses the browser cache,

(3) a check box for “Force origin server” which follows ‘redirects’ to reach the origin server of a web page addressed and served via a secondary server,

(4) a check box for “Add files to cache” which instructs the agent to add discovered and collected files and data sets to the browser cache, and

(5) a check box for “Disable cookies” which prevents the machine from having a ‘cookie’ code from being sent to and added into the local machine ‘cookie’ cache.

The FIG. 9 “Time Outs” 274 sub-window provides four numeric envy lines or boxes to identify certain preferences related to time outs, including:

(1) a numeric entry box for “Consecutive errors top the search” such that if the agent encounters a certain number of network errors the search will be stopped;

(2) a numeric entry box for “Timeout in second for CONNECT”;

(3) a numeric entry box for “Timeout in seconds for RECEIVE”; and

(4) a numeric entry box for “Timeout in seconds for SEND”, which specify the number of seconds that can elapse before the system ‘times out’ for each of the phases of network operation for ‘connecting’, ‘receiving’ and ‘sending’ operations.

The FIG. 9 “Maximum subdirectory depth to search” 276 sub-window provides five radio buttons to select the sub-directory search preferences, including:

(1) “Top only—no subdirectories” which limits the search to only examining the upper most directory; and

(2) “1” which permits search one subdirectory level down; and

(3) “2” which permits search two subdirectory levels down, and “3” which permits search three subdirectories down; and

(4) “All subdirectories (no limit)” which permits unlimited levels of subdirectory search.

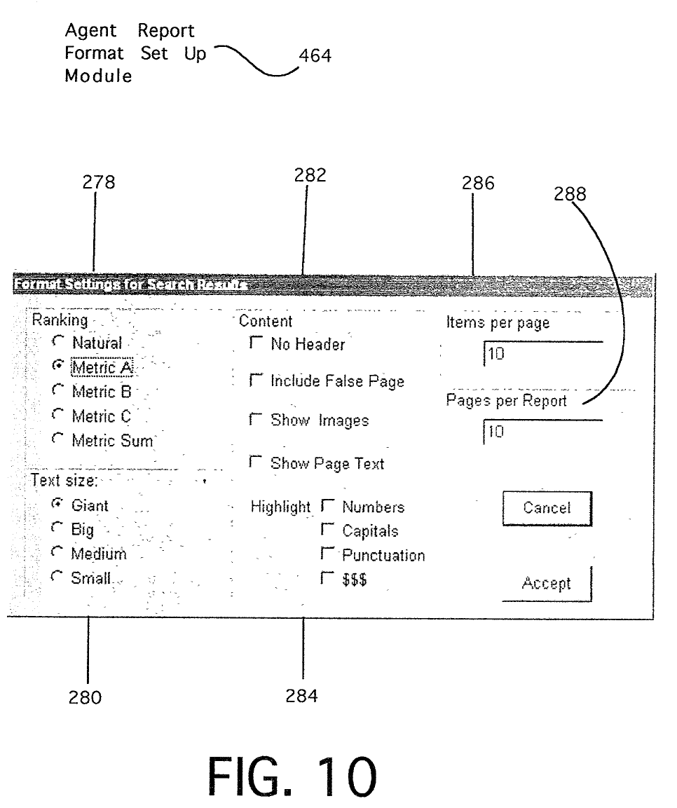

FIG. 10, represented in FIG. 1a as 464, “Format Settings for Search Results” provides controls for setting up the format of the HTML document generation of search and retrieval collection results.

The FIG. 10 “Ranking” 278 sub-window has five radio buttons for ranking the web pages and associated selected data sets collected by the agent, including:

(1) “Natural” radio button which ranks the results in the order in which they were discovered;

(2) “Metric A” radio button which ranks the results in the order of the Metric A counts with higher number of counts ranking higher in the results ‘hits’ ranking list;

(3) “Metric B” radio button which ranks the results in the order of the Metric B counts with higher number of counts ranking higher in the results ‘hits’ ranking list;

(4) “Metric C” radio button which ranks the results in the order of the Metric C counts with higher number of counts ranking higher in the results ‘hits’ ranking list; and

(5) “Metric Sum” button which ranks the results in the order of the sum of all Metric counts together, with total metric sum counts with higher number of counts ranking higher in the results ‘hits’ ranking list.

Additional ranking order options in one preferred embodiment include “Metric A+B”, “Metric A+C”, and “Metric B+C”, and further additional ranking order options include “Boolean Match” which is

The FIG. 10 “Text Size” 280 sub-window has four radio buttons for setting the size of the text layout on the auto-generated HTML page of results, including “Giant”, “Big”, “Medium”, and “Small” text sizing selections.

The FIG. 10 “Content” 282 sub-window has checkboxes for setting content formatting within the auto-generated HTML report. The “No Header” check box when checked eliminates the report header that is normally attached the first page of the HTML report. The “Include False Pages” check box when checked includes Boolean false result pages in addition the normally included Boolean True pages in the auto-generated HMTL results report. The “Show Images” check box when checked will include the collected images associated with the web page document. The “Show Page Text” check box when checked includes the collected text associated with the web page document.

The FIG. 10 “Highlight” 284 sub-window area includes several check boxes to effect bold or underline highlighting to report textual contents, including check boxes for “Numbers”, “Capitals”, “Punctuation” “$$$” and “Search Terms”, which when checked will generate highlights on the selected associated textual characters or words.

The FIG. 10 “items per page” 286 sub-window area has a numeric text entry line box for limiting the total number of collected items per HTML page in the report. The “Pages per Report” 288 sub-window area has a numeric text entry line box limiting the total number of HTML pages to be included in the report.

FIG. 11, represented in FIG. 1a as 424, illustrates the AGENT ACTION window. Section 58 of the agent action window is the AGENT START command settings for agents that are begun by double clicking on an agent icon, or in application to agents automatically started as screensavers.

The check box 60 “Hide”, when checked, commands the system to not show the agent on the desktop, and is effective ONLY for icon or screen saver started agents. Radio button 62 “Open”, when checked, opens the agent in a STOPPED state, and is effective ONLY for icon or screen saver started agents. Check box 64, “New”, when checked, opens the Agent and then STARTs it, and is effective ONLY for icon or screen saver started agents. Radio button 66 “Get URL+NEW”, when checked, opens the Agent, GET an URL from Internet Explorer, and then STARTs it, and is effective ONLY for icon or screen saver started agents. Radio button 68 “Continue”, when checked, opens the Agent and then CONTINUEs it, and is effective ONLY for icon or screen saver started agents.

The next section of FIG. 11 is the ACQUIRE and CAPTURE sub-window, where the user can specify what type and size file will be collected. Check box 70

“Include False Pages”, when checked, captures files from FALSE pages in addition to pages that have tested true in the Boolean search test. Check box 72 “Text”, when checked, enables text capture from an examine HTML document page, and limits the capture to the normally visible text on an HTML document page, excluding source code text not normally visible.

The capture of text can set to a given number of bytes per page, such as 1000 bytes for example. Check box 74 “Capture JPEG Images”, when checked, enable JPEG image capture. If it is not enabled, only links will be gathered according to the maximum number of bytes specified in text line 76.

Check box “capture GIF Images” 77, enable GIF image capture. If it is not enabled, only links will be gathered according to the maximum number of bytes specified in text line 76. Check box 78 “Capture Custom”, when checked, enables CUSTOM file capture.

If it is enabled, only files will be gathered according to the maximum number of bytes specified in text line 76. The operation of the Minimum and Maximum size settings 76 are such that before the server sends the image file the agent running computer, the server is queried to find out what the size of the file is. The size tests are done before the download begins allowing the download to be skipped if the size is out of bounds.

Text entry line 80 is where the user specifies the particular type of file to capture, such as any custom file type desired, for example, entering “pdf” to capture pdf files, or entering “mp3” to capture mp3 audio files. Examples of different file types the system can be arbitrarily specified to capture, include but are not limited to the following file types as any arbitrary file type extension can be included.

The abbreviation “exts”=file type extension. File type descriptions are included below for clarity, however, only the extension characters themselves, such as “cgi”, for example are necessary to be entered into the text line 80.

type=text/common gateway interface exts=cgi

type=application/postscript exts=ai eps ps

type=audio/x-aiff exts=aif aiff aifc

type=audio/Sun audio exts=au

type=text/active server page exts=asp

type=msvideo/active streaming exts=asf

type=Shockwave/Flash file exts=swf

type=Shockwave/MP3 file exts=swa

type=iexplorer/Chan. Def. format exts=cdf

type=text/plain exts=asc txt

type=video/x-msvideo exts=avi

type=image/bmp exts=bmp

type=application/x-director exts=dcr dir dxr

type=application/msword exts=doc

type=application/x-dvi exts=dvi

type=application/Photoshop file exts=psd

type=image/gif exts=gif

type=text/html exts=html htm

type=image/jpeg exts ipeg jpg jpe

type=application/x-javascript exts=js

type=audio/midi exts=mid midi kar

type=video/impeg exts=mpeg mpg mpe

type=audio/mpeg exts=mpga mp2 imp3

type=application/pdf exts=pdf

type=application/vnd.ms-powerpoint exts=ppt

type=video/quicktime exts=qt mov

type=audio/x-realaudio exts=ra

type=audio/x-pn-realaudio exts=ram rm rmm

type=application/rtf exts=rtf

type=text/richtext exts=rtx

type=application/Mac archive exts=sea

type=application/x-stuffit exts=sit

type=application/compression exts=tar

type=image/tiff exts=tiff tif

type=audio/x-wav exts=wav

type=spreadsheet/excel exts=xls

type=text/ exts=xml

type=application/zip exts=zip

The text entry line 82 titled “Max #”, text entry line 82 titled “Max #”, and text entry line 82 titled “Max #”, specify the maximum number of JPEG files to capture, GIF files to capture, or CUSTOM files to capture, respectively. More than one file type extension can be entered into the custom type text entry line 80 to have an agent custom capture multiple types of files at once.

Text line entry 76 titled “Maximum” and text entry line titled “Minimum”, are where the user may specify the Minimum and Maximum size of individual files that will be captured. The preferred embodiment also includes a text line entry to specify the total number of bytes that can be captured before the agent suspends image file, text and other document type collection activity, such as “2,000,000 bytes” or alternatively stated “2 megabtes”, for example.

In addition, the user can specify how much of the available hard disk space on their computer or on their remote storage server can be utilized for capture, as a percentage of available storage space to be used, such as “80%” for example, not shown in the window.

The next section of FIG. 11 agent actions, is the titled “EARLY FINISH TEST” sub-window. The text entry line 84 title “Page Limit” specifies the maximum number of pages the agent is permitted to search. The Radio button 86 titled “All” under the title “Source”, when checked, specifies to only test All pages for Early Finish. The Radio button 88 titled “True” under the title “Source”, when checked, specifies to only test only True pages for Early Finish Test.

The radio buttons A, B and C under the 90 titled “Metric” in the Early Finish Test sub-window, when alternatively checked, specifies:

(1) to use Metric A for Early Finish Test, or

(2) use Metric B for Early Finish Test, or

(3) use Metric C for Early Finish Test, or use Metric SUM for early finish test.

The radio buttons or “>” or “<” under the title 92 “Test” specify if the early Finish Test is Greater-Than dependent, or if the Early Finish Test is Less-Than dependent, and the text entry line 94 is where the user specifies the numeric Value to be tested for Early Finish. In this manner, for example, if the numeric element on a HTML document tests the number ‘1000’, and the “>” radio button is checked, if the agent obtains a number greater than the number ‘1000’, the agent will execute an Early Finish action,

The next section of the FIG. 11 agent actions is the titled “FINISH TEST” sub-window The Radio button 96 titled “All” under the title “Source”, when checked, specifies to only test All pages for Finish. The Radio button 98 titled “True” under the title “Source”, when checked, specifies to only test only True pages for Finish Test. The radio buttons A, B and C under the 100 titled “Metric” in the Finish sub-window, when alternatively checked, specify to use Metric A for Finish Test, or use Metric B for Finish Test, or use Metric C for Finish Test, or to use Metric SUM for Finish Test. The radio buttons or “>” or “<” under the title 102 “Test” specify if the Finish Test is Greater-Than dependent, or if the Finish Test is Less-Than dependent and the text entry line 104 is where the user specifies the numeric Value to be tested for Finishing. The check box 106 titled “Rate”, when checked, tests for RATE OF CHANGE relative to the previous iterated successful TRUE Finish Test.

The next section of FIG. 11 agent actions is the titled RETRY sub-window. Agents which persistently scan and send results and then repeat the actions even if the results are true or false or the Boolean search test in any instance, in order to obtain desired continuously changing data from a given source, such as a stock price for example. The text entry line 110 embedded into the first part of the sentence “If test is FALSE, wait ______ Minutes . . .” specifies if the Finish Test result is FALSE, wait this number of minutes before repeating, and is effective ONLY for icon or screen saver started agents. The text entry line 112 embedded into the last part of the sentence “. . . Minutes and retry ______ times” specifies if Finish Test result is FALSE and this value is non zero, repeat the search this number of times, and is effective ONLY for icon or screen saver started agents.

The bottom section of FIG. 11 agent action window is the FINAL ACTIONS sub-window. There are several check boxes contained here. Check box 114 titled “Bell”, when checked, if the result of the Finish Test is TRUE, rings the bell. Check box 118 titled “Report”, when checked, if the result of the Finish Test is TRUE, open result Report. Check box 120 titled “Alarm”, when checked, if the result of the Finish Test is TRUE, start Alarm bell. Check box 122 titled “E-Mail”, when checked, if the result of the Finish Test is TRUE, the user then clicks on the 124 “E-mail Msg” button, which opens a notification message window, where the user can write an E-mail, including entering address, and subject line.

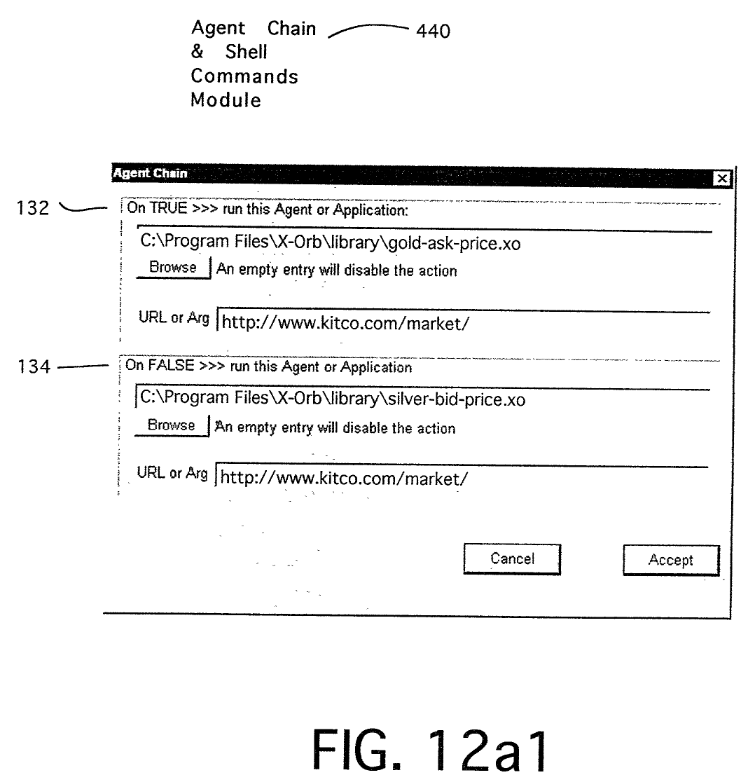

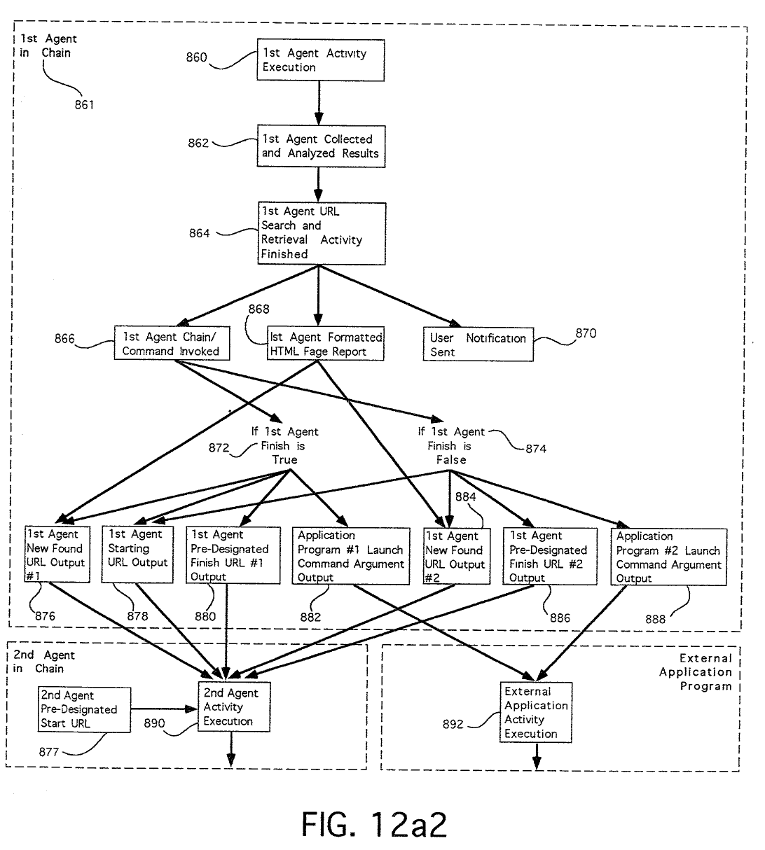

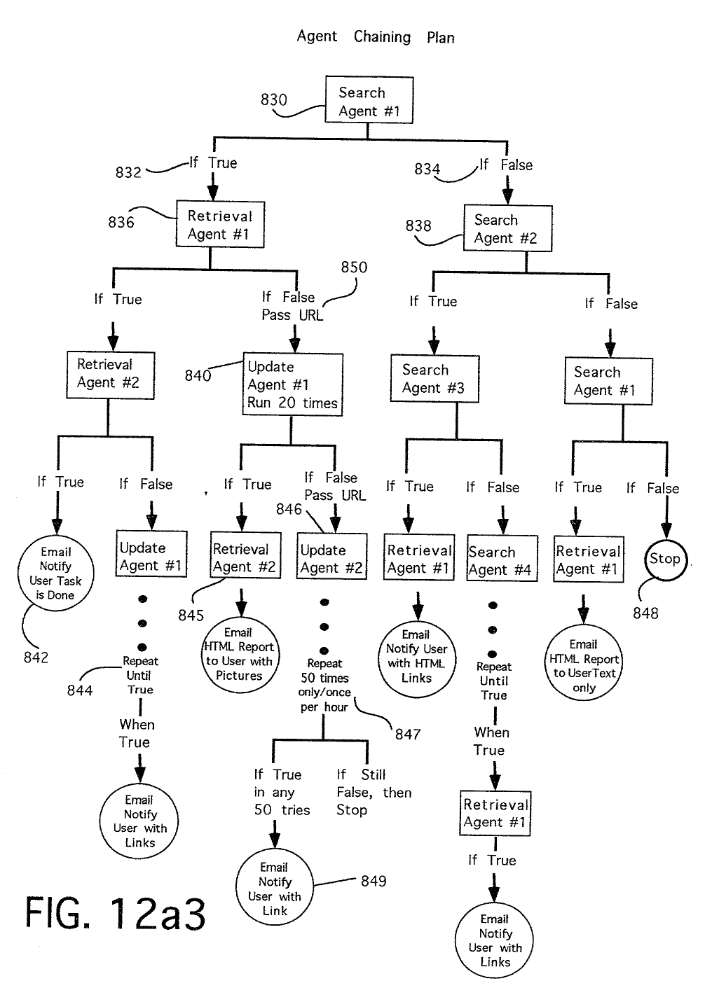

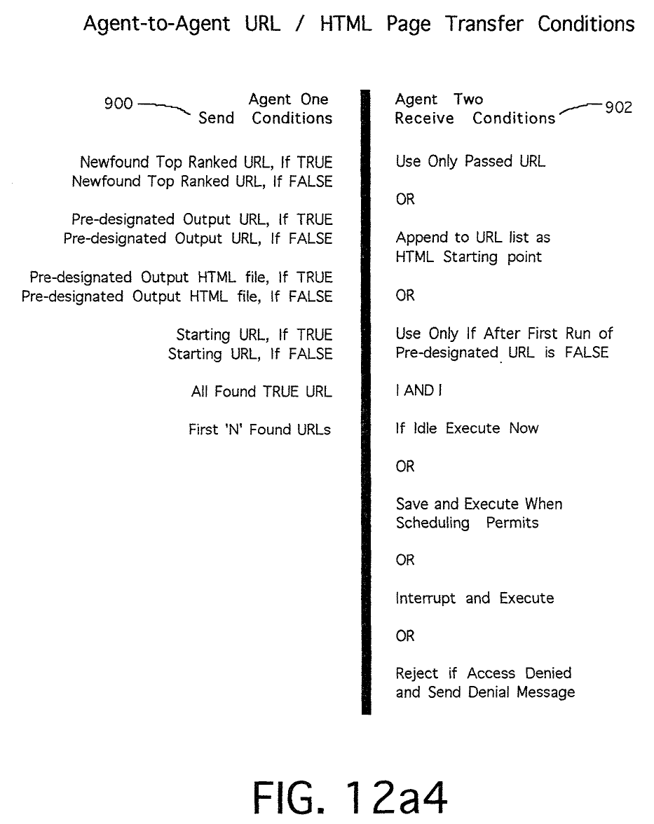

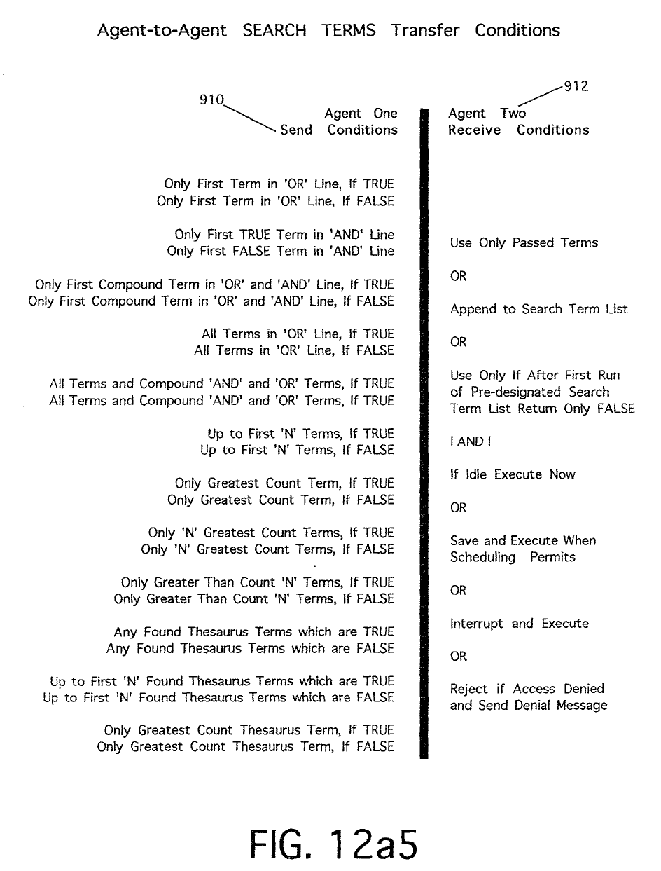

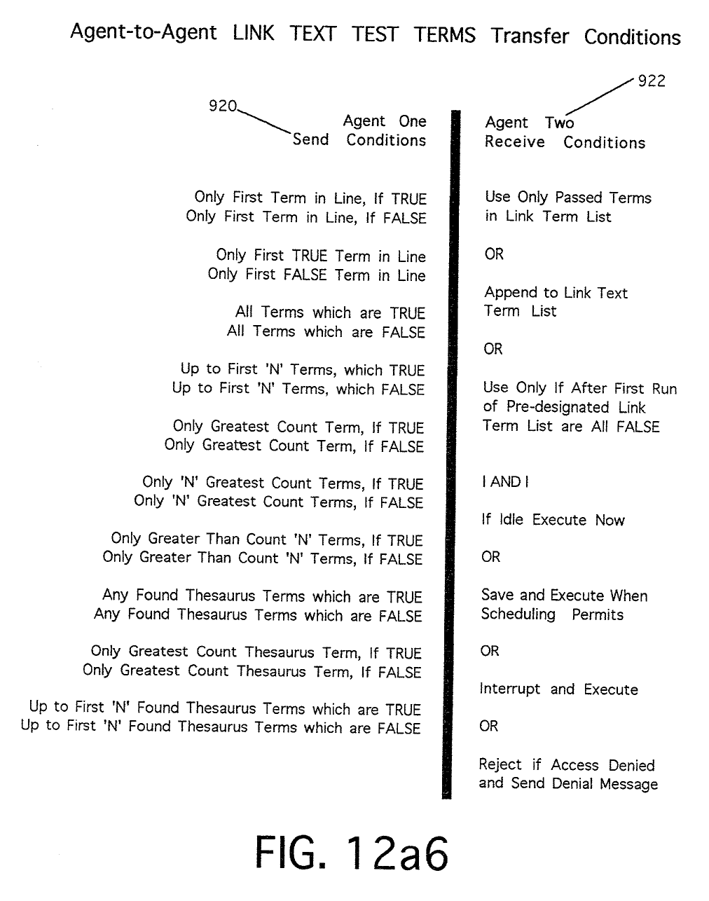

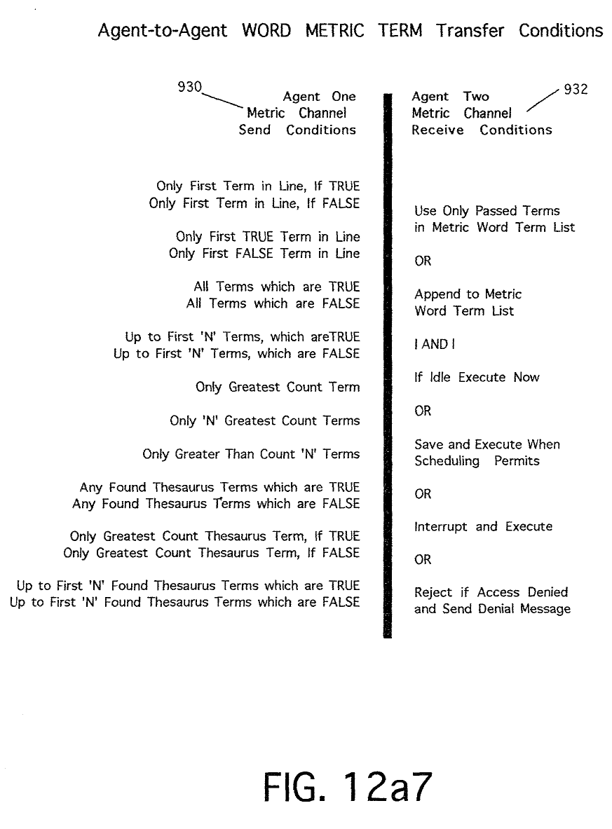

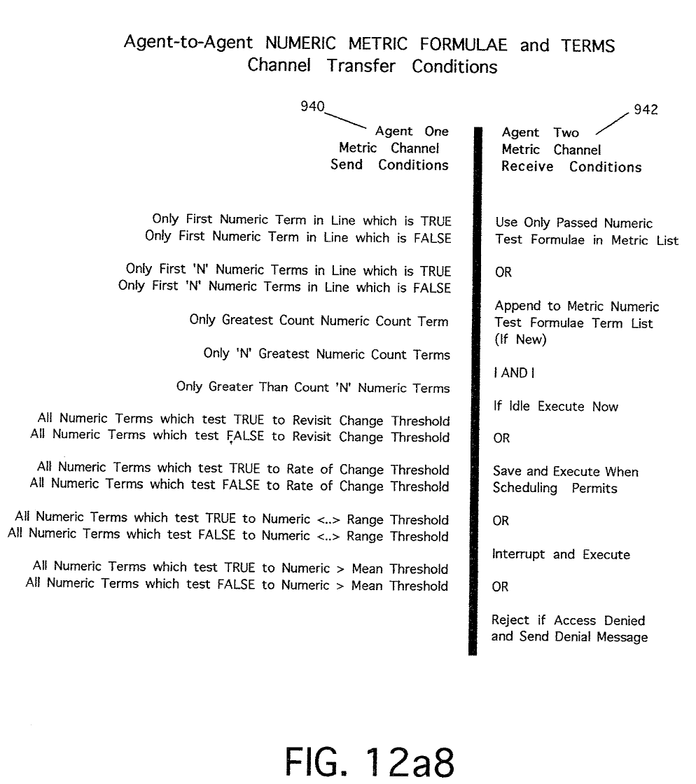

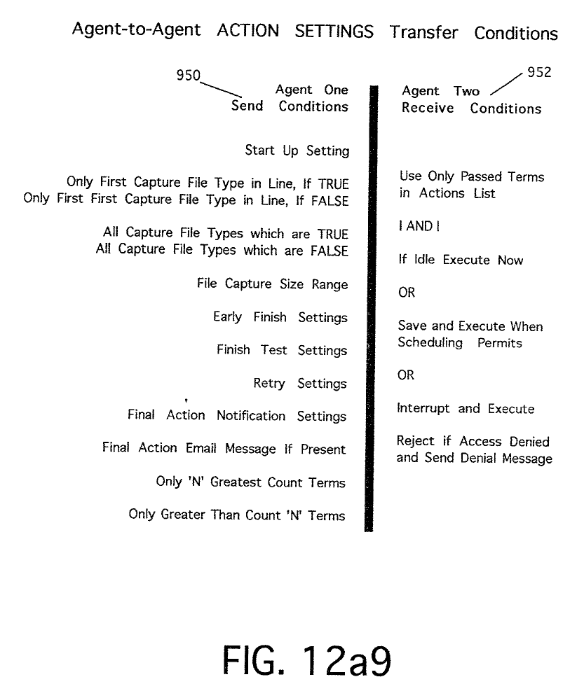

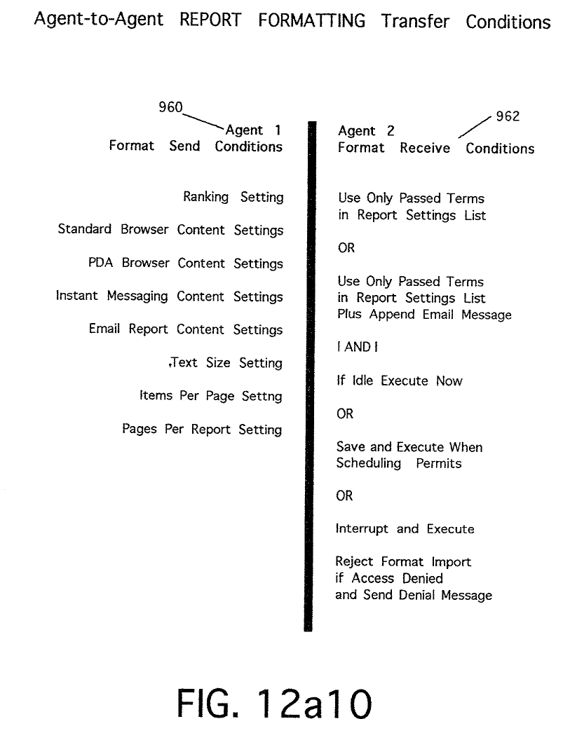

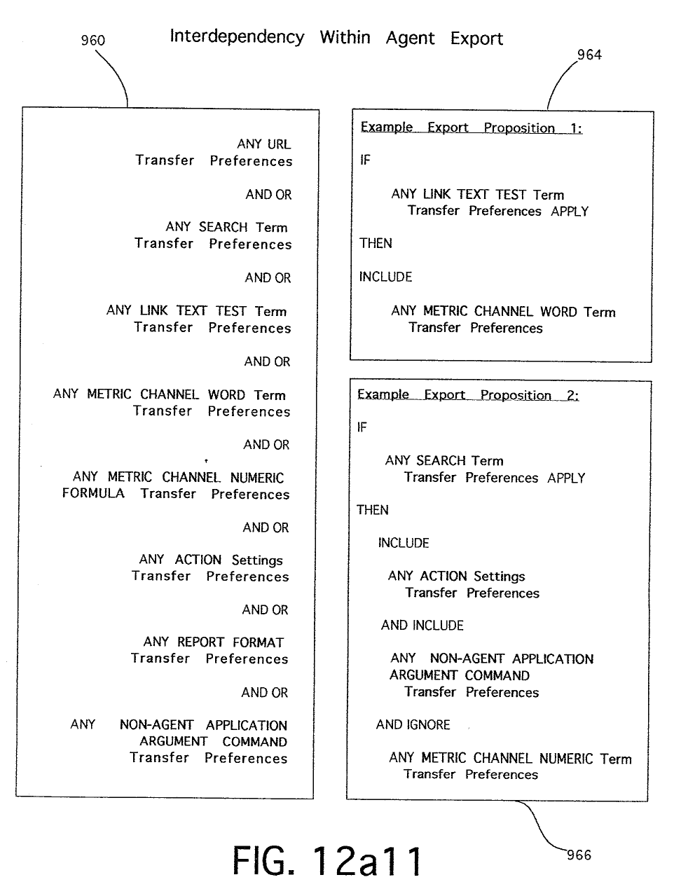

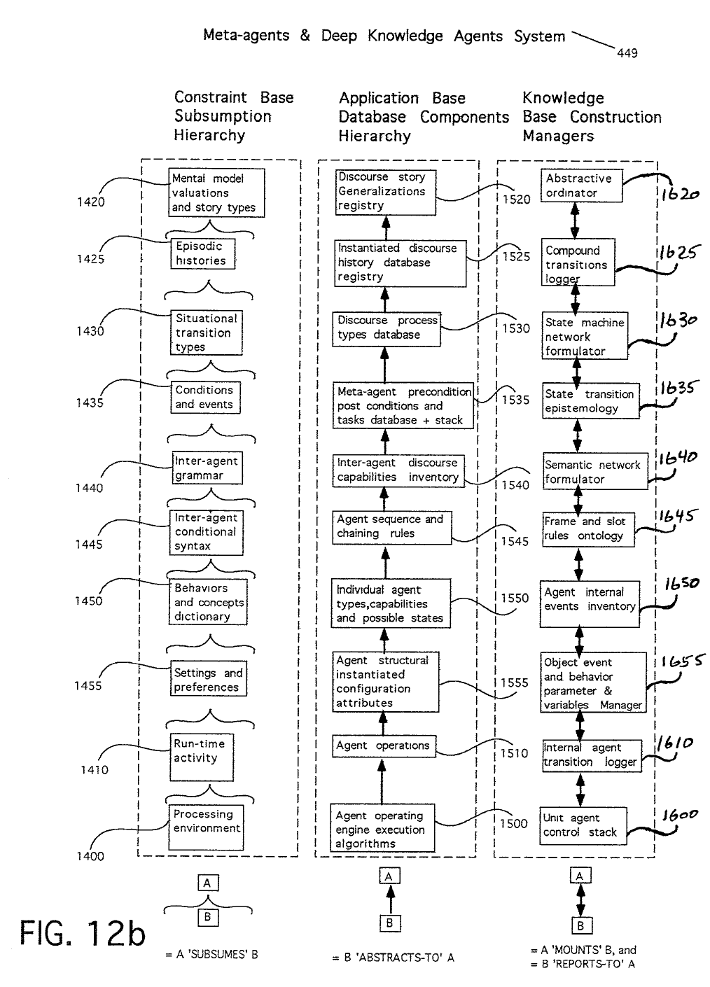

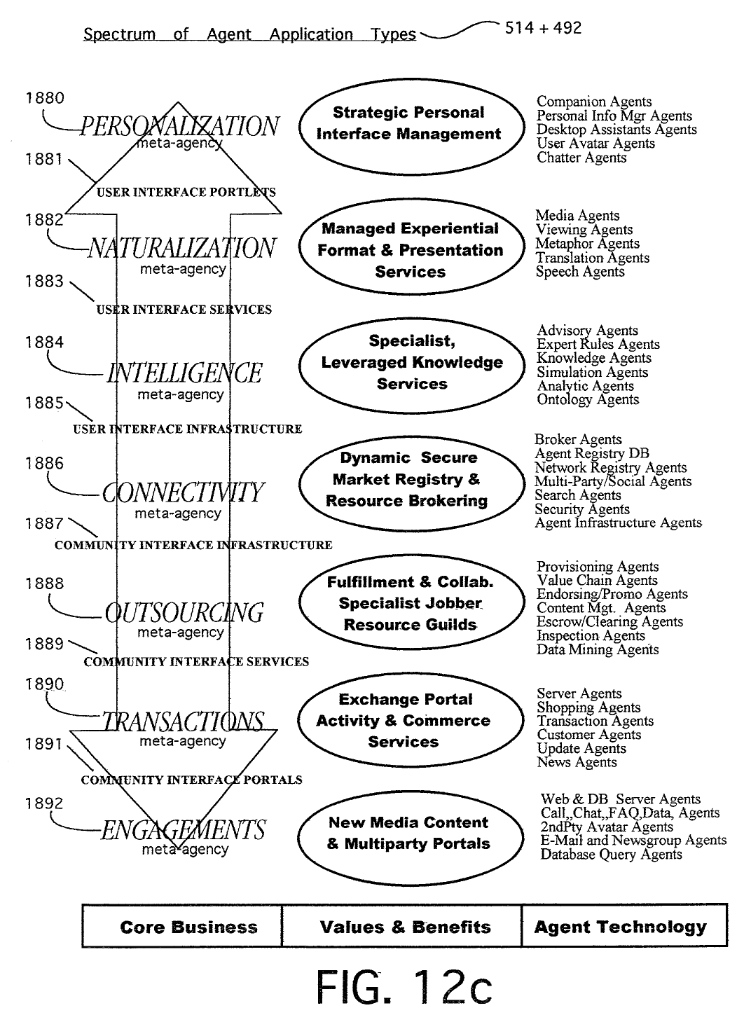

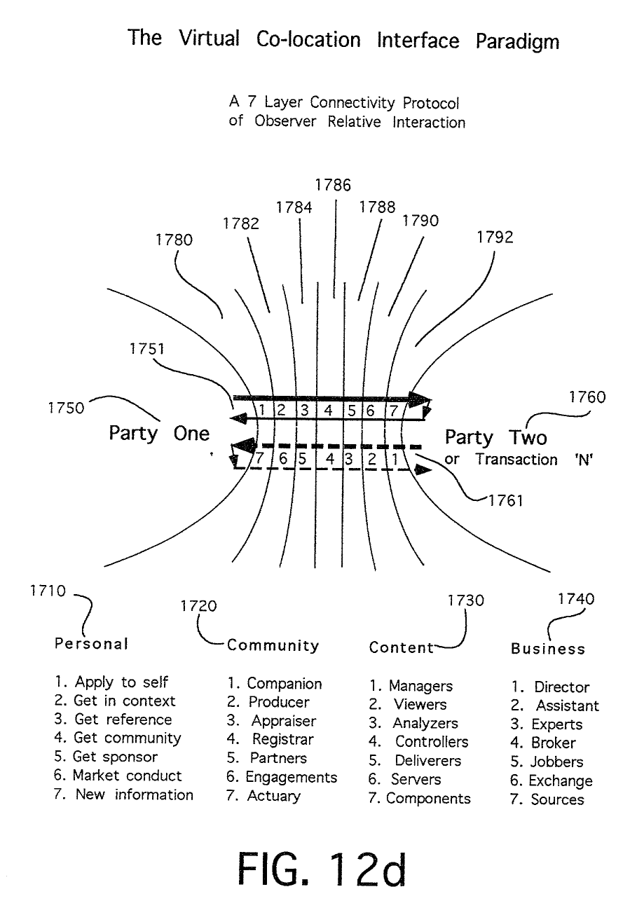

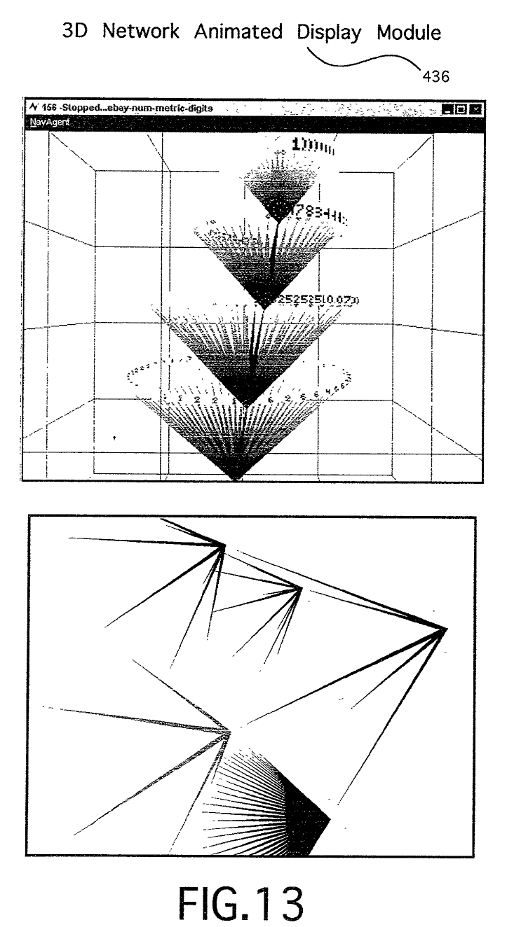

Check box 126 titled “Close”, when checked, closes the Agent on the final Finish, and is effective ONLY for icon or screen saver started agents. Check box 128 titled “Do Final Actions even if it is False”, when checked, if Finish Test result is FALSE on the final finish, the agent will execute the selected FINISH ACTIONS. The FIG. 11 button 130 titled “Chain” opens the FIG. 12 “Agent Chain” or shell execution window.

An advantage of the present invention is the ability to rapidly and automatically update shell application programs and priorities of subsequent agents activity by chaining agents. This autonomous rapid update process using live search over a network of disparately formatted and heterogenous information, provides maximum recency of information to the shell environment applications. This effects better specificity, currency and relevance of information, and provides more reliable, actionable information Further, such information aggregation production can be based on using popularly higher ranked information sources or known higher authority sources.

The chaining and shell application execution permits an additional operational capability at the multi-agent scale. In this manner a plurality of agents can be conditionally chained together in different conditional flow logic structures in order to accomplish more complex tasks and collection operations than a single agent could provide. Such multi-agents and agents chains comprise a proposition inferencing network state machine.

Further, agents may be chained to and embedded into conventional rule and or framed based inference systems. For example, an agent can comprise the execution of business rules that represent key application logic such as rules about conditions associated with the diagnosis and corrective maintenance of a product, or rules associated with an transactional exchange system relating to price, quantity and delivery.

Such rule and frame based systems already common within industry describe and facilitate specification of rules and rule sets to be applied to support decision making and management of information. This information management method can help to configure products, direct and qualify services, perform user proxy negotiation and delegation, and effect workflow value chaining.

Using the chaining function, agents can thereby be subordinated to other agents, and clusters of agents can operate in a compound manner to derive complex propositional activities. Agents are defined as active objects within an environment. Agents, as active objects, or alternatively defined as active atoms, are classed within a plurality of types of agents.

Each agent, as an instantiated type of agent, has associated individual attributes and capabilities. Agents also have starting and finishing states and variables. Agents undergo transitions from one state to another state depending on their interaction with the environment and the behavior engaged. Agents can operate in aggregate, as collections of agents. Agent can be sequenced and associated according to inter-agent rules of interaction and discovered information due to search activity on a network.

An individual agent, when launched, engages in private singular activity without the aid of other agents. An individual agent, upon completion of it's run-time task, then can engage in agent-to-agent interaction and communication in the form of next agent or agents activation chaining. More than one agent can be activated from a prior executed agent.

Agent outcome states can exist as preconditions to the initiation of other agent activity based on the Boolean state of the Agent task execution results. Agent activity start conditions must match the post-condition outcome of prior executed agent activity.

Agent behavior can thereby cause other agents to activate their behavior as a form of forward chaining propagation causality. The forward chaining is data driven from the data set discovered by an agent during search or retrieval task execution on a network. An agent can have conditional restrictions under which it will function. Such conditions are situational settings for agent actuation or inactivity.

The FIG. 12a1, represented in FIG. 1a as 440, “Chain Execute” window provides a means to conditionally chain agents to one another based on the outcome of their search and retrieval activity returning a TRUE or FALSE result. The 132 “On TRUE” text entry line is where the user can specify another agent to commence activity if the results of the prior agent returned a TRUE result. The 134 “On FALSE” text entry line is where the user can specify another agent to commence activity if the results of the prior agent returned a FALSE result.

Both the On TRUE and On FALSE text entry lines can individually specify more than one agent to start, or can specify the computer to launch any application program, or combination thereof of agents, application programs, using a batch file. The “Browse” buttons associated with each On TRUE and On FALSE sub-window areas can be used to capture a file name and path on the users computer that are to be executed.

When an Agent ‘chains’ another agent, it can pass a URL to it. The URL that is passed to it is used as the Starting URL for the new Agent. This is similar to the GET URL command button on the search set up window in FIG. 4 button 1, except it gets it from the preceding Agent instead of the Browser. There are entry lines for adding the URL to the Agent that is being chained. The URL which is passed to the next Agent in the chain can be either a web address or an HTML document located on the local hard disk or in local device memory.

By setting the URL to point at the HTML report for the Agent project that is on the hard disk, a group of URLs that are discovered on the network by one Agent can be passed to another Agent. By limiting the size of the Report in terms of items per page and number of pages, a limited number of URLs can be passed between agents. By using the metric sorting, a limited set of URLs with high ranking value for successfull application production chaining can be passed.

If the Chain feature is being used to launch an application instead of an XORB agent, the text which holds the URL data for an XORB agent is used as the standard command line argument for the application. When an Agent is launched and there is a URL being passed to it, which will only happen when an Agent is launched via the Chain feature, it forces the “AGENT START” action to be set to RUN. This insures that it will execute a NEW search while preventing the Open, Continue, and Get URL+New actions, which prevented actions are inappropriate for a ‘chained’ agent.

This ‘chaining’ setup accommodates the password protected mode of an Agent being used as a screen saver module. It is configured so that any agent that is chained by another Agent that is password protected will inherit the password and the full screen mode. In other words, if the first Agent in the chain is launched as a screen saver module, all subsequent Agents that may be chained to it will also act as screen saver modules.

FIG. 12a2 illustrates the preferred embodiment of agent chaining and external application program launch capability. In this illustration a first agent 861 is chained to a second agent 890, or the first agent 861 launches an external application program 892. The first agent engages in substantial search and retrieval execution activity 860, collects and analyzes results 862 until it is finished 864. Once the first agent is finished with internal tasks 860, 862, and 864, it can, for example, format an HTML report 868. The first agent can also send a user notification 870 to the user.

The first agent can also activate the command line 866 to launch another agent. The first agent can also activate the command line 866 to launch an external application. The first agent chain to a second agent and or to effect an external program launch, can follow different instructions depending on whether the first agent task results were found True or False as a Boolean proposition.

In FIG. 12a2, if the first agent activity returns a True 872 conclusion, or alternatively, if the first agent returns a False 874 conclusion, the first agent can launch a second agent 890.

If a first agent activity returns a True 872 conclusion, or alternatively, if the first agent returns a False 874 conclusion, the first agent can launch an external application program 892.

A first agent can trigger a second agent 890 to execute using a URL starting page 877 if True, which page is predetermined for the second agent independent of the first agent.

A first agent can trigger a second agent 890 to execute using a first agent newly found URL 876 if first agent returns a True result, as discovered during the first agent execution.

A first agent can trigger a second agent 890 to execute using a first agent newly found URL 884 if the first agent returns a False result, as discovered during the first agent execution.

A first agent can trigger a second agent 890 to use the same starting URL 878 that the first agent used, if the first agent returns a True 872 result.

A first agent can trigger a second agent 890 to use the same starting URL 878 that the first agent used, if the first agent returns a False 874 result.

A first agent can trigger a second agent 890 using a URL 880, if the first agent returns a True result, which URL 880 was pre-designated by the first agent before the first agent executed.

A first agent can trigger a second agent using a URL 886, if the first agent returns a False result, which URL 886 was pre-designated by the first agent before the first agent executed.

A first agent can trigger the launch 882 of an external application program 892 if the first agent returns a True result.

A first agent can trigger the launch 882 of an external application program 888 if the first agent returns a False result.

A program application launch can alternatively be a command file that is read in to an already running external application.

A pre-designated URL starting page 880 or 886 can be either resident on the local computer or be resident on remote networked computer.

A first agent can be resident on the same computer as the second agent 890, or alternatively the first and second agent can be located on two computers which are connected over a network.

A first agent 861 can be resident on a server or based on a local computer or based on another computer which is connected over a network.

A second agent 890 can be resident on a server or based on a local computer or based on another computer which is connected over a network.

A program application 892 can be resident on a server or based on a local computer or based on another computer which is connected over a network.

A first agent can generate a new HTML page or use an already extant HTML page that resides on a local computer whose local access address is in the first agent command line 866.

A first agent can generate a new HTML page or use an already extant HTML page that resides on a remote computer whose access URL address is in the first agent command line 866.

The “on True” 872, or “on False” 874 command line arguments 866 for a first agent to trigger a second agent 890 can contain command line arguments for more than one agent to be executed. This follows the particular True or False results conclusion of the first agent, such that the second agent 890 can be a plurality of second agents.

The “on True” 872 or “on False” 874 command line arguments 866 for a first agent to trigger an application program 892 can contain command line arguments for more than application program to be executed. This follows the particular True or False results conclusion of the first agent, such that the second agent 890 can be a plurality of application programs.

An “on True” 872 command line argument can contain means to execute both a second agent and an application program, or a plurality of second agents and application programs.

An “on False” 874 command line argument can contain means to execute both a second agent and an application program, or a plurality of second agents and application programs.

The first agent can provide a single URL on a networked computer for the second agent to use as its starting point.

The first agent can provide a starting URL or local HTML page with multiple URLs to the second agent to use as its starting point.

The second agent can be independently provisioned with a URL or a local HTML page containing multiple URLs in a list, where the first agent only triggers its execution but does not provide any URL starting page information

When a first agent triggers a second agent, the first agent designated search terms can be passed to the second agent.

When a first agent triggers a second agent, the same means described for selecting, passing or outputting a URL can apply as means to also select, pass or output designated Search terms from a first agent to be used by the second agent.

When a first agent triggers a second agent, the same means described for selecting, passing or outputting a URL can apply as means to select, pass or output designated Metric Channel terms from a first agent to be used by the second agent.

FIG. 12a3 illustrates an example multi-agent chaining schema for a particular application. In this schema the representation of FIG. 12a2 first agent 861 or second agent 890, can be any two vertically connected adjacent agents in FIG. 12a3. FIG. 12a3 Search agent 830 is the starting agent for this example agent chaining schema, and as such equivalent to the first agent 861 in FIG. 12a2. Retrieval agent 836 and Search agent 838 are both second agents, and as such either are equivalent to the second agent 890 in FIG. 12a2.

In subsequent stages of agent activation and execution, the second agents are equivalent a first agent 861 in FIG. 12a2, and the next chained agent subsequently are equivalent to a second agent 890 in FIG. 12a2. As such, FIG. 12a2 is a basic schematic of first and second agent interaction, and FIG. 12a3 illustrates successive chaining of more agents, where the relationship between any two chained agents follow the same basic state transition rules between first and second agent as are identified in FIG. 12a2. In FIG. 12a3 agents are identified according to their functional focus in the schema, such as 836 Retrieval Agent #1, or as 840 Update Agent #1, or as 830 Search Agent #1, for example. This example agent chaining illustrates a possible schema configuration of agent chaining, with different agents triggered for execution by the prior agent returning a True or False results conclusion.

In FIG. 12a3, following an example possible agent chaining route, the 830 Search Agent #1 executes and returns an 832 True results conclusion, which triggers the execution of 836 Retrieval Agent #1. Following the execution of 836 Retrieval Agent #1 a 850 False return is returned with instruction to 850 Pass URL from 836 Retrieval Agent #1 to 840 Update Agent #1, which executes its run time activity cycle up to 20 times.

After 840 Update Agent #1 runs 20 times and has not returned a True result, and a False result is returned which triggers 846 Update Agent #2 to execute. If 840 Update Agent #1 executed less than 20 times and had returned a True result, then 845 Retrieval Agent #2 would have executed. Following 846 Update Agent #2 being executed following 840 Update Agent #1 returning a False result after twenty attempts, 846 Update Agent #2 repeats its execution 847 fifty times once per hour. If in any of the hourly 847 repetition executions 846 Update Agent #2 returns a True result, a user is sent an email 849. In this agent chaining routing example out of the other possible agent chaining paths possible, the various agents involved could have been applied as follows:

830 Search Agent #1—searches for the presence of a particular rare book on a popular on line rare books for sale aggregator portal. The search proves futile at that time, so a False is returned.

836 Retrieval Agent #1—goes to an alternate web site to retrieve an selection of rare book listings by the same author, including prices associated with the books offered for sale. As no example of the desired books in the retrieved list meet the desired price range, a False is returned.

840 Update Agent #1—takes a URL passed to it and commences execution to track the URL designated page that will repetitively monitor the web page up to twenty times on a once per day basis for example. After twenty days of monitoring the web site page, and the book has not become available within the desired price range, the twentieth returned False result triggers the next agent to be given the same URL.

846 Update Agent #2—monitors the same site URL as the previous agent looking for the same book, repeats looking at the site once an hour for fifty hours 847 to see if an update occurs. If within less than fifty hours the agent finds an update mentioning the desired rare book within the desire price range, which returns a True result, and email notifies 849 the user with a link for the user to click on to visit the site for additional details.

This possible sequence is described for general explanation purposes on how a sequence of agents chaining to one another over time can produce a desired outcome. Using a plurality of agents in sequence can accomplish taks more complex than a single agent can accomplish, and provide a schema for a decision tree network of agents for adapting to a variety of different conditions in the open environment.

For example, a plurality of agents with the same functional configuration except for the URL starting point can be used to distribute a search and retrieval task, employing many agents to do the same activity in a plurality of network domain locations. Conversely, a plurality of differently configured agents can distribute the work of accomplishing a complex task in a single network location.

The value in the present invention of limiting individual agent capabilities and opting for an architecture of chaining employing a plurality of agents, or independently employing a plurality of agents, to accomplish complex tasks for a user over a network, include:

(1) a more simplified individual agent architecture,

(2) easier individual agent maintenance,

(3) easier complex task reconfiguration,

(4) agent function modularity,

(5) increased range of agent utility for compound agent applications, and

(5) easier user configuration of individual agents for tasking.

Further, an important advantage to using such a modular agent architecture is easier and simpler debugging, increased error free operation, and easier methods usable for providing non-programmers the opportunity to construct agents to accomplish common tasks.

Further, each individual agent used in a complex compound or multi-agent schema, has the full range of application configuration as any other individual agent, providing a more uniform planning and configuration approach to be applied in constructing agents.

Each agent within a plurality of agents can be configured to accomplished a different type of application task, with all agents still retaining the same underlying core architecture. This permits a singular methodology to be used in agent application construction.

Each agent is capable of being constructed for different purposes using the same core architecture permitted range of configurable functionality. The range of purposes or applications of an individual agent encompasses a wide full range of possible functionality. Each agent is however limited to certain level of complexity of functionality. Once an agent has been configured for a particular functional utility, it cannot also be configured for another particular focus of functionality.

It is simpler to configure another agent, using the same core architecture, to accomplish an alternative functional application purpose. Individual agents are configured to be specialized for different functions and different types of functions, all using a common core architecture.

The division of more complex or divergent types of functionality into multiple agents permits easier configuration and maintenance of the individual simpler functions and easier configuration and maintenance of more complex functions. Single agents thereby serve to accomplish individual a specialized functional purpose. Collections of agents working together thereby serve to accomplish more specialized or generalized complex multi-functional purposes.

In the present invention, agents and integrated collections of agents have been designed to operate individually or in concert over a network. Further, agents and integrated collections of agents have been designed to provide information management functions specific to networks and communication protocols of various types of networks.

In the preferred embodiment of the present invention, agents are focused to accomplish a range of tasks related along a spectrum of information utility production. The range of tasks involved include (1) information access, (2) information discovery, (3) information monitoring, (4) information retrieval, (5) information analysis, (6) information transactions, (7) information notification and (8) information presentation and reporting.

A single agent can effect a useful degree of all of these tasks in a singular agent configuration, without requiring more than one agent to be employed to accomplish a degree of all of these network related information management tasks. The elegance of this approach is that a single agent can provide comprehensive functionality to meet a wide range of user interests and needs.

A single agent provides a bedrock foundation of integrated information management capability for a user. Multiple agents, when connected together to operate in concert or in sequence, provide an increasingly powerful capability to manage a more complex range of task processes and applications in an adaptive manner.

An appropriate analogy for understanding the architectural approach to creating agents in the present invention is cell specialization in biology. An individual agent engine and interface paths which have not been configured with instructions to specialize its function are like embryonic stem cells. A stem cell contains the potential to become any types of specialized cell, such as a liver cell, a brain cell, a bone cell, or a muscle cell, for example.

Once a stem cell, in this analogy for an agent, receives particular instructions that cause it to specialize its function, it cannot be specialized to become another type of cell, unless it were possible to revert back to the state before it received instructions to specialize. Similarly, agents in the present invention can be specialized to perform a wide range of different possible functions.

Assuming the agent function has value to the user, which user by analogy is the integrative whole of the organism, there is no reason to change the specialization of the cell. It is useful to create entire collections of similarly specialized agents, or specialized agent cells using the analogy, in order to provide sufficient capability to address all aspects of a given type of task. Thus, in the present invention, while the basic configuration of an Update agent will classify it as an Update agent relative to the larger collection of divergently purposed agents,

To use the biological analogy further, the basic set of potential functionality available to a cell is the DNA within the cell. In the present invention, the basic core architecture of an agent which permits it to accomplish a range of different functions as a single agent, including the capability for information access, discovery monitoring, retrieval, analysis, transactions, notification, presentation and reporting, is by analogy the DNA of the agent. The RNA instructions interact with the genotype of a cell to specialize a cell to express as a particular phenotype.

By analogy, the agent cells are specialized by the configuration instructions it receives from the user. Alternatively from the user, agents can receive instructions from other agents specialized to be “meta-agents” in the case of using agents to provide all the instructions necessary to other agents for specialization and conditions of execution.

Leaving the biological analogy, agents are instructed to become divergent specialized in their singular agent configuration and functionality. Agents in the present invention operate deterministically within an open system environment of unknown or partially known information and specialty information features.

A single agent can be sufficient for accomplishing a great many application functions for users. When more complex application functions are required, individual agents can be connected together to support more adaptability, more specialization, more robust operations, more

The present invention provides an adjunct set of agent program communication adapters to permit agents to communicate with agents not within the current architecture. As such, one embodiment of the present invention provides for passing information through common agent communication interface protocols, including developing standards for “Agent Communications Languages” that are anticipated to be adopted by industry over time.

The present preferred embodiment of the invention is implemented in C and C++ computer language. Other embodiments of the functional architecture in other computer language implementations, include but are not limited to: Java, Enterprise Java Beans (EJBs), Smalltalk, Unix, BSD Unix, Perl, Perl Script, Visual Basic, Corba, Jini and Ada. These different embodiments permit the system to operate in server side application environments, mainframe application environments, wireless application environments, certain enterprise environments, certain military environments, and other environments.

Further, the present preferred embodiment of the invention is implemented in the Microsoft Windows Operating System (OS) platform environment. Other embodiments of the functional architecture designed to operate on other computer OS platforms, include but are not limited to: various forms of Microsoft .Net, Linux OS, Apple Macintosh OS, including system 8.6 or OSX, for example.

Further, the present invention preferred embodiment is implemented to parse HTML, CGI script, DHTML and Javascript served over the World Wide Web. Other embodiments of the functional architecture designed to read and interact with other types internet and network served interfaces, include but are not limited to: internet secure socket connection languages, XML database, and Java applets for example.

Further, the present invention preferred embodiment is implemented for network and information visualization and user network and information navigation, using various version of the Silicon Graphics, Inc., licensed standard OpenGL 3D graphics engine, as it exists resident on current Linux, Microsoft and Apple computers.

Other embodiments of the functional architecture for 3D and 2D information visualization and navigation, include but are not limited to:

(1) Java based 3D graphics engines,

(2) VRML (Virtual Reality Mark-up Language) 3-D standards,

(3) Microsoft Xbox graphics engine,

(4) Sony Playstation graphics engine,

(5) Nintendo video game console graphics engines, and

(6) other embodiment graphics which may enter popular use.

The World Wide Web contains immense information resources, which are constantly increasing and changing, and information agents are an ideal means to assist the information management challenge.

However, the description of the preferred embodiment of the invention is not intended to limit its application to World Wide Web information management for users. Other application embodiments of the modular agent architecture approach of the present invention include accomplishing the same range of tasks on other types of networks or information file systems.

The present invention is intended to read and interact with any type of file system. Such information networks include other embodiments of the internet, email newsgroups, intranets, extranets, virtual private networks, wireless networks, local area proprietary networks and wide area proprietary networks.

Further, other application embodiments of the modular agent architecture approach of the present invention include accomplishing the same range of tasks on and within networked information storage systems, non-networked local information storage systems, such as hard drives, local databases, and other types of information repositories.

In order to enable the greatest flexibility of inter-agent conditional interaction and connectivity, a general set of conditional information transfer functions between agents is provided. In FIG. 12a1, and FIG. 12a2, and FIG. 12a3, were described the interaction and transfer of information between agents, and the triggering or chaining of agent activities limited to passing of different forms of URLs.

The transfer of URLs between agents is fundamental as the agent architecture of the preferred embodiment of invention is focused on information documents available over the World Wide Web, which has standardized the URL (Universal Resource Locator) address as the means for identifying and accessing information on the web network. Agents in the preferred embodiment always have a starting point URL or HTML page which contains URLs.

The preferred embodiment contains provisions for conditionally transferring URLs and a range of other information as agent task related parameters and variables between agents.

FIGS. 12a4, 12a5, 12a6, 12a7, 12a8, 12a9, and 12a10 all identify different conditional forward chaining rules that can be used to export agent configuration or results data another agent using the chain/shell command function. Further, FIG. 12a11 identifies how conditional forward chaining rules can be interdependent of other chaining rules.

FIG. 12a11 show such rules, such for example 964 and 966, when triggered, can cause the agent to ignore other chaining rules for the agent. Alternatively it can cause the agent include other rules to be exported to the next agent in the chain, although such rules were not explicitly triggered by any agent activity Boolean evaluation that would have triggered the individual rule to be exported to another agent.

In FIG. 12a11, each of the different types of agent data 960 and configuration information associated with an agent have their own specific possible forward chaining conditions. Further, simple or complex production rules associated different types of an agent's data or configuration such as 964 or 966 for example can be used.

The user specifies the forward chaining rules relating to export of different data or configuration instructions. The user specified the forward chaining rules relating to import of different data or configuration instructions.

The plurality of different forward chaining rules associated with each aspect of an agent's configuration details and instructions as identified in FIGS. 12a4, 12a5, 12a6, 12a7, 12a8, 12a9, and 12a10 are for example only, and are not necessarily an exhaustive itemization of possible associated rules. However, these rules represent the available compliment of possible chaining rule types within the preferred embodiment of the present invention.

FIGS. 12a4, 12a5, 12a6, 12a7, 12a8, 12a9, and 12a10 all identify a sending and receiving agent. The left column for FIGS. 12a4, 12a5, 12a6, 12a7, 12a8, 12a9, and 12a10 show the possible information export transfer or sending agent rules. The right column of the same FIGURES shows the possible information import transfer or receiving agent rules.

FIG. 12a4 shows Agent One Send Condition rules 900 and Agent Two Receive Condition rules 902 for Agent-to-Agent URL address or HTML page Transfer.

FIG. 12a5 shows Agent One Send Condition rules 910 and Agent Two Receive Condition rules 912 for Agent-to-Agent SEARCH TERMS Transfer.

FIG. 12a6 shows Agent One Send Condition rules 920 and Agent Two Receive Condition rules 922 for Agent-to-Agent LINK TEXT TEST TERMS Transfer.

FIG. 12a7 shows Agent One Send Condition rules 930 and Agent Two Receive Condition rules 932 for Agent-to-Agent METRIC CHANNEL WORD TERMS Transfer.

FIG. 12a8 shows Agent One Send Condition rules 940 and Agent Two Receive Condition rules 942 for Agent-to-Agent NUMRIC METRIC FORMULA and TERMS Transfer.

FIG. 12a9 shows Agent One Send Condition rules 950 and Agent Two Receive Condition rules 952 for Agent-to-Agent ACTION SETTINGS Transfer.

FIG. 12a10 shows Agent One Send Condition rules 960 and Agent Two Receive Condition rules 962 for Agent-to-Agent REPORT FORMATTING Transfer.

For each of the information transfer functions available, the user is provided with a multiple choice check box window to activate agent send and agent receive conditional rules. This selection window pop-ups for each applicable display window by:

(1) pressing the ‘F1’ function key while that particular control window is open, or

(2) clicking on a graphical button labeled “C” located in the particular control window, or

(3) clicking on a graphical button labeled “C” located on the Chain/Shell set up window, which opens a selector wndow containing each of the control window types, and when a particular control type, such as REPORT FORMAT for example is clicked, opens the conditional send and receive rules selector for that agent control component.

The shell application or alternatively, the agent chaining execution component of the system of the present invention provides a means to effect a goal directed, data driven forward chaining inference of conditional propositions between multiple agents. Propositions are tested by the internal action and results of individual search agents, based on interaction with the network as the agent instructed to do. Agent execution behavior is specified, however what the agent encounters is not necessarily known in advance.

Individual agents also, within themselves, based on their search term and metric term and starting point conditions, also goal directed, data driven, forward chaining inference engines. These agents test the propositions set within them and passed to them as regards to Boolean search terms tests, data set collection, metric counts, evaluation tests, and other agent actions.

Between different chaining and execution shell applications, embedded search and retrieval agents information mapping agents can be used to execute the forward chaining testing of Boolean or Fuzzy logic propositions.

This provisions an atomic level of executing the testing of propositions by an agent and chaining of propositions between agents, where each atom is an agent activity, and multiple atoms are multiple agent activity. The chaining and shell execution methods can remain common between different disparate shell applications that utilize the same agent rule testing processes and interchange.

Further, the present invention preferred embodiment is implemented to use Boolean True and False and Not logic to determine conditions for obtaining desired results and interactions and information transfer between agents.

Other embodiments of the functional architecture are designed to accommodate additional and alternative logic to determine conditions for obtaining desired results and interactions and information transfer between agents, and include but are not limited to:

(1) temporal logic,

(2) Fuzzy logic,

(3) discrete non-Boolean logic,

(4) Bayesian probability assignments,

(5) neural networks, and software genetic algorithms, for example.

One embodiment of the present invention uses a discrete non-Boolean logic which can have seven states of logical tested value, including the logical state values of:

True, False, Maybe True, Maybe False, Deferred, Unknown, Don't-Care.

In addition the logic inversion Not can be applied to any of these seven This logic provides means to use a discrete number of logic states that include a minimal but useful degree of qualitative logical uncertainty handling and relevance handling in addition to standard Boolean logic.

To further illustrate the range of this discrete non-Boolean state logic embodiment, the following list provides additional comparable description of the logic state values as used in different type contexts (A, B, C, D and E) of application definition, where:

‘A’ type descriptions correspond to a usage context of “personal evaluation”,

‘B’ type descriptions correspond to a usage context of “semantic connective ontology”,

‘C’ type descriptions correspond to a usage context of “action commitment”,

‘D’ type descriptions correspond to a usage context of “inter-party engagement”, and

‘E’ type descriptions correspond to a usage context of “definitive declaration”,

‘F’ type descriptions correspond to a usage context of “prospective consideration,

‘G’ type descriptions correspond to a usage context of “legal evidence”,

‘H’ type descriptions correspond to a usage context of “temporal stance of determination”,

‘I’ type descriptions correspond to a usage context of “qualitative assignment”:

TRUE (T), logical evaluation equivalent to:

A—Yes,

B—Is,

C—Commit,

D—Accept,

E—Definite_yes

F—Will_consider,

G—Incontrovertible_evidence

H—Present_positive,

I—Absolute_Positive_assignment

FALSE (F), logical evaluation equivalent to:

A—No,

B—Is_Not,

C—No-commit,

D—Deny,

E—Definite_no

F—Won't_consider,

G—Incontrovertible_alibi

H—Present_negative,

I—Absolute_negative_assignment

PROBABLE-TRUE (PT), logical evaluation equivalent to:

A—Maybe,

B—Likely,

C—Offer/ask_Commit,

D—Conditioned_acceptance,

E—Indefinite_yes

F—May_Consider,

G—Incriminating_evidence

H—Future positive,

I—Relative_positive_assignment

PROBABLE-FALSE (PF), logical evaluation equivalent to:

A—Maybe-Not,

B—Unlikely,

C—Offer/ask_No_commit,

D—Conditional_denial,

E—Indefinite_no

F—May_not_consider,

G—Exonerating_evidence

H—Future_negative,

I—Relative_negative_assignment

DEFERRED (DF), logical evaluation equivalent to:

A—Later.

B—Not-now,

C—Commit_later,

D—Reschedule,

E—Currently_Indefinite

F—Consider_later,

G—Suspended_investigation

H—Future_unknown,

I—Future_temporal_assigment

UNKNOWN (UN), logical evaluation equivalent to:

A—Don't-know,

B—Indeterminate,

C—Non-commital,

D—No-response,

E—Undefined

F—Unable_to_consider.

G—No_evidence

H—Present_unknown

I—Uncertain_assignment

DON'T-CARE (DC), logical evaluation equivalent to:

A—Irrelevant,

B—Ignore,

C—Skip_commit,

D—Bypass,

E—Definitely_Pass

F—Never consider,

G—Dismissed_evidence

H—Present_known

I—Irrelevance_assignment

[UNTESTED (OO) ] is Un-Evaluated State.

The application of this above seven state logic in expert systems based inferential reasoning and judgement is different depending on whether the multiple terms evaluation is (1) an “OR gate” or (2) an “AND gate” type relationship. This permits the logic to conclude a single logical value for a collection of terms with different values:

(1) For “OR gate” node or term collections, the logic state precedence in positive logic valuation preference, for the seven states and the untested state are as follows:

T>PT>PF>F>DF>UN>DC.

For example, if one term in an ‘OR’ proposition is tested to be DON'T-CARE and another term is tested to be FALSE, the result returned is a FALSE conclusion.

As another example, if one term in an ‘OR’ proposition is tested to be PROBABLE-FALSE and another term is tested to be PROBABLE-TRUE, the result returned is a PROBABLE-TRUE conclusion.

As a third example, if one term in an ‘OR’ proposition is tested to be DEFER and another term is tested to be DON'T-CARE, the result returned is a DEFERRED conclusion.

(2) For “AND gate” node or term collections, the logic state precedence in positive logic valuation preference, for the seven states and the untested state are as follows:

DC>UN>DF>F>PF>PT>T

For example, if one term in an ‘AND’ proposition is tested to be DON'T-CARE and another term is tested to be TRUE, the result returned is DON'T-CARE conclusion.

As another example, if one term in an ‘AND’ proposition is tested to be PROBABLE_TRUE and another term is tested to be FALSE, the result returned is a FALSE logical conclusion.

As a third example, if one term in an ‘AND’ proposition is tested to be UNKNOWN and another term is tested to be DEFERRED, the result returned is a DEFER logical conclusion.

While the order of preference for logical evaluation in the above truth preference order may be counter-intuitive, it proves quite effective for qualitative logical evaluation a great many applications where terms or nodes are connected as logical ‘AND’, or as logical ‘OR’.

Further, when combining complex propositions containing both logical ‘AND’ and logical ‘OR’ terms, such as in search engine applications, the order of logical evaluation precedence follows the same conventions as does standard Boolean AND plus OR term evaluation. For example in the expression “term N1 AND (terms N2 OR N3)”, the evaluation is distributed, where the equivalent expression is ((N1 AND N29) OR (N1 AND N3)). The discrete extended, or non-Boolean logic described above follows the same expression distribution conventions.

Each agent operates its own private behaviors which form an individual agent operating history. Agents can have multiple operating histories, which can be aggregated, stored and pattern matched relative to one another. Pattern matches between agent histories assigns a conformity to deviation measure, as a weighted match function. Multiple run time histories weighted as more similar to one another can be generalized. History generalizations generate probability weightings that can be assigned to agents relative to the operational environment. History sequences and conditional outcomes can therefore be predicted as a result of the built up database of situational and sequential histories, with associated probabilities of occurrence. An agent situational, historical and sequential database becomes a pattern match weight, and can index different probabilities of behavior against expected environmental circumstances. Expected behavioral patterns are stored as conformal and deformal patterns of activity and state transition sequences. In most agent plural history pattern match databases, a given agent will have a distribution of plural histories, forming a bell curve of more common histories in the middle of the bell curve of sample histories.

When an agent is operating privately during agent task execution, it compares it's current operating run time activity to the stored instances and generalizations of prior run-time activities. Matches and deviations from the plural history database either reinforce or modify the stored database of agent historical patterns of behavior and performance. A weighted database of recorded histories forms the basis for a primitive mental model of the agent in relationship to its environment. The mental model contains a range of different histories, with associative matching. More common points of sequence in a history increases the history pattern match between histories. A population of histories comprises common and uncommon sequences. An agent episode of task execution activity becomes a sampled history, which history is matched, compared, assigned a mean deviation from the most common history, and classified under the built up database of histories. The temporal process of agent behavior becomes part of the pattern match information that can alter current agent run time behavioral activity. This alteration of behavior instantiates as a mental model of belief and anticipated consequences of agent engagement. Developed beliefs can be used to modify or alter the state transition rules of an agents run time activity. If, for example, a prior run time task execution activity of an agent repeatedly finds a dead link, as a missing HTML page on the network, that page address can be discarded from the task execution stack in future agent task run time executions. This can occur even though future executions of other HTML pages may still provide a link to the missing HTML page which the agent would have followed.

When an agent is operating interactively with other agents, a meta-agent is used to compares multiple agent chaining and interactivity. Multiple agents comprise a compound agent. A compound agent instantiates a meta-agent to build a mental model of the compound agent current operating run time activities. The meta-agent records and stores the aggregate histories of agent interactions, and from the plurality of instantiated histories, and from these stored histories inductively derives generalizations of prior run-time activities. These generalizations are used to guide and refine future compound agent activity and inter-agent behavior. Matches and deviations from the compound agent historical instances and generalized dominant patterns of interaction, either reinforce or modify the stored database of meta-agent derived and stored patterns of behavior. These collection of stored behavioral histories and general patterns of operational history form a primitive mental model of the agent in relationship to its environment.

A given compound agent episode of activity becomes a sample compound history which is matched, compared, partially unified and classified under the built up temporal ontology of compound histories. A temporal ontology of predominate agent behavior becomes a pattern match pool of referential pattern formation indices that can alter the current compound agent run time behavioral activity. This alteration of behavior is instantiated as a mental model of beliefs and rules applicable to compound agent activity, and are used to alter the state transition rules of the present compound agent run time activity.

Compound agents can operate as closed systems or open loosely bound collections of agents, which change according to usage context. In this formation, individual agents can belong or operate in conjunction with a plurality of compound agent activities. Each different meta-agent stores a registry of available agents associated with it's compound agent activity functions. Individual agents located in individual processor real estate, receive requests from meta-agents to accept or reject participation in compound agent activity. If available for operation within the constraints of their local commitments and capability, individual agents will accept the compound agent activity participation proposition.

Individual agents have local or remote registries of what compound agent activities, other individual agents, and what meta-agents they can and will engage with. The range of activities permissible for engagement by an individual agent, and the range of internal state transitions of which an individual agent is capable, and the range activities with other agents, and with compound activity meta-agents are stored as a mental model of behavioral horizon. Constraints and freedoms of agent and inter-agent behavior is stored as as a registry. The registry is a collection of agent configuration attributes and contents, which are given a label name and address. Each agent's horizon of private and interactive behavior becomes a database registry of addressable configurations and permissions for private actions or inter-agent actions. The registry of interactions with other agents are stored in a database registry of permissible behaviors.

The registry of private agent and inter-agent activities are called agent plans. Agent plans are matched to external requests. The plan registry can have ranking and priority, so that if certain agent activities are proposed by human users or meta-agents, the agent can select the higher ranking behavioral option in the registry that fits the request. Plan ranking can be designated by the human user, or owner, of the agent. If the human user has designated a meta-agent authority over individual agent collections, the plan ranking of an individual agents private or inter-agent behavior can be designated, on an on-call basis, by a meta-agent.

Mental models of behavior, and the of the environment in which the behavior occurs, are formulated as semantic networks and Petri nets, which are in turn ordinated by an abstraction ontology. The semantic network forms the structural and functional model of relationship between element agents and environmental conditions. Semantic network propositions when repeatedly verified, become reinforced structural or functional pattern templates and are called beliefs. A pattern template belief of relational structure and relational function in a semantic network comprise aspects or the whole of a mental model. The mental model is also called a conceptual construct, with which agents or meta-agents can obtain instructions, reference, comparison, and permission to engage activity or cease or finish activity.

A conceptual construct that defines a initial state precondition for operation, or start-up state for an agent, can be used as an instruction to commence activity. A conceptual construct that defines a completed operation, or final state for an agent, can be used as an instruction to cease activity. Semantic networks can further be defined in temporal state of instantiation, similar to a Petri net which diagrams temporal state transitions of a system. Semantic networks are built up of active behaviorally induced, trained or pre-designated associations between atomic elements. These associative atoms of structure and function comprise the scale of granularity of a conceptual construct. Individual agents and compound agents governed by meta-agents can have varying degrees of granularity. Finer granularity represents more complexity of conceptual construct formation and coarser granularity represents lower complexity of conceptual construct formation.

Conceptual constructs of semantic networks are represented in multiple layers of abstraction. Element atom modes in a semantic network can be members of a class of nodes, which itself is represented as a node. Class level nodes in a semantic network can themselves be members of a super-class, a higher generalization, and be represented as individual nodes within their abstraction layer. Semantic network elemental atom nodes have an associated abstraction layer label. Depending on application context, an individual node may exist in more than one abstraction layer, but not at the same time and abstractive context.

As different tasks and operations are engaged, as initiators of change and state transition, the environmental context in which the change occurs is modeled at multiple levels or layers of abstraction. Each state transition in a agent or in a compound agent activity is a discourse act. Sequences and aggregations of discourse acts form complex discourse activity. A collection of discourse acts in an environmental context becomes a instantiated discourse history. A collection of discourse histories are stored, compared and classified according to structural and functional similarity.

In the present invention, agent experience is stored, compared and classified as behavioral activity log patterns of discourse history. Discourse histories are parsed into multiple abstraction layer state transition networks. Discourse histories, as agent ‘experiences’, are represented in multiple layer abstraction story models. Discourse histories are classed into story types, which types form higher order abstraction nodes. Multiple stories and discourse histories can be called and referenced by addressing the higher order abstraction node as a means to use a resource of multiple discourse histories as probable distribution of behaviors which can predict or instruct current agent activity. In this respect, the action of calling and comparing collections of prior discourse histories, as a plurality of stories known to have been possible given particular precondition contexts, permits an agent to resource a range of different discourse path probabilities in relation to a current run time activity.

A semantic network forms a conceptual construct space. A temporal state transition network process applied to a semantic net, is similar to a Petri net, a forms a behavioral history network. A behavioral history network embodies as a state machine transition activity log. The state machine transition activity log references against the beliefs which are mental models defined into conceptual constructs. The temporal transitional state of a semantic network element becomes the instantiated semantic network, as a situational application of the network in a behavioral context. As such, there is a requirement to track the contextual application of the semantic network in a given behavioral temporal trajectory.

A semantic network is a virtual mental model. A temporal state transition network is a behaviorally instantiated virtual model, which is therefore no longer operating as a closed system, but in an environmental usage context. As agents increase their body of experience, the conditional knowledge about the environment and its behavior in relation to their own behavior increases. This incremental behavioral experience expands the robustness of the mental model, beliefs, and constructs in the form of increasing the adaptation capability of the agent to new circumstances. Agents and compound agents can thus form increasingly complex and also increasingly robust capability for adaption to changing environmental circumstances and situational unexpectedness.

Compound agents can be used as complex task processors and complex situational environment managers. When compound agents are equipped with a sufficiently robust ontology to represent internal and external probable discourse, they can be applied to many uses that require non-brittle solutions. Human-computer interaction is an example of a domain requiring robust, non-brittle adaptation and interaction. In creating a range of network based agent resources for users to apply, compound agent activity can form many intelligent processes.

Many compound agents do not require a meta-agent manager, and no mental model or controlling scheduler is required. The only requirement is for agents to have their input start initialization and output chaining or stop conditions defined. One agent does not have any mental model of what another agent does. The only history of discourse an individual agent has is related to its own internal activity log. In circumstances where a compound agent activity log is desired, this is merely a aggregation of the individual agent activity logs with pointers to other agents and their respective logs. A meta-agent may not have any provision for complex inter-agent history and discourse process modeling, but be limited to being a database storage of pointers between agents which chained in some compound activity.

Domain expertise can be provisioned to an agent in the form of a database of discourse histories, and associated mental models in the form of:

(1) semantic networks,

(2) conceptual constructions,

(3) representation at different orders of abstraction,

(4) beliefs in the form of rules of interaction

(5) and beliefs as logical proposition IF-THEN-ELSE rules

(6) time fixed WHEN-IF-THEN rules or

(7) causally propagated activation conditions.

A deep knowledge base can be provisioned as a frame and slot based database of domain facts and situational conditions stored by example. The domain expertise knowledge base forms dynamically operable discourse of epistemological knowledge, which refers to and is built on a mental model ontology of domain facts and domain event and process conditions.

FIG. 12b illustrates a preferred hierarchy for agent and compound agent operational management and deep knowledge abstraction. For comprehension, the hierarchy is divided into three columns, including a Constraint Base Subsumption Hierarchy, and corresponding Application Base Components Hierarchy, and corresponding Knowledge Base Construction Managers hierarchy.

In FIG. 12b, in the subsumption hierarchy, the constraints of any lower element constraints in the list are subsumed by the next ascendant list element constraints. For example, the lowest element, “processing environment manager” 1400 constraints are subsumed under the “run-time activity manager” 1410, in that the processing environment manager is subordinate to the run-time activity manager.

In FIG. 12b, represented in FIG. 1a as 449, in the application base components hierarchy, the components of each level are operate at a successive abstraction layer higher than the adjacent lower level component. Each layer effects a more abstracted and generalized level of functionality and greater scope at the next higher level in the hierarchy.

In FIG. 12b, in the knowledge base construction managers hierarchy are identified the implementation constructs applicable to manage each layer of a deep knowledge hierarchy.

In FIG. 12b, all three columns are isomorphic and carry one-to-one correspondence across the hierarchy, and the illustration of three columns for subsumption constraints, application components, and knowledge base management techniques are shown for clarification. Exceptions to this formulation are numerous however, and this schema is introduced to illustrate one embodiment organization for agent and compound agent interaction, management, and intelligent hierarchic operational aggregation.

This schema provides a hierarchical ladder of interdependent subsumed components, where each successively higher component in the ladder is composed of the prior ladder elements with an super-ordinate class level management function over the lower components.

Each level in the deep knowledge command and control hierarchy consists of a class layer of complexity in the system, with higher level classes containing higher inherent complexity in that they effectively contain, manage and subsume all lower class layers.

Thus, in FIG. 12b, the uppermost class of mental model valuations and story types 1420 are comprised of and subsume Episodic histories 1425, where 1420 introduces the classification and generalization of the prior 1425 component episode histories. Mental model valuations and story types 1420 are embodied as dynamic Discourse story generalizations registry 1520, and are implemented as an Abstractive ordinator program 1620 manager. The Abstractive ordinator manager 1620 knowledge base construction program includes means to perform all aspects of registry 1520 categorization, storage, recollection, pattern matching and statistical grouping for purposes of housekeeping the deep knowledge system at that class layer.

In FIG. 12b, Episodic histories 1425 are comprised of and subsume Situational transition types 1430, which define the range of possible episodic histories. Episodic histories 1425 are embodied as a dynamic Instantiated discourse history database registry 1525, and are implemented as a Compound transitions logger 1625. The Compound transitions logger 1625 manager program knowledge base construction program includes means to perform all aspects of registry 1525 collection, indexing, assignment, and statistical grouping for purposes of housekeeping the deep knowledge system at that class layer.

In FIG. 12b, Situational transition types 1430 are comprised of and subsume collections of Conditions and events 1435 which define the range of possible range of situations that can develop. Situational transition types 1430 are embodied as a dynamic Discourse-process-types database 1530 and are implemented as a State machine network formulator 1630. The State machine network formulator 1630 knowledge base construction manager program includes means to perform all aspects of generating new and old types of network state machine interaction types. This includes search, identification, correlation, categorization, indexing, assignment and statistical grouping for purposes of housekeeping the deep knowledge system at that class layer

In FIG. 12b, collections of Conditions and events 1435 are comprised of and subsume inter-agent grammar 1440, wherein the inter-agent grammar 1440 as a collection of instances form descriptions of Conditions and events 1435. Collections of Conditions and events 1435 are embodied as dynamic meta-agent pre-conditions and post-conditions and tasks database and related operations stack, and are implemented as a State transition epistemology knowledge base construction manager program 1635. This includes means to perform all aspects of state transition coordination and handling. This includes search, identification, state transitions correlation, categorization, indexing, assignment and statistical grouping for purposes of housekeeping the deep knowledge system at that class layer.

In FIG. 12b, Inter-agent grammar 1440 is comprised of and subsumes Inter-agent conditional syntax 1445, which constrains the grammar to a particular range of transactional communication formations. Inter-agent grammar 1440 is embodied as a dynamic Inter-agent discourse capabilities inventory database 1540, and are implemented as Semantic network formulator 1640 knowledge base construction manager program. This includes means to perform all aspects of semantic network generation, coordination and handling. This includes search, identification, semantic network data node correlation, categorization, indexing, assignment of relational linkage typology, and statistical grouping for purposes of housekeeping the deep knowledge system at that class layer.

In FIG. 12b, Inter-agent conditional syntax of interactions 1445 is comprised of and subsumes a possible Dictionary of behaviors and concepts 1450 which agents use in inter-agent activity. The Inter-agent conditional syntax of interactions 1445 is embodied as dynamic Agent sequence and chaining rules 1545, and are implemented as Frame and slot rules ontology 1645 knowledge base construction manager program. This includes means to perform all aspects of frame and slot rules generation, inter-relationships and dynamic update handling. This includes search, identification, frames and frame set correlation, categorization, indexing, assignment of relational linkage typology, and statistical grouping for purposes of housekeeping the deep knowledge system at that class layer.

In FIG. 12b, Inter-agent Behaviors and concept dictionary 1450 is comprised of and subsumes individual agent Settings and preferences 1455, and these individual agent preferences define and limit the range of possible inter-agent behaviors 1450. The inter-agent Behaviors and concept dictionary 1450 is embodied as dynamic Individual agent types, capabilities and possible states 1550, and are implemented an Agent internal event inventory 1650 knowledge base construction manager program. This includes means to perform all aspects of frame and slot rules generation, inter-relationships and dynamic update handling. This includes search, identification, frames and frame set correlation, categorization, indexing, assignment of relational linkage typology, and statistical grouping for purposes of housekeeping the deep knowledge system at that class layer.

In FIG. 12b, Individual agent settings and preferences 1455 are comprised of and subsume the constraints effective in the agent Run-time activity manager 1410, and the run-time activity manager limits the range of possible activities which can set as preferences 1455. Individual agent settings and preferences 1455 are embodied as dynamic Agent structural instantiated configuration attributes 1555, and are implemented an Object event and behavior parameter and variables 1655 knowledge base construction manager program. This includes means to perform all aspects of agent object event and configuration related event generation, inter-relationships and dynamic agent configuration update handling. This includes instruction import and export, agent instantiation type correlation, configuration parameters and variables categorization, indexing, assignment of structural integration, and statistical grouping of such configuration management of such attributes for purposes of housekeeping the deep knowledge system at that class layer.

In FIG. 12b, the Agent run-time activity manager 1410 is comprised of and subsumes the Processing environment manager 1400, which constrains the possible range of run-time activity as a function of the operating environment in which the agent is intended to run. The agent run-time activity manager 1410 is embodied as a dynamic Agent operations stack 1510, and is implemented as an Internal agent operational transitions database logger 1610 and knowledge base construction manager program. This includes contains means to perform all aspects of operations related processes, agent operations program sub-module interactions, and dynamic agent activity transition instruction management. This includes agent project database creation, discovered data set collection, correlation, analysis, categorization, indexing, assignment of Boolean or non-Boolean valuations to findings, and produce statistical grouping of results collected for purposes of housekeeping the deep knowledge system at that class layer.

The agent processing environment manager 1400 is embodied as a dynamic Agent operations execution engine algorithms set 1500, and is implemented Unit agent control stack 1600 knowledge base construction manager program which contains means to perform all aspects of algorithm application. This application includes related control stack processes, agent internal temporary file interactions, and associated control processes for agent engine algorithm execution. This includes agent internal program step sequencing and exception handling, timing, input-output correlation, input data set categorization, execution of search comparison routines to classify and sort findings for purposes of housekeeping the deep knowledge system at agent execution engine algorithm processing class layer.

In FIG. 12b, the agent Processing environment manager 1400, the Agent operating engine execution algorithms the Unit agent control 1600, and has further underlying components, including,

(1) application software language in which it is coded,

(2) the application platform environment operating system on which the software runs,

(3) the native assembly language environment which the platform and application software are high level language interpreters of, and

(4) the hardware processing system in which the operating system functions.

The elucidation of the continuing hierarchy from 1400 up to 1420 in sequence, establishes a method and schema for planning, analysis, management, control and abstracted intelligence of the system. Decomposition of the hierarchy into the layers as shown, provides a modular and consistent schema in which complex task requirements and application case definitions can be embodied, maintained, constrained, and analyzed. Further, this hierarchic schema for planning and complex task hierarchic decomposition provides means to rapidly classify the abstraction level of the origin of design problems and failure modes within a deep knowledge system.

FIG. 12c illustrates a spectrum of agent and compound agent application domains facilitating one-to-many and one-to-one network interactions for users.

Agent activity and compound agent activities can be used in a variety of application contexts. While individual agents are configured to be limited in scope and complexity to a small plurality of tasks and activity, compound agents can inter-operate to effect a wide range of complex tasks and processes. These more complex processes encompass different discourse contracts and conditional activities based on what the integrated aggregate of agents as a compound agent can support.

Examples of individual agent application capabilities include selective information content and media search, navigation, retrieval, analysis, reporting and presentation delivery of information from a plurality of disparate sources over a network such as the internet. These capabilities can be applied to comparison shopping, meta-search, form filling and submission, change detection, update notification, data mining, search engine results previewing, web browsing, web navigation, newsgroup data collection, news collection, chat discovery, auction minding, financial data minding, content media discovery, forum message mining, time sensitive alerts, for example.

Examples of compound agent application capabilities include engaging in complex search and retrieval requiring multiple agent approaches for:

(1) information discovery and collection,

(2) user proxy transaction management,

(3) customer support assistance,

(4) negotiation between parties,

(5) brokering between agents, brokering between people,

(6) identify verifications,

(7) secure access authorization,

(8) security control, user provisioning,

(9) compound agent provisioning,

(10) expert system advisory functions,

(12) domain expertise mining,

(13) data set ontological mapping,

(14) resource registry interaction and control,

(15) supply chain analysis and management,

(16) distribution chain analysis,

(17) user choice profiling,

(18) user behavior profiling,

(19) configuration management,

(20) natural language interpretation,

(21) user avatar interaction and habitation behavior,

(22) program construction,

(23) complex investigation,

(24) decision support,

(25) failure recovery,

(26) web site statistical analysis,

(27) quantitative financial portfolio management,

(28) qualitative social capital search and evaluation,

(29) complex information visualization,

(30) conversational interaction,

(31) device controllers, and

(32) peer-to-peer distributed agent search, retrieval and reporting, for example.

FIG. 12c, as represented in FIG. 1a combines 514 and 492 elements, and illustrates the preferred organizational usage taxonomy of agents in different contexts for network based interaction, communication and information transaction. Each of seven classes of agents are identified for accomplishing different types of network based interactions. The individual first person user exists at the top of the network multi-party interaction relational stem, and a second party user for end point information resource exists at the bottom of the network relational interaction stem.

The FIG. 12c model rectifies in an self-consistent organizational layering schema, seven primary components relating to intelligent resource instantiation fo the purposes of supporting (1) one-to-one, (2) one-to-many, (3) one-to-site, and (4) one-to-many-sites virtual dimensional inter-domain connectivity across the network.

Each class represents a gradation of relationship between different layers of interaction space between a user at one end of the arc and another destination user of place or node extant in the network at the other end of the arc.

The FIG. 12c architectural network interaction schema is biased of a first-person party point of view being located at the top of the seven layer support protocol. All interactions between the first-person user and anywhere or anyone else on the network contains the agent support provisioning structure biased to the first-person at the top of the diagram. A second person, when considered from their centric vantage point of agent support protocol will have the same position at the top of their own similar multi-layered schema, even though another “first-person” party is located at the other end.

In simple terms, this is a single network human user centric schema. When two people interact over the network, they both have the same relative ordering schema of agent support protocol applied to them. As such FIG. 12c illustrates a virtual interaction dimensional manifold that is single user biased, and which uses agent technology means and protocols to support their most advantaged position as a single user.

As such the plurality of agents listed on the right column of the diagram are all applied in relation to the single user in the instantiation of those agents for the user.

To further illustrate the overlapping bi-directional nature of the multi-agent, single user biased network interaction resources support protocol, FIG. 12d illustrates the overlapping but relative independent usage layering of seven concentric layers between them. Party or first-person user One 1750 interacts with a second person or party two.

By definition the first person party is the determining placement of the classification of the network interaction agent resources as a multi-layered deep support protocol. From a single user, or first person or Party One 1750 point of view, the interaction is always one to many, unless the single user expressly represents an entity such as a business or organization.

The schema is designed to be a general purpose organizational architecture for conception, classification, and application of different types of user centric support tasking in a wide variety of application contexts, and typologies of description for such application contexts.

For example, FIG. 12d four different examples of agent class descriptive typologies are shown to illustrate the different means to which the overall schema can be applied to classify and holistically unify the range of possible elements in a seven layer agent support protocol system. These typologies include Personal 1710, Community 1720, Content 1730, and Business 1740. The one through seven numbered agent activities or agent identities correspond to the one through seven layering 1751 for Party One 1750. Party Two 1760 has their own centric directional layering 1761, in dotted lines.

In FIG. 12d, the layering schema is represented as seven zones of area where agents function to support user interaction across virtual network space. Reading from the Party One 1750 across their centric agent collaborative virtual space between themselves and any destination or other Party Two 1760.

The seven layers correspond the FIG. 12c seven vertical stacked classes of agent types relative to the Party One or first-person user situation at the top of the diagram. This schema is extremely useful as a comprehensive encapsulation of the inter-dimensional interstitial zones between remote party interactions over networks, especially as agent technology can be applied to support conductivity across the inter-party switch space.

FIG. 12c Personalization 1880 corresponds to FIG. 12d zone layer 1780, and treats the functions of Strategic User Interface Management.

FIG. 12c Naturalization 1882 corresponds to FIG. 12d zone layer 1782 and treats the functions of Managed Experiential Format & Presentation Services.

FIG. 12c Intelligence 1884 corresponds to FIG. 12d zone layer 1784 and treats the functions of Specialist, Leveraged Knowledge Services.

FIG. 12c Connectivity 1886 corresponds to FIG. 12d zone layer 1786 and treats the functions of Dynamic Secure Market Registry and Resource Brokering.

FIG. 12c Outsourcing 1888 corresponds to FIG. 12d zone layer 1788 and treats the functions of Fulfillment and Collaboration Specialist Jobber Resource Guilds.

FIG. 12c Transactions 1890 corresponds to FIG. 12d zone layer 1790 and treats the functions of Exchange Portal Activity and Commerce Services.

FIG. 12c Engagements 1892 corresponds to FIG. 12d zone layer 1792 and treats the functions of New Media Content and Multi-Party Portals.

FIG. 12c User Interface Portlets 1881 typically deal with aggregation of the business of Personalization 1880 and Naturalization 1882.

FIG. 12c User Interface Services 1883 typically deal with aggregation of the business of Naturalization 1882 and Intelligence 1884.

FIG. 12c User Interface Infrastructures 1885 typically deal with aggregation of the business of Intelligence 1880 and Connectivity 1886.

FIG. 12c Community Interface Infrastructures 1887 typically deal with aggregation of the business of Connectivity 1886 and Outsourcing 1888.

FIG. 12c Community Interface Services 1889 typically deal with aggregation of the business of Outsourcing 1888 and Transactions 1890.

FIG. 12c Community Interface Portals 1891 typically deal with aggregation of the business of Transactions 1890 and Engagements 1892.

In FIG. 12c, each of the seven layers represent contiguous virtual inter-domain space that separates or associates the user real domain spaces, through virtual space, to any other real domain space or location on the network. In this terminology ‘inter-domain’ is the association of two space extant parties across the heterogenous network.

Agents are facilitators in the association between real spaces or parties across the inter-domain virtual space of the network. Each layer may use or invoke agents to support interactivity across the network, in cognitive, associative interactive, and operational terms.

In FIG. 12c associative virtual space connectivity and interactivity mapping between real spatial location principals or terminal domains, occurs. Agents function in seven classes of operational activity, as augmentation functions, including: Personalization augmentation functions, Naturalization augmentation functions, Intelligence augmentation functions, Connectivity augmentation functions, Outsourcing augmentation functions, Transaction augmentation functions, and Engagement augmentation functions.

This model defines a spectrum of seven core business activities in which agents may be applied, the associated application services and benefits, and a sample plurality of agents which operate in each inter-domain layer.

FIG. 12c illustrates a model for organizing different business methods and supporting application agent technologies, which direct and inform seven different types of core business missions. Each of the seven primary categories of agent populations is managed by a specialized ‘meta-agent’ which dedicated to that population type. This allows means for a vast plurality of possible agents that currently exist or will exist, to be coordinated and controlled by only seven meta-agent managers. For convenience only, the seven meta-agents are named as follows, following the FIG. 12c seven layers, including:

(1) a Personalization meta-agent 1880, and manages, for example:

Companion Agents

Personal Info Manager Agents

Desktop Assistants Agents

User Avatar Agents

Home Chatter or Local Chat Agents

(2) a Naturalization meta-agent 1882, and manages, for example:

Media Agents

Viewing Agents

Metaphor Agents

Translation Agents

Speech Agents

(3) an Intelligence meta-agent 1884, and manages, for example:

Advisory Agents

Expert Rules Agents

Knowledge Agents

Simulation Agents

Analytic Agents

Ontology Agents

(4) a Connectivity meta-agent 1886, and manages, for example:

Broker Agents

Agent Registry DB

Network Registry Agents

Multi-Party/Social Agents

Search Agents

Security Agents

Agent Infrastructure Agents

(5) an Outsourcing meta-agent 1888, and manages, for example:

Provisioning Agents

Value Chain Agents

Endorsing/Promo Agents

Content Mgt. Agents

Escrow/Clearing Agents

Inspection Agents

Data Mining Agents

(6) a Transactions meta-agent 1890, and manages, for example:

Server Agents

Shopping Agents

Transaction Agents

Customer Agents

Update Agents

News Agents

(7) an Engagements meta-agent 1892, and manages, for example:

Web & DB Server Agents

Call,,Chat,,FAQ,Data, Agents

2ndPty Avatar Agents

E-Mail and Newsgroup Agents

Database Query Agents

Each of the seven meta-agents manages the population of agent types within its observer relative class layer.

Meta-agents are deployed on a user centric basis, and different users have different meta-agent interactivity managers.

Each meta-agent can communicate with every other meta-agent, and as such the seven meta-agents are the master brokers in the user observer centric interactivity management as elates to other meta-agents. Each meta-agent can communicate and evaluate any agent within its internal class population of agents.

In all these application settings, the requirement for using agents to execute individual information change detection, content verification, retrieval, and associative semantic definition between information is serviceable by the method and apparatus described in this preferred embodiment of the present invention.

In these application integration contexts, the search mapping and retrieval agents or the semantic mapping agents, for example, of the present invention communicate with an application host. The application host performs the traditional business rule based inference and control operations.

These operations can include logic rule programs such as employed in relational databases, production rule program such as commonly employed in expert systems, and EVENT-CONDITION-ACTION rule based programming such as employed in business workflow tools, process automation tools or publish-subscribe tools.

In the preferred embodiment of the present invention the search and retrieval agents coded in ‘C’ language and ‘C++” and additionally in Java, are configured to additionally search and retrieve information data sets from a plurality of differently designed XML based database information ontologies.

The system interprets and collects information from executable Java objects. The present invention can acquire and collect and display complex database information and produce useful visualization of database content information nodes, as can be queried from content stored using MS COM/DCOM SQL database servers, or Oracle 8i database server solutions for example.

FIG. 13 illustrates two three-dimensional animated display windows showing web site document nodes and links in a fan display format. The upper example window display in the illustration shows a floating tree fan format that has four successive link depths discovered with only one link per level pursued.

The lower example window display in the illustration shows a two level tree fan with each page in the second level showing thr number of page links associated with those pages, from zero in one page, to dozens in another page.

FIG. 14 illustrates both a complex and simple three-dimensional animated display windows showing web site document nodes and links both in a spherical star display format. The upper example window displays thousands of discovered page nodes and link connection and the lower example window shows only a few page links from an origin starting point page. The links associated with each successive page discovered are scaled to be smaller than the parent page links from which they were discovered.

FIG. 15 illustrates an example three-dimensional animated display window of web site document nodes and links in a fan tree format with fish eye perspective lens. The user point of view has been rectified to a particular level of the tree fan so that all page nodes on the same descendent link level are on the same plane. This enables valuable discrimination and motion navigation of the complexity and descendent level of the page nodes discovered in the network.

FIG. 16a illustrates an complex three-dimensional animated display window of web site document nodes and links in a color coded cubic type domain layering format of the NASA web site with fish eye perspective lens. This display comprises thousands of page nodes and links, which are clustered according to similarity of domain name and file path, and also clustered based on whether the page nodes are within the same domain address or another domain address.

The placement and positioning of nodes in the visualization using the cube display type follows method that provides assignment in three dimensions based on (1) domain name, which has largest strength influence on 3D placement, (2) file path, which has least strength influence on 3D placement. Different domain names with similar text string data are placed nearer in proximity to each other. Different file paths within the same domain are placed in different positions based on the similarity of the file path text string data.

FIG. 16b illustrates an example three-dimensional animated display window of a portion of the NASA web site in planar shadow cast sphere display format with triangular bar chart elevation metrics. This display represents a visualization of ninety associated web page nodes and connection links.

The elevation metrics display the occurrence count of certain word terms present in given web pages, with the highest elevation triangles in the 3D bar chart display preference showing highest hits per page visited. When the linear HTML report is generated based on this acquired group of pages, the results can be ranked according to the elevation metrics shown. The user can point and click on different elevation bars in the visualization to immediately launch the browser to go visit that web page.

FIG. 16c illustrates an example three-dimensional animated display window of a portion of the NASA web site in planar shadow cast sphere display format with rectangular bar chart elevation metrics. The appearance of metric count elevations in rectangular format gives the appearance of skyscraper buildings in the display.

The use of a degree of fish eye lens perspective produces a slight curvature to the planar shadow cast of the connections between page nodes to provide the appearance of semi-spherical planetary curvature. These features have esthetic recognition value to the user to more readily visualize information structures in dimensional terms that are familiar and feel natural.

FIG. 17a illustrates an example three-dimensional animated display window of web site document nodes and links in tree fan format shadow cast onto a plane with metrics in a bar chart elevation format.

When not in planar shadow cast display format, this network display would be dimensionally floating in three dimensions above this point in the virtual network display. When shadow cast, at any orientation, the tree fan structure generates a surface map of the tree structure, and the metric elevation bars show hits relating to metric counts of terms or number values in a given web page document.

FIG. 17b illustrates two examples of three-dimensional animated display window of web site documents and links in a triangular bar chart elevation format. When the user views the network visualization from a near to planar surface elevation angle, the relative heights of the triangles can be more readily discriminated.

When using flight simulation mode the user can browse the network elevation display by flying just above the planar shadow cast surface of the network. The user can point and highlight any bar to see a display of the title name and the URL of any web site node. The user can click on any highlighted bar and launch the browser to visit that web site page location.

FIG. 17c illustrates two three-dimensional animated display windows of the same web site document nodes and links in bar chart format with metric digit labels in both shadow cast tree fan format and shadow cast star format. This illustrates how at the click of a preference button the display of elevation bars with digits attached can be changed to be displayed in an alternate surface layout pattern. In this example, the two alternate presentation visualizations of a network and associated metrics are the sphere and fan format.

Additionally, in the upper example the digit display is marquee style with four sides boxes with the digits visible on four ninety degree angles. In the lower example, the digit display is a singular two dimensional and continuously follows to remain facing the user point of view regardless of the user motion around the network display.

FIG. 17d illustrates an example three-dimensional animated display window of bar chart display with triangular bars to create a mountainous appearance for height discrimination. This is useful when the contiguous abutting of different elevation metrics provides better relative discrimination of heights of metrics, without digit display.

The FIG. 19 visual display of graphical rendered digits in 3-D network display space, represent different examples of how the user can operate multiple agents simultaneously, where each agent is tasked with collecting and constantly update a number display window which is titled with the task being performed. Tasks can include activities such showing as “SF Weather temperature” and “SF Wind speed” at a particular location, “Gold asking price” or “Gold bid price” for example.

Examples of the different types of watchdog tasks an agent can perform in financial information search and retrieval and display, and can include:

(1) World markets: open, close, volume, previous, change (up/down magnitude), last price, day high, day low, scoop highlights, trends by company type.

(2) World commodities: up/down, relative up/down differential magnitude, foreign currency futures, currency credit rating, news links of relevance.

(3) Fortune 100 stocks, up/down magnitude, volume traded per time interval, bar chart graphing volume trading changes over the day, and time of day stored or real time related numeric measurements.

Sources for these measurements can be publicly available or subscription based or pay per use access, and may include authoritative financial information sources including, but not limited to:

Baring Pan Asia, Bloomberg, Bridge, CBS Marketwatch, Central European Exchange, Credit, Lyonnaise Index, Dow Jones Index, EASDAQ, Euro NM, S&P AWI, FTSE, Guinness Flight, HSBC James Capel, ISMA, JP Morgan Composite & Government, KB Petercam, Morgan Stanley, Stanley Capital International, Multex, OneSource Information Services, Salomon Brothers Index, Street Fusion, TOPLX, UBS B'Mark Bond Index, and Vcall.

Sources may include Stock Exchanges and Commodities around the world, in Africa, America and South America, Asia, and Europe.

In one preferred embodiment of the present invention the user can upload the agent to be executed to a server. The server referred to in FIG. 1, block 476, will run the agent in an agent processing computer using higher speed access facilities than the local user computer has available within its disposal in terms of network access bandwidth or available storage. After the agent search and collection task is completed on the remote server, the auto-generated HTML formatted results are posted onto a web server page FIG. 1a block 481.

The user is notified via email 480 or speech enabled email that the search and collection result is completed and now available. Alternatively the user is notified by an instant messaging pop-up window on their local client interface.

Further, the user the user can be sent the collected results within certain limits of size and content types delivered via e-mail to their client interface device. The search execution is performed remotely from the user client interface device or computer. In this case, then the results can be delivered via email, instant messaging or posted and hosted by a remote web page server privately for the user.

This is in addition to the provision of the results of the search, whereby the user can be sent a selection of the 3-D or 2-D network visualization. This visualization can be delivered in multiple formats, such as a JAVA animation applet, or as an OpenGL file, or as static image GIFs, or JPEGs, or as a downloaded movie such as a AVI movie file, or a QuickTime movie.

Whether the agent search and retrieval activity is executed on the local client machine or a remote processing server, the agent results report can be additionally served with an advertisement banner or other advertisement content. This advertisement content is positioned at the top of the first page of the report, and the banner is served from a remote web server that the agent checks with each time an agent search and retrieval run is engaged.

This feature of serving a banner or other inserted element into the report on a regular basis served from a remote server can reference the Boolean search terms used by the user. Referencing the search terms can match against a remotely maintained database thesaurus of words and phrases that are correlated with the Boolean search terms or Metric terms. The thesaurus matched words and phrases are indexed against a pool of available advertisement banners. If the Boolean search terms or Metric terms do not match a banner in the available pool, then the thesaurus match function is used.

However, if at least one banner matches the user entered Boolean, the matching banner may be served to the client computer. If no banner matches the user entered Boolean search terms or Metric terms, then the thesaurus matching function is used.

In the case of using the remote served thesaurus, or of using the local client computer thesaurus, if more than one banner is available, the banner selected to be served may be randomly selected.

Alternatively the selected banner advertisement served to the user can be the first banner on the list of matches. An account is set up for the user which tracks which banners have been served to the user, and thereby serving new banners to the user which the user has not yet received in prior instances. In one embodiment of the banner serving function, the banner served is the banner that an advertiser has paid or has bid a higher price to be served compared to other banners available to be served within the banner match pool.

FIG. 20, as represented in FIG. I as 404, illustrates the control panel for setting up an agent to launch in screen-saver mode. Any agent can be used as a screen saver module, and this is selected using the ‘select’ button on this control panel window.

If an agent to be used in a screen saver operation and display mode has any notes associated with it these notes can be displayed by clicking on the ‘notes’ button. If the agent to be used in screen saver mode requires editing or changes to change its focus, search terms, action actions or any other configuration parameter, the ‘edit’ button is clicked, which opens the agent development and set-up tool.

FIG. 21, as represented in FIG. 1 as 408, illustrates the header on the HTML generated results report. The report header includes certain information related to the agent activity and the results collected and displayed in the report. This includes the URL starting page 700, certain report format preferences 702, the search and navigation mode preferences 704, metric terms and counting codes 706, specific exclusionary information 708, and the media collection preferences 710.

FIG. 22 shows an example web page report being displayed in the standard internet browser, and provides metrics 720 number count display and number links to the page. The display report for the page shows the web page title 722 which is highlighted as an active link that can be clicked to take the user to the web page using the browser. The report for the page in this example shows partly formatted text 724 that was captured from the site, including the actual URL address at the top.

Search and retrieval agent execution activity is optionally complimented with encryption features. These features execute user agent activity in a anonymous and private method, whereby the identity of the user is encrypted using, for example, commonly known double or triple D.E.S. (Digital Encryption Standard) technique.

Further, the system can use a commonly available P.G.P. (Pretty Good Privacy) encryption standard, or other standards and encryption techniques available from third party vendors.

FIG. 23 illustrates an example of the network visual display occluded in cloak mode. In certain circumstances the user may wish to prevent the network node and link display from being observed by third parties, and the cloak mode provides a masking feature for this purpose.

Further, the cloaking mode graphics are set to change color depending on the agent activity, with red indicating the agent is stopped or finished, and green indicating the agent is still working on line.

In FIG. 24 an agent activity remote server encryption method is illustrated. The client to server system incorporates an encryption of the user identity, the mail path, the agent instruction, and the agent report results. A remote server executes the agent search and retrieval collection processes in the world wide web or the internet, and stores and encrypts the results on the server for later emailing or instant messaging to the client user.

This method provides an additional degree of security for users both in terms of anonymity of who is executing the search and retrieval agent activity and what the results are of the activity, following a series of steps:

(1) The user identity and agent instructions 626 are separately encrypted using strong encrypted using triple D.E.S. for example, which only the user and the machine-readable-only secure server have corresponding keys for decrypting for example. The user and the server both have a common set of keys, which are once-only-usage keys. The user ID is encrypted 624 separately from the agent instructions encryption 622.

(2) The email 620 contains the encrypted agent instructions and agent return path identity which are sent to the server via an anonymous additionally encrypted re-mailer system to protect the client user location and identity path. The encrypted re-mailer 620 service uses an additional layer of PGP encryption of the already separately encrypted.

(3) The server 600 uses a pre-stored once-only-usage (use once and erased) decryption key to decrypt the agent instructions, temporarily save the return path identity, and execute the agent search and retrieval activity. The host server 602 executes the agent activity.

(4) When the agent execution activity is completed and a results collected 605 and a report is ready to be downloaded to the client user, the server sends an email 610 or instant message notification, through an anonymous additionally PGP encrypted re-mailer system to the client user.

This message signal the results report are ready, and the timing delay of sending this message is optionally randomized. This randomization allows the results to be sent in a large enough elapsed time interval to disassociate synchronization of the agent server execution activity completion 604 and the client user notification 610 for purposes of temporal de-correlation. This de-correlation is useful for further measure of secrecy should third party external surveillance of the server agent execution and communications activity occur.

(5) The results of the agent execution activity as a report are separately encrypted 606 using another newly generated once-only-usage decryption key.

(6) The newly generated key is sent separately to the user using an anonymous additionally encrypted re-mailer path 610.

(7) The user receives the notification message 611 containing the newly generated decryption key that the results are ready for download.

(8) The user then downloads 613 via an anonymous additionally encrypted email re-mailer 608 the encrypted results report.

(9) The user decrypts 612 the report using the prior or separately received newly generated key which is itself encrypted using a client server once-only-usage commonly held key.

(10) The report results are read 614.

In this encryption schema, user identity, agent report content, email paths and keys are all separately encrypted. As a consequence, the probability of associating any broken key code component with any other becomes highly improbably and more code breaking intensive. Such code breaking becomes yet more improbable given the difficulty of knowing which user identity is associated with which email path, and which agent execution activity is associated with which emailed results, and which keys are associated with which encrypted data streams.

The selection of commonly used keys between server and client can be further obscured from external exposure. This is accomplished if the selection of which commonly held key currently used is itself a random selection from the pool of available once-only-usage keys. Such random selection generates a deterministic key selection pointer, which pointer is itself encrypted and sent to the user using a once-only-usage decryption key.

This once-only-usage decryption key is not randomly selected. The successive once-only-usage key available to use in a separate key list is commonly held by both the client and server. Further, the commonly held pool of keys are additionally encrypted for storage until needed for use in information transport activity.

In one embodiment of the present invention the agent chaining and shell application command processing capability as illustrated in FIG. 12 is extended to multiprocessing and distributed search activity and functionality. This is accomplished by means of incorporating a peer-to-peer agent collaboration network and network collaboration management meta-agents called “horizon hub computers”. These meta-agents structure and coordinate agent-to-agent activities whereby a plurality of agents are available on a plurality of computers over a network.

This plurality of agents are coordinated and designated to perform search and retrieval and storage and database indexing and search and retrieval results formatting functions. The communication between agents can be managed by other agents residing on other peer-to-peer client user computers in a network, or be managed by a centralized client-to-server server.

In a preferred embodiment of the invention, the peer-to-peer context deploys many agents in concert to accomplish a function of search, retrieval, indexing, storage, and serving results to users, search and retrieval agents are coordinated using a registry of peer-to-peer computers, as so-called horizon registries. In another embodiment of the invention, semantic mapping agents are also deployed in the same manner as the previous sentence.

The peer-to-peer coordination of operational agent processes follow a multi-layered horizon indexing scheme. This scheme operates so that the lowest level peer-to-peer network generates an index of other agents available within a client maintained network addressable horizon. This horizon is limited to practical collection and results summation processes for the horizon, where, for example, a search and retrieval job activity is divided between a group of agents each searching a different section of the network.

When distributed executed search space overlaps occur where more than one agent overlaps the search space URLs of other agent, these duplications are limited, or alternatively, the most recent searched space is accepted. When conflict between search space results occurs between agents, the conflict is resolved via recency, or by including both variant results.

When the search space of URLs and data set contents overlaps between agents, while redundancy occurs, this can be used as an indicator of relative completeness for the search. A plurality of search agents in a peer-to-peer collaboration network can be deployed where the agent instructions are broadcast to all other peer client computer agent runtime facilities. Thereby the agents are following the same search preferences, however, with the starting search points for the live network search being divided and distributed between the agents running on each peer collaborator computer.

Singly redundant search can apply more two agents to the same starting point if required. The individual results of the search and retrieval activity of each agent are stored on each client peer computer. The results are then erased after being transferred to a peer horizon hub computer. The horizon hub computer receives the results of all the peer computer agent activities, performs a unification on the results to eliminate conflicts and redundancies, and performs a global indexing function, and serves the result back to the client peer user that initiated the search.

If the peer horizon fails to produce adequate results according to user preferential criteria, then a second level horizon search deployment can be engaged. The second level local horizon hub computer (local horizon server) communicates user requested agent instructions and search space starting point preferences to a group of other local horizon hub computers. These other horizon hubs each in turn distribute and divide the search and retrieval job to their own local peer member horizon, or if their local horizon facilities are too busy with other activities, the hub will pass the job onto another peer horizon hub computer.

In FIG. 25 is illustrated a possible embodiment of an agent work distribution peer-to-peer network. A local peer-to-peer horizon group of different user computers 1360 are composed of a plurality of individual peer horizon member computers such as computer 1300 for example. Each computer in the local peer horizon 1360 communicates with a local horizon hub computer 1310 via network communication paths such as connection 1320 or 1322 for example.

The number of peers in a local horizon is not limited to the number of peers shown in each horizon, and this illustration is for example only. The actual number of peers such as 1305 and 1300 for example within a horizon 1360 may vary depending on the constraints of implementation relating to the preferences of users or the capacity of the local hub computer 1360.

Different local horizons may have different numbers of member peers. FIG. 25 illustrates four local peer horizons 1360, 1362, 1374, and 1372, each equally containing twelve member peers, and each local peer horizon group having a local peer horizon hub manager 1310, 1364, 1336, 1334, respectively. Each hub manager is a specialized member peer within the local horizon, and is a specialized the thirteenth member peer in its own local horizon.

The hub computer 1310 manages the local horizon members such as computer 1300 and computer 1305 for example. When a peer member 1300 wishes to engage its local horizon of peers 1360, for example, it sends 1322 a request and agent configuration file to its local horizon hub manager computer 1310.

The local horizon hub computer 1310 is another peer computer partly or wholly dedicated to managing local horizon agent distribution, results collection, and results delivery activities. The hub computer 1310 may also be used to engage in agent operations as requested by local horizon peer members. Alternatively, the local horizon hub manager may be dedicated to the local horizon distributed agent activity management and related communications.

Any peer member user such as computer 1305 or computer 1300 within a local horizon 1360 can request distributed agent job processing within the local horizon. The local horizon hub computer 1310 then distributes the agent job task to one or more members of the local horizon 1360.

If the local horizon 1360 is too busy, the hub 1310 can request 1330 another local horizon hub manager 1364 to accept and process all or a portion of the multi-agent task, depending on the distributed agent job task requirements. If a second local horizon 1362 peers member computers are available to be tasked with the job request from first local horizon hub 13 10, then second horizon hub 1364 will distribute the agent configuration instructions to peer members within its local horizon.

The agent instructions and configuration data sent to any peer can include one or a finite plurality of agents. If an agent sent to one peer 1300 requires chaining to other agents which chaining is beyond the local computer 1300 preferred capacity, then the chaining instruction and the second agent configuration are sent to another peer member computer 1305.

This is accomplished by means of the first agent chain instructions for a second agent being sent to the local horizon hub manager 1310, which in turn relays the instructions and agent configuration data to the peer member computer 1305 within the local horizon.

The agent data for the second agent in the chain may be never resident at the first agent execution peer 1300, if the peer computer 1300 was not the origin of the first agent activity, but was tasked for the job by the local horizon hub manager 1310. In this case, the second agent configuration data may be stored at the hob computer 1310, and not sent to any peer member computer until triggered for execution.

The local horizon hub manager 1310 maintains agent scheduling, local horizon peer member registry, and a larger horizon hub manager peer registry. Local hub 1310, maintains an address registry of other local hubs 1334, 1332 and 1364 for example. Local hub 1334 maintains an address registry of local hubs 1310, 1332, and 1336 for example. A local horizon hub manager computer 1310, is also a peer computer within larger horizon of local hubs and may communicate with other local peer-to-peer horizon hub managers 1334, 1332 and 1364 for example to participate in executing an multi-agent processing job task.

Peer horizon hub computers maintain an index database of addresses and deployment preferences of other peer horizon hubs. As results are obtained within each peer horizon, the plurality of horizon hub computers within each local horizon sends results back to the originating local horizon hub requester, which in turn delivers the results to the individual peer client user that originated the request.

Peer horizon hubs can either be connected only to a limited horizon of other local horizon hubs, and/or they can be responsible to report results to a multi-hub server 1340 via communication connections such as 1350 for example.

Typically, a multi-hub server will be a dedicated high speed access server which can store and index and serve aggregated databases of network document information, contents and content addresses. The multi-hub server 1340 may or may not carry a registry of local horizon hub peer members such as 1305 or 1300 for example.

In an entirely peer-to-peer based network schema, the multi-hub horizon manager 1340 is another peer computer. In the event a multi-hub server is a dedicated server, such as maintained by a commercial entity for example, all indexing, conflict resolution and results delivery services can be accomplished directly between the local horizon hubs and the dedicated server.

In one embodiment of the invention, there exist only peers that function within an unlimited single horizon of all peers in a network. All communication occurs between the single or co-located dedicated server and the individual peer computers, such as for example like the SETI at Home screen saver program for searching for signs of extraterrestrial life utilize.

In contrast to the SETI at Home peer computing initiative, this preferred embodiment of the present invention is designed for search and retrieval functions of data sets available on the network. It is therefore not a distributed computer processing network to accomplish computational objectives.

In the embodiment of the present invention herein described, the peer of network computers is used to search the network, using search and content retrieval agents. In the embodiment of peer-to-peer local horizon agent search and retrieval and associated peer-horizon results collection hubs, several methods are used to arbitrate (1) peer horizon size, (2) horizon availability for tasking, (3) horizon hub facility requirements, (4) multi-hub data-collection and (5) multi-hub registry indexing.

We claim:

1. A method of providing information, comprising the steps of:
creating a plurality of autonomous search agents to identify portions of a plurality of forms of information stored in a plurality of sources;
retrieving identified information from the plurality of sources;
representing the plurality of sources as a plurality of three-dimensional graphical symbol object and icon nodes and associated links between sources as connectors between nodes;
visually accentuating the plurality of graphical symbol objects and icons according to a plurality of information categories and logic states and evaluation status;
visually captioning the plurality of graphical symbol objects and icons with textual flags indicating an information node title derived from the associated sources; and
permitting a plurality of manual navigation approaches to select, highlight and retrieve and visually rank the plurality of information sources according to preferred-quantitative and qualitative metrics.

2. The method of claim 1, wherein the plurality of sources include web sites, databases, programs, audio and visual media.

3. The method of claim 1, wherein the plurality of symbols are visually highlighted to indicate different logical states of Boolean and non-Boolean evaluation.

4. The method of claim 1, wherein the plurality of symbol objects are visually highlighted to indicate discovered semantic and topical categories and show connections between such associated symbols as visual links.

5. The method of claim 1, wherein, during the search process, the plurality of sources hyper-linked to any source page are subsequently visited and searched according to whether any single source page URL and URL page title and associated document page content contain certain threshold numeric terms and text terms.

6. A method of navigating information, comprising the steps of:
creating a plurality of three-dimensional views of a network of hyperlinked information nodes and links between nodes;
permitting the plurality of information views to be visually scaled and traversed in a three-dimensional representation and with changing user point-of-view perspective;
enabling user chosen information nodes and groups of nodes within the three-dimensional to be selected and highlighted by the user using any ergonomic means;
providing commands for the selected information nodes and associated collected information to be ranked and displayed as a textual and multimedia report when opened for viewing in a standard web browser;
providing commands for the selected information nodes to be opened as original source documents and media for viewing in a standard web browser.

7. The method of claim 6, wherein the information nodes and groups of nodes are selected automatically and the associated gathered information generates a report that is sent via email and instant messaging to the user at another location.

8. The method of claim 6, wherein the information nodes and groups of nodes are selected manually and the associated gathered information is presented to the user locally using a web browser.

9. The method of claim 6, wherein any of the plurality of the three-dimensional views of information nodes and links can be manually modified by the user.

10. The method of claim 6, wherein any of the plurality of the three-dimensional views of information nodes and links can be animation morphed into any other alternate three-dimensional view.

11. The method of claim 6, wherein any of the plurality of the three-dimensional views of information nodes and links can be animation morphed into an equivalent two-dimensional structured list view.

12. The method of claim 6, wherein any of the plurality of the textual and media report views using a web browser can be reordered based on ranking criteria chosen by the user.

13. The method of claim 6, wherein the network of hyperlinked information nodes and links between nodes can be the world wide web and connected databases.

14. The method of claim 6, wherein the network of hyperlinked information nodes and links between nodes can be the intranet private network and connected databases.

15. An apparatus of providing information, comprising the steps of:
creating a plurality of autonomous search agents to identify portions of a plurality of forms of information stored in a plurality of sources;
retrieving identified information from the plurality of sources;
representing the plurality of sources as a plurality of three-dimensional graphical symbol objects and associated links between sources;
visually accentuating the plurality of graphical symbol objects according to a plurality of information categories and states; and
visually captioning the plurality of graphical symbol objects and icons with textual flags indicating an information node title;
permitting a plurality of manual navigation approaches to select, highlight and retrieve the plurality of information sources;
effecting communication to the user of the evaluated search results using browser and email delivered reports.

16. The apparatus of claim 15, wherein the plurality of three-dimensional symbols and icons and associated links between symbols can include tree structures, constellations structures and perspective structures.

17. The method of claim 1, wherein the plurality of search agents include procedures for pruning and limiting the search to only gather and follow links that meet user selected criteria.

18. The method of claim 1, wherein the plurality of search agents include procedures for finishing and closing the search process once a predetermined threshold goal has been achieved.

19. The method of claim 1, wherein the plurality of search agents include procedures for activating subsequent searches and search agents conditioned on the results of prior executed search agent results.

20. The method of claim 1, wherein the plurality of search agents include procedures for activating a plurality of agents located at a plurality of different network locations, and the return on the collective results to a originating requester.
